(19) United States
(12) Patent Application Publication
(10) Pub. No.: US 2026/0074370 A1
(43) Pub. Date: Mar. 12, 2026

(54) HIGHLY PERMEABLE CERAMIC COATED SEPARATORS AND RELATED COMPONENTS, BATTERIES, AND METHODS

(71) Applicant: Sila Nanotechnologies, Inc., Alameda, CA (US)

(72) Inventors: Ryosuke Isobe, Westminster, CO (US); Alexander Carlos Perez de Leon, Oakland, CA (US); Yi-Jui WU, San Leandro, CA (US); Alec Sai Ho, Berkeley, CA (US); David Michael Lynch, Menlo Park, CA (US); Rachel Elise Owyeung, San Mateo, CA (US); Justin Michael Virgili, Berkeley, CA (US); Gleb Nikolayevich Yushin, Atlanta, GA (US)

(21) Appl. No.: 19/319,345

(22) Filed: Sep. 4, 2025

Related U.S. Application Data
(60) Provisional application No. 63/691,807, filed on Sep. 6, 2024.

(51) Int. Cl. H01M 50/446; H01M 50/403; H01M 50/434; H01M 50/449; H01M 50/489

(52) U.S. Cl. CPC H01M 50/446; H01M 50/403; H01M 50/434; H01M 50/449; H01M 50/489

(57) ABSTRACT

In some embodiments, a separator includes a polymer membrane, and a separator coating disposed on the polymer membrane. The separator coating includes (1) ceramic particles including a mixture of higher-aspect ratio ceramic particles (HARCPs) and lower-aspect ratio ceramic particles (LARCPs) and (2) a binder. The separator coating may have a thickness of about 0.5 μm to about 5.0 μm and a mass fraction of the binder in the separator coating may be 20 wt. % or less. The ceramic particles may include Al₂O₃, AlO(OH), and/or Al(OH)₃. The HARCPs may be characterized by an HARCP aspect ratio of more than about 3 and the LARCPs may be characterized by an LARCP aspect ratio of about 1 to about 3. Integrated electrode-separator components, lithium-ion batteries, and related methods are also disclosed.

### CROSS-REFERENCE TO RELATED APPLICATIONS

The present application for patent claims the benefit of U.S. Provisional Application No. 63/691,807, entitled “HIGHLY PERMEABLE CERAMIC COATED SEPARATORS AND RELATED COMPONENTS, BATTERIES, AND METHODS,” filed Sep. 6, 2024, assigned to the assignee hereof, and expressly incorporated herein by reference in its entirety.

### BACKGROUND

### Field

Aspects of the present disclosure relate generally to energy storage devices and, more particularly, to battery technology and the like. Aspects of the present disclosure relate to ceramic nanofiber membranes and their use as a separator in an anode-separator composite for a battery, a supercapacitor or another energy storage device. Aspects of the present disclosure relate to methods of making a ceramic nanofiber membrane.

### Background

As the demand for energy storage continues to surge driven by growth in energy sectors such as portable consumer electronics, electric vehicles and grid energy storage systems, there is an incessant need to improve energy and power densities of lithium-ion batteries (LIBs) without compromising safety. To achieve this target, higher areal loading or higher energy density electrodes are necessary, which often increase mechanical stresses and self-heating and thus associated safety risks of the resultant batteries. Advanced separators, whose primary roles are to enable ion transport and to prevent a short circuit by avoiding a direct electrical contact between the electrodes, can play important roles to both enhance cell power density and improve safety features. The LIB separators typically satisfy several basic criteria for their use, such as: (a) high open porosity, low tortuosity, and (for applications that use liquid electrolyte) high wettability by liquid electrolyte(s) to facilitate rapid molecule/Li-ion transport, (b) good chemical and electrochemical stability in contact with the electrolyte and electrode materials across an operational potential range (that may result in strong oxidizing and reducing environments during charge/discharge), and (c) strong mechanical stability for materials manufacturing and cell assembly. Indeed, LIB rate performance may be significantly reduced if a separator does not allow fast ion transport at high areal current density, while high separator shrinkage during heating or high-temperature operations may induce formation of internal short-circuits in LIBs. In addition, separators should ideally be flame-retardant to minimize the probability of catastrophic events, such as fire or explosion originating from either a thermal runaway reaction and/or a short circuit.

Commonly employed LIB separators are manufactured from either polyethylene (PE) or polypropylene (PP), which have their advantages in terms of low cost, excellent electrochemical stability and mechanical strength, but do not meet all of the above desired LIB separator criteria. In particular, their poor thermal stability (glass transition temperature (T_{g}) of −110 and −20° C., low melting temperature (Tₘ) of 135 and 170° C., and thermal decomposition temperature (Ta) of 325-450° C. and 328-410° C., respectively, for PE and PP separators) could result in serious safety issues (e.g., smoke, fire or even explosion) when operated at elevated temperatures or under extreme conditions. Moreover, conventional LIB separators' non-polar chemical structure (e.g., dielectric constant value ε=1.6 and 2.1, respectively, for PE and PP), small porosity and high tortuosity lead to the poor electrolyte wettability and low ion conductivity. Although these issues may be somewhat alleviated when the surfaces of PE or PP separators are coated with particulate inorganic materials, such fabrication procedures are complex, costly, increase separator thickness, reduce separator flexibility and processability, often enhance moisture entrapment and offer limited improvements.

Accordingly, there is a need for improved separators (membranes) and integrated electrode-separator components incorporating improved ceramic (nano) particles are desired. In particular, improved separators and integrated electrode-separator components based on elongate ceramic (nano) particles (e.g., ceramic nanofibers) are desired for obtaining thin, highly permeable separator membranes characterized by low thermal shrinkage and good mechanical, electrochemical, and thermal stability. Furthermore, improved manufacturing processes for making such separator membranes and integrated electrode-separator components are desired. Yet furthermore, there remains a need for improved lithium-ion batteries incorporating such separators or integrated electrode-separator components.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a separator includes a polymer membrane; and a separator coating disposed on the polymer membrane comprising (1) ceramic particles comprising a mixture of higher-aspect ratio ceramic particles (HARCPs) and lower-aspect ratio ceramic particles (LARCPs) and (2) a binder, the separator coating having a thickness of about 0.5 μm to about 5.0 μm, a mass fraction of the binder in the separator coating being about 20 wt. % or less, wherein: the ceramic particles comprise Al₂O₃, AlO(OH), and/or Al(OH)₃; the HARCPs are characterized by an HARCP aspect ratio of more than about 3; and the LARCPs are characterized by an LARCP aspect ratio of about 1 to about 3.

In an aspect, a method comprises: (A1) preparing a dispersion comprising (1) ceramic particles comprising a mixture of higher-aspect ratio ceramic particles (HARCPs) and lower-aspect ratio ceramic particles (LARCPs), (2) a binder, and (3) a solvent; and (A2) dispensing the dispersion on a substrate to form a layer and drying the layer to form a separator coating on the substrate, wherein: a thickness of the separator coating is in a range of about 0.5 μm to about 5.0 μm; a mass fraction of the binder in the separator coating is about 20 wt. % or less; the ceramic particles comprise Al₂O₃, AlO(OH), and/or Al(OH)₃; the HARCPs are characterized by an HARCP aspect ratio of more than about 3; and the LARCPs are characterized by an LARCP aspect ratio of about 1 to about 3; and the substrate comprises a polymer membrane.

In an aspect, an integrated electrode-separator component includes an electrode coating disposed on and/or in a current collector and comprising electrode active material; and a separator coating disposed on the electrode coating comprising (1) ceramic particles comprising a mixture of higher-aspect ratio ceramic particles (HARCPs) and lower-aspect ratio ceramic particles (LARCPs) and (2) a binder, the separator coating having a thickness of about 1.0 μm to about 15 μm, a mass fraction of the binder in the separator coating being about 20 wt. % or less, wherein: the ceramic particles comprise Al₂O₃, AlO(OH), and/or Al(OH)₃; the HARCPs are characterized by an HARCP aspect ratio of more than about 3; and the LARCPs are characterized by an LARCP aspect ratio of about 1 to about 3.

In an aspect, a method comprises: (A1) preparing a dispersion comprising (1) ceramic particles comprising a mixture of higher-aspect ratio ceramic particles (HARCPs) and lower-aspect ratio ceramic particles (LARCPs), (2) a binder, and (3) a solvent; and (A2) dispensing the dispersion on a substrate to form a layer and drying the layer to form a separator coating on the substrate, wherein: a thickness of the separator coating is in a range of about 1.0 μm to about 10 μm; a mass fraction of the binder in the separator coating is about 20 wt. % or less; the ceramic particles comprise Al₂O₃, AlO(OH), and/or Al(OH)₃; the HARCPs are characterized by an HARCP aspect ratio of more than about 3; the LARCPs are characterized by an LARCP aspect ratio of about 1 to about 3; and the substrate comprises an electrode coating disposed on and/or in a current collector and comprising electrode active material.

In an aspect, a method includes (B1) preparing a slurry comprising (1) an electrode active material, (2) a first binder, and (3) a first solvent; (B2) preparing a dispersion comprising (1) ceramic particles comprising a mixture of higher-aspect ratio ceramic particles (HARCPs) and lower-aspect ratio ceramic particles (LARCPs) and (2) a second binder, and (3) a second solvent; (B3) dispensing the slurry on a current collector to form a first layer; (B4) dispensing the dispersion on the first layer to form a second layer, while the first layer is still wet; and (B5) drying the first and second layers concurrently to form an integrated electrode-separator component, the first layer becoming an electrode coating, the second layer becoming a separator coating, wherein: a first thickness of the electrode coating is in a range of about 10 μm to about 300 μm; a second thickness of the separator coating is in a range of about 1.0 μm to about 15 μm; a mass fraction of the binder in the separator coating is about 20 wt. % or less; the ceramic particles comprise Al₂O₃, AlO(OH), and/or Al(OH)₃; the HARCPs are characterized by an HARCP aspect ratio of more than about 3; and the LARCPs are characterized by an LARCP aspect ratio of about 1 to about 3.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of embodiments of the disclosure and are provided solely for illustration of the embodiments and not limitation thereof. Unless otherwise stated or implied by context, different hatchings, shadings, and/or fill patterns in the drawings are meant only to draw a contrast between different components, elements, features, etc., and are not meant to convey the use of particular materials, colors, or other properties that may be defined outside of the present disclosure for the specific pattern employed.

FIG. 1 illustrates an exemplary Li-ion battery in which the components, materials, processes, and other techniques described herein may be implemented.

FIG. 2 is a flow diagram of a process of making a Li-ion battery according to one aspect.

FIG. 3 is a flow diagram of a process of making a separator coating in one aspect.

FIG. 4A is a flow diagram of a process of sequentially forming an electrode coating and a separator coating in one aspect.

FIG. 4B is a flow diagram of a process of making a Li-ion battery in which the process of FIG. 4A is employed.

FIG. 4C is a flow diagram of another process of making a Li-ion battery in which the process of FIG. 4A is employed.

FIG. 5 is a flow diagram of a process of making elongate ceramic (nano) particles in one aspect.

FIG. 6A shows flow diagrams of three types of coating processes: (1) a single-layer coating process, (2.1) a dual-layer, wet-on-dry coating process, and (2.2) a dual-layer, wet-on-wet coating process.

FIG. 6B schematically illustrates a coater configuration for coating a single layer in a reverse gravure coating process.

FIG. 6C schematically illustrates a coater configuration for coating a single layer in a wire bar coating process.

FIG. 6D schematically illustrates a coater configuration for coating a single layer in a tensioned web slot die coating process.

FIG. 6E schematically illustrates a coater configuration for coating a single layer in a slot die coating process with a backing roll.

FIG. 6F schematically illustrates a coater configuration for coating two layers in a wet-on-wet coating process in which the first coating layer is coated with a first slot die with a backing roll, and the second coating layer is coated with a second slot die with the same backing roll.

FIG. 6G schematically illustrates a coater configuration for coating two layers in a wet-on-wet coating process in which the coater comprises a dual slot die with one backing roll.

FIG. 6H schematically illustrates a coater configuration for coating two layers in a wet-on-wet coating process in which the coater comprises two tensioned web slot dies.

FIG. 6I schematically illustrates a coater configuration for coating two layers in a wet-on-wet coating process in which the first coating layer is coated with a slot die with a backing roll and the second coating layer is coated with a tensioned web slot die.

FIG. 6J schematically illustrates a coater configuration for coating two layers in a wet-on-wet coating process in which the coater comprises a tensioned web slot die with two separate slots.

FIG. 6K schematically illustrates a coater configuration for coating two layers in a wet-on-wet coating process in which the coater comprises a tensioned web slot die with two separate coating liquids and one slot.

FIG. 6L schematically illustrates a coater configuration for coating two layers in a wet-on-wet coating process in which the first coating layer is coated with a slot die with a backing roll and the second coating layer is coated with a reverse gravure coating process.

FIG. 7A is a scanning electron microscope (SEM) image of a sample of ceramic (nano) particles, after hydrolysis (stage 508) and before comminution (stage 510).

FIGS. 7B, 7C, and 7D are SEM images of samples of ceramic (nano) particles, after milling under respective milling conditions (stage 510).

FIG. 8 (Table 1) shows selected data relating to composition and properties of examples of ceramic (nano) particles.

FIG. 9 shows cumulative pore volume data of ceramic (nano) particle examples.

FIG. 10 shows volume-weighted particle size distribution (PSD) data of ceramic (nano) particle examples under respective milling conditions.

FIG. 11 shows a plan view SEM image of a separator, comprising a coating of ceramic (nano) particles, disposed on a polymer membrane.

FIG. 12 shows a cross-sectional view SEM image of an integrated electrode-separator component, comprising coating of the sample of ceramic (nano) particles, disposed on an electrode coating on a current collector.

FIG. 13A shows the dependence of Gurley air permeabilities of separator coatings on ceramic coating layer thickness, for samples of ceramic (nano) particles of respective milling conditions. These separator coatings are disposed on polymer membranes and these Gurley air permeabilities of separator coatings do not include the Gurley air permeabilities of the underlying substrates.

FIG. 13B shows the dependence of Gurley air permeabilities of separator coatings on separator coating thicknesses, for separator coatings comprising binders at respective mass ratios of ceramic (nano) particles to binders. These separator coatings are disposed on polymer membranes and these Gurley air permeabilities of separator coatings do not include the Gurley air permeabilities of the underlying substrates.

FIG. 14 shows the dependence of thermal shrinkage of separators on separator coating thicknesses, for samples of ceramic (nano) particles of respective milling conditions. These separator coatings are disposed on polymer membranes. The thermal shrinkage of the (bare) polymer membrane is shown for comparison.

FIG. 15 shows the dependence of the puncture strength (puncture resistance) of separators on separator coating thicknesses. These separator coatings are disposed on polymer membranes. The puncture strength (puncture resistance) of the (bare) polymer membrane is shown for comparison.

FIG. 16 (Table 2) shows selected data relating to the properties of (1) a (bare) polymer membrane substrate, (2) a commercially available ceramic-coated separator (CCS) (ceramic coating disposed on a polymer membrane), and (3) an example separator of a ceramic coating disposed on a polymer membrane.

FIG. 17 shows the dependence of the normalized charge capacity on the normalized charge rate, for three types of lithium-ion battery test cells: (1) test cells each comprising an example separator comprising a ceramic (nano) particle coating on a polymer membrane, (2) test cells each comprising a (bare) polymer membrane as the separator, and (3) test cells each comprising a commercially available ceramic-coated separator (CCS) (ceramic coating disposed on a polymer membrane).

FIG. 18 shows the dependence of the normalized capacity retention on the normalized charge rate, for three types of lithium-ion battery test cells: (1) test cells each comprising an example separator comprising a ceramic (nano) particle coating on a polymer membrane, (2) test cells each comprising a (bare) polymer membrane as the separator, and (3) test cells each comprising a commercially available ceramic-coated separator (CCS) (ceramic coating disposed on a polymer membrane).

FIG. 19 shows the dependence of the normalized charge capacity on the normalized charge rate, for three types of lithium-ion battery test cells: (1) test cells each comprising an integrated anode electrode-separator component, (2) test cells each comprising a (bare) polymer membrane as the separator, and (3) test cells each comprising a commercially available ceramic-coated separator (CCS) (ceramic coating disposed on a polymer membrane).

FIG. 20 shows the dependence of the normalized capacity retention on the normalized charge rate, for three types of lithium-ion battery test cells: (1) test cells each comprising an integrated anode electrode-separator component, (2) test cells each comprising a (bare) polymer membrane as the separator, and (3) test cells each comprising a commercially available ceramic-coated separator (CCS) (ceramic coating disposed on a polymer membrane).

### DETAILED DESCRIPTION

Aspects of the present invention are disclosed in the following description and related drawings directed to specific embodiments of the invention. The term “embodiments of the invention” does not require that all embodiments of the invention include the discussed feature, advantage, process, or mode of operation, and alternative embodiments may be devised without departing from the scope of the invention. Additionally, well-known elements of the invention may not be described in detail or may be omitted so as not to obscure other, more relevant details.

Any numerical range described herein with respect to any embodiment of the present invention is intended not only to define the upper and lower bounds of the associated numerical range but also as an implicit disclosure of each discrete value within that range in units or increments that are consistent with the level of precision by which the upper and lower bounds are characterized. For example, a numerical distance range from 7 nm to 20 nm (i.e., a level of precision in units or increments of ones) encompasses (in nm) a set of [7, 8, 9, 10, . . . , 19, 20], as if the intervening numbers 8 through 19 in units or increments of ones were expressly disclosed. In another example, a temperature range from about −120° C. to about −60° C. encompasses (in ° C.) a set of temperature ranges from about −120° C. to about −119° C., from about −119° C. to about −118° C., . . . from about −61° C. to about −60° C., as if the intervening numbers (in ° C.) between −120° C. and −60° C. in incremental ranges were expressly disclosed. In yet another example, a numerical percentage range from 30.92% to 47.44% (i.e., a level of precision in units or increments of hundredths) encompasses (in %) a set of [30.92, 30.93, 30.94, . . . , 47.43, 47.44], as if the intervening numbers between 30.92 and 47.44 in units or increments of hundredths were expressly disclosed. Hence, any of the intervening numbers encompassed by any disclosed numerical range are intended to be interpreted as if those intervening numbers had been disclosed expressly, and any such intervening number may thereby constitute its own upper and/or lower bound of a sub-range that falls inside of the broader range. Each sub-range (e.g., each range that includes at least one intervening number from the broader range as an upper and/or lower bound) is thereby intended to be interpreted as being implicitly disclosed by virtue of the express disclosure of the broader range.

It will be appreciated that the level of precision of any particular measurement, threshold or other inexact parameter may vary based on various factors such as measurement instrumentation, environmental conditions, and so on. Below, reference to such measurements or thresholds may thereby be interpreted as a respective value assuming a pseudo-exact level of precision (e.g., a threshold of 80% comprises 80.0000 . . . %). Alternatively, reference to such measurements or thresholds may be described via a qualifier that captures pseudo-exact value(s) plus a range that extends above and/or below the pseudo-exact value(s). For example, the above-noted threshold of 80% may be interpreted as “about,” “approximately,” “around,” “˜” or “˜” 80%, which encompasses “exactly” 80% (e.g., 80.0000 . . . %) plus some range around 80%. In some designs, the range encompassed around a measurement or threshold via the “about,” “approximately,” “around,” or “˜” qualifier may encompass the level of precision for which the respective measurement or threshold is capable of being measured by the most accurate commercially available instrumentation as of the priority date of the subject application.

While this disclosure provides the description and most examples for Li-ion batteries due to their current market dominance, it should be appreciated that many aspects are additionally applicable for other battery chemistries. Examples of such other suitable electrochemical energy storage chemistries include, but are not limited to: other metal-ion batteries (Na-ion, K-ion, mixed Na—/K-ion, mixed Li—/Na-ion, other metal-ion batteries incl. mixed ion or dual ion batteries, etc.), electrochemical capacitors (EDLCs), hybrid energy storage systems, among others.

As used herein, the term “composition” is intended to encompass a product comprising the specified ingredients in the specified amounts, as well as any product which results, directly or indirectly, from a combination of the specified ingredients in the specified amounts.

References in the specification and concluding claims to parts by weight of a particular element or component in a composition denote the weight relationship between the element or component and any other elements or components in the composition or article for which a part by weight is expressed. Thus, in a mixture containing 2 parts by weight of component X and 5 parts by weight of component Y, components X and Y are present at a weight ratio of 2:5 and are present in such a ratio regardless of whether additional components are contained in the mixture.

A weight percent (wt. %) of a component, unless specifically stated to the contrary, is based on the total weight of the formulation or composition in which the component is included.

In the following description, various material properties are described so as to characterize materials (e.g., binders, molecules, particles, powders, slurries, electrodes, separators, electrolytes, battery cells, etc.) in various states. Note that a person of ordinary skill in the art (POSITA) is generally capable of selecting (and is herein assumed to select) the most appropriate measurement technique for any particular measurement. Moreover, in some cases, the most appropriate measurement technique may include a combination of techniques. While the following Table characterizes various measurement type options for particular material types and particular material properties, certain embodiments of the disclosure may be more specifically characterized in context with a specific measurement technique and/or specific commercially available instrumentation, if warranted. Note that while the Table below characterizes measurements with respect to active material particles, similar measurements may also be made with respect to other particle types, such as precursor particles (e.g., carbon particles, etc.). Hence, unless otherwise indicated, the following Table provides examples of how such material properties may be readily measured by one of ordinary skill in the art using commercially available instrumentation:

### Table of Techniques and Instrumentation for Material Property Measurements

| Material | Property | Measurement | |
|---|---|---|---|
| Type | Type | Instrumentation | Measurement Technique |
| Active | Coulombic | Potentiostat | Charge (current) is passed to |
| Material | Efficiency | | an electrode containing the |
| | | | active material of interest |
| | | | until a given voltage limit is |
| | | | reached. Then, the current is |
| | | | reversed (discharge current) |
| | | | until a second voltage limit is |
| | | | reached. The ratio of the two |
| | | | charges passed determines |
| | | | the Coulombic Efficiency |
| | | | (CE). In the simplest case, |
| | | | the charge and discharge |
| | | | currents may be constant |
| | | | and often have absolute |
| | | | values that are the same or |
| | | | close to each other. It should |
| | | | be understood though that in |
| | | | some experiments, either |
| | | | charge current or discharge |
| | | | current or both may be |
| | | | changing during such |
| | | | experiments (e.g., be initially |
| | | | constant and when the |
| | | | voltage limit is reached, |
| | | | diminishing to a |
| | | | predetermined value). In |
| | | | addition, the absolute value |
| | | | of the charge and discharge |
| | | | currents may differ. |
| Active | Partial | Manometer | The partial vapor pressure |
| Material | Vapor | | of an active material in a |
| | Pressure | | mixture (e.g., composite |
| | (e.g., Torr.) | | particle) at a particular |
| | at a | | temperature is given by the |
| | Temperature | | known vapor pressure of the |
| | (e.g., K) | | active material multiplied by |
| | | | its mole fraction in the |
| | | | mixture. |
| Active | Volume | Gas pycnometer | Gas pycnometer measures |
| Material | | | the skeletal volume of a |
| Particle | | | material by gas displacement |
| | | | using the volume-pressure |
| | | | relationship of Boyle's Law. |
| | | | A sample of known mass is |
| | | | placed into the sample |
| | | | chamber and maintained at |
| | | | a constant temperature. An |
| | | | inert gas, typically helium, is |
| | | | used as the displacement |
| | | | medium. |
| | | | Note: A vol. % change may |
| | | | be calculated from two |
| | | | volume measurements of the |
| | | | active material particle. |
| Active | Open | nitrogen | Nitrogen sorption/desorption |
| Material | Internal | sorption/desorption | isotherm (typically at 77 K) is |
| Particle | Pore Volume | isotherm | collected and analyzed to |
| | (e.g., cc/g or | | estimate the total amount of |
| | cm³/g) | | gas adsorbed/desorbed and |
| | | | internal pore volume of the |
| | | | sample with known mass is |
| | | | estimated from such |
| | | | measurements. Pore size |
| | | | distribution (PSD) may be |
| | | | further estimated from the |
| | | | sorption/desorption isotherm |
| | | | using various analyses, such |
| | | | as Non-Local Density |
| | | | Functional Theory (NLDFT) |
| Active | Volume- | PSA, scanning | PSA using laser scattering, |
| Material | Average Pore | electron microscope | electron microscopy (SEM, |
| Particle | Size and Pore | (SEM), transmission | TEM, STEM) in |
| | Size | electron microscope | combination with image |
| | Distributions | (TEM), scanning | analyses, laser microscopy |
| | (e.g., nm) | transmission | (for larger particles and |
| | | microscope (STEM), | larger pores) in combination |
| | | laser microscope, | with image analyses, optical |
| | | Synchrotron X-ray, | microscopy (for larger |
| | | X-ray microscope | particles and larger pores), |
| | | | neutron scattering, X-ray |
| | | | scattering, X-ray microscopy |
| | | | imaging may be employed to |
| | | | measure pore sizes (average |
| | | | pore size or pore size |
| | | | distribution) in different size |
| | | | ranges (in addition to the |
| | | | analysis of the |
| | | | sorption/desorption |
| | | | isotherms). |
| Active | Closed | Gas pycnometer | Closed porosity may be |
| Material | Internal Pore | | measured by analyzing true |
| Particle | Volume (e.g., | | density values measured by |
| | cc/g or cm³/g) | | using an argon gas |
| | | | pycnometer and comparing |
| | | | them to the theoretical |
| | | | density of the individual |
| | | | material components present |
| | | | in Si-comprising particles. In |
| | | | addition, closed internal |
| | | | pore volume may be |
| | | | estimated by comparing the |
| | | | total pore volume estimated |
| | | | from neutron scattering and |
| | | | the nitrogen-accessible pore |
| | | | volume estimated from |
| | | | nitrogen sorption isotherms. |
| Active | Closed | Gas pycnometer | With a pycnometer, the |
| Material | Internal | | amount of a certain medium |
| Particle | Volume- | | (liquid or Helium or other |
| | Average Size | | analytical gases) displaced |
| | (e.g., nm) | | by a solid can be determined. |
| Active | Size | TEM, STEM, SEM, | Laser particle size |
| Material | (e.g., nm, | X-Ray, PSA, etc. | distribution analysis (LPSA), |
| Particle | μm, etc.) | | laser image analysis, electron |
| | | | microscopy, optical |
| | | | microscopy or other suitable |
| | | | techniques |
| | | | transmission electron |
| | | | microscopy (TEM), scanning |
| | | | transmission electron |
| | | | microscopy (STEM), |
| | | | scanning electron |
| | | | microscopy (SEM)), X-ray |
| | | | microscopy, X-ray |
| | | | diffraction, neutron |
| | | | scattering and other suitable |
| | | | techniques |
| Active | Composition | Balance | Note #1: A wt. % change |
| Material | (e.g., mass | | may be calculated by |
| Particle | fraction or | | comparing the mass fraction |
| | wt. %, mg, | | of a material in the particle |
| | number of | | relative to the total particle |
| | atoms, etc.) | | mass. |
| | | | Note #2: The capacity |
| | | | attributable to particular |
| | | | active material(s) in the |
| | | | particle may be derived from |
| | | | the composition, based on |
| | | | the known (e.g., theoretical |
| | | | or practically attainable) |
| | | | capacity(ies) of each active |
| | | | material. |
| | | | Note #3: The composition of |
| | | | the particle may be |
| | | | characterized in terms of |
| | | | weight (e.g., mg). The |
| | | | composition of may |
| | | | alternatively be |
| | | | characterized by a number |
| | | | of atoms of a particular |
| | | | element (e.g., Si, C, etc.). In |
| | | | case of atoms, the number of |
| | | | atoms may be estimated |
| | | | from the weight of that atom |
| | | | in the particle (e.g., based on |
| | | | gas chromatography) |
| Active | Composition | X-ray Fluorescence | |
| Material | (e.g., mass | (XRF), Inductively | |
| Particle | fraction or | Coupled Plasma | |
| | wt. % of | Optical Emission | |
| | various | Spectroscopy (ICP- | |
| | atomic | OES); Energy | |
| | elements or | Dispersive | |
| | molecules, | Spectroscopy (EDS), | |
| | atomic | Wavelength | |
| | fraction or | Dispersive | |
| | at. % of | Spectroscopy | |
| | various | (WDS), Electron | |
| | elements, | Energy Loss | |
| | etc.) | Spectroscopy | |
| | | (EELS), Nuclear | |
| | | Magnetic Resonance | |
| | | (NMR); Secondary | |
| | | Ion Mass | |
| | | Spectrometry | |
| | | (SIMS); X-Ray | |
| | | Photoelectron | |
| | | Spectroscopy (XPS); | |
| | | Fourier Transform | |
| | | Infrared | |
| | | Spectroscopy (FTIR) | |
| | | and Raman | |
| | | Spectroscopy | |
| | | (Raman) | |
| Active | Specific | Potentiostat | An electrode containing an |
| Material | Capacity | | active anode or cathode |
| Particle, | | | material of interest is |
| Battery | | | charged or discharged (by |
| Half-Cell | | | passing electrical current to |
| | | | the electrode) within certain |
| | | | potential limits using an |
| | | | electrochemical cell with a |
| | | | suitable reference electrode, |
| | | | typically lithium metal. The |
| | | | total charge passed (e.g., in |
| | | | mAh) divided by the active |
| | | | material mass (e.g., in g) |
| | | | gives this quantity (e.g., in |
| | | | mAh/g). The active mass is |
| | | | computed by multiplying the |
| | | | total mass of the electrode by |
| | | | the active material mass |
| | | | fraction. Both reversible and |
| | | | irreversible capacity during |
| | | | charge or discharge may be |
| | | | calculated in this way. |
| Active | BET SSA | BET instrument | A sample is placed into a |
| Material | (e.g., m²/g) | | sealed chamber at 77 K, |
| Particle | | | where nitrogen is introduced |
| | | | at increasing pressure. The |
| | | | change in pressure of the |
| | | | nitrogen is used to calculate |
| | | | the surface area of the |
| | | | sample. |
| Active | Aspect Ratio | SEM, TEM | The dimensions and shape of |
| Material | | | the particles are typically |
| Particle | | | measured by using SEM or |
| | | | TEM or (for large particles) |
| | | | by using optical microscopy. |
| Active | True Density | Argon Gas | True density values may be |
| Material | of Particle | Pycnometer | measured by using an argon |
| Particle | (e.g., g/cc or | | gas pycnometer and |
| | g/cm³) | | comparing to the theoretical |
| | | | density of the individual |
| | | | material components present |
| | | | in the particle. |
| Active | Particle Size | Dynamic light | laser particle size |
| Material | Distribution | scattering particle | distribution analysis (LPSA) |
| Particle | (e.g., nm or | size analyzer, | on well-dispersed particle |
| Population | μm) | scanning electron | suspensions in one example |
| | | microscope | or by image analysis of |
| | | | electron microscopy images, |
| | | | or by other suitable |
| | | | techniques. While there are |
| | | | diverse processes of |
| | | | measuring PSDs, laser |
| | | | particle size distribution |
| | | | analysis (LPSA) is quite |
| | | | efficient for some |
| | | | applications. Note that other |
| | | | types of particle size |
| | | | distribution (e.g., by SEM |
| | | | image analysis) could also be |
| | | | utilized (and may even lead |
| | | | to more precise |
| | | | measurements, in some |
| | | | experiments). Using LPSA, |
| | | | particle size parameters of a |
| | | | population's PSD may be |
| | | | measured, such as: a tenth- |
| | | | percentile volume-weighted |
| | | | particle size parameter (e.g., |
| | | | abbreviated as D₁₀), a |
| | | | fiftieth-percentile volume- |
| | | | weighted particle size |
| | | | parameter (e.g., abbreviated |
| | | | as D₅₀), a ninetieth-percentile |
| | | | volume-weighted particle |
| | | | size parameter (e.g., |
| | | | abbreviated as D₉₀), and a |
| | | | ninety-ninth-percentile |
| | | | volume-weighted particle |
| | | | size parameter (e.g., |
| | | | abbreviated as D₉₉). |
| Active | Width (e.g., | PSA | Parameters relating to |
| Material | nm) | | characteristic widths of the |
| Particle | | | PSD may be derived from |
| Population | | | these particle size |
| | | | parameters, such as D₅₀- |
| | | | D₁₀ (sometimes referred to |
| | | | herein as a left width), D₉₀- |
| | | | D₅₀ (sometimes referred to |
| | | | herein as a right width), and |
| | | | D₉₀-D₁₀ (sometimes |
| | | | referred to herein as a full |
| | | | width). |
| Active | Cumulative | Computed via LPSA | A cumulative volume |
| Material | Volume | data | fraction, defined as a |
| Particle | Fraction | | cumulative volume of the |
| Population | | | composite particles with |
| | | | particle sizes of a threshold |
| | | | particle size or less, divided |
| | | | by a total volume of all of the |
| | | | composite particles, may be |
| | | | estimated by LPSA. |
| Active | Composition | Balance | The mass of active materials |
| Material | (e.g., wt. %) | | added to the electrode |
| Particle | | | divided by the total mass of |
| Population | | | the electrode. |
| Active | BET SSA | BET Isotherm | obtained from the data of |
| Material | (e.g., m²/g) | | nitrogen sorption-desorption |
| Particle | | | at cryogenic temperatures, |
| Population | | | such as about 77 K |
| Electrolyte | Salt | balance, volumetric | Total volume of the solution |
| | Concentration | pipette | is computed either via the |
| | (e.g., M or | | sum of the volume of the |
| | mol. %) | | constituents (measured by a |
| | | | volumetric pipette), or by |
| | | | the mass of the constituents |
| | | | divided by the density. The |
| | | | molar mass of the salt is then |
| | | | used to calculate the total |
| | | | number of moles of salt in |
| | | | the solution. The moles of |
| | | | salt is then divided by the |
| | | | total volume to obtain the |
| | | | solvent concentration in M |
| | | | (mol/L). |
| Electrolyte | Solvent | balance, volumetric | Total volume of the solution |
| | Concentration | pipette | is computed either via the |
| | (e.g., M or | | sum of the volume of the |
| | mol. %) | | constituents (measured by a |
| | | | volumetric pipette), or by |
| | | | the mass of the constituents |
| | | | divided by the density. The |
| | | | molar volume of each solvent |
| | | | is then used to calculate the |
| | | | total number of moles of |
| | | | solvent in the solution. The |
| | | | moles of solvent is then |
| | | | divided by the total volume |
| | | | to obtain the solvent |
| | | | concentration in M (mol/L). |
| Electrode | Composition | Balance | The mass fraction of a |
| | (e.g., mass | | material (e.g., active |
| | fraction or | | material, active material |
| | wt. %) | | particle, binder, etc.) in the |
| | | | electrode is calculated based |
| | | | on a measured or estimated |
| | | | mass of the material and a |
| | | | measured or estimated mass |
| | | | of the electrode, excluding |
| | | | the electrode current |
| | | | collector. |
| | | | Note: The mass of individual |
| | | | components (e.g., composite |
| | | | active material particles, |
| | | | graphite particles, binder, |
| | | | function additive(s), etc.) of |
| | | | the battery electrode |
| | | | composition may be |
| | | | measured before being |
| | | | mixed into a slurry to |
| | | | estimate their mass in a |
| | | | casted electrode. The mass of |
| | | | materials deposited onto |
| | | | and/or into the casted |
| | | | electrode may be measured |
| | | | by comparing the weight of |
| | | | the casted electrode |
| | | | before/after the material |
| | | | deposition. |
| Electrode | Areal Binder | balance | A mass fraction of the |
| | Loading (e.g., | | binder in the battery |
| | mg/m²) | | electrode, divided by a |
| | | | product of (1) a mass |
| | | | fraction of the active |
| | | | material (e.g., Si—C |
| | | | (nano)composite, etc.) |
| | | | particles in the battery |
| | | | electrode, and (2) a |
| | | | Brunauer-Emmett-Teller |
| | | | (BET) specific surface area |
| | | | of the active material |
| | | | particle population. |
| Electrode | Capacity | Calculated | Measure the mass (wt.) of |
| | Attributable | | active material in the |
| | to Active | | electrode, and calculate |
| | Material | | electrode capacity based on |
| | (active | | the known theoretical |
| | material | | capacity of the active |
| | capacity | | material. For example, the |
| | fraction) | | average wt. % of active |
| | | | material in each active |
| | | | material particle may be |
| | | | measured and used to |
| | | | calculate the mass of the |
| | | | active material based on the |
| | | | mass of the active material |
| | | | particles before being mixed |
| | | | in the slurry. This process |
| | | | may be repeated if the |
| | | | electrode includes two or |
| | | | more active materials to |
| | | | calculate the relative |
| | | | capacity attribution for each |
| | | | active material in the |
| | | | electrode. |
| Electrode | Capacity | Potentiostat and | Determine the average |
| | Attributable | balance | specific capacity (mAh/g) of |
| | to Active | | active material particles. For |
| | Material | | example, the average specific |
| | Particles | | capacity may be estimated |
| | (active | | from the average wt. % of |
| | material | | active material(s) in each |
| | particle | | particle and its associated |
| | capacity | | known theoretical |
| | fraction) | | capacity(ies). Then, measure |
| | | | the mass (wt.) of active |
| | | | material particles in the |
| | | | electrode before being mixed |
| | | | in slurry, which may be used |
| | | | to calculate the capacity |
| | | | attributable to that active |
| | | | material. This process may |
| | | | be repeated if the electrode |
| | | | includes two or more active |
| | | | material particle types to |
| | | | calculate the relative |
| | | | capacity attribution for each |
| | | | active material particle type |
| | | | in the electrode. |
| Electrode | Mass of | balance | The average wt. % of active |
| | Active | | material in each active |
| | Material in | | material particle may be |
| | Electrode | | measured, and used to |
| | | | calculate the mass of the |
| | | | active material based on the |
| | | | mass of the active material |
| | | | particles before being mixed |
| | | | in slurry. |
| Electrode | Mass of | balance | Measure the active material |
| | Active | | particle before the active |
| | Material | | material particle type is |
| | Particle in | | mixed in the slurry. |
| | Electrode | | |
| Electrode | Areal | Potentiostat and | Areal capacity loading is the |
| | Capacity | balance | weight of the coated active |
| | Loading (e.g., | | material per unit area |
| | mAh/cm²) | | (g/cm²) multiplied by the |
| | | | gravimetric capacity of the |
| | | | active material (not the |
| | | | electrode, but the active |
| | | | material itself with zero |
| | | | binder and zero electrolyte; |
| | | | mAh/g). |
| Electrode | Coulombic | Potentiostat | The change in charge |
| | Efficiency | | inserted (or extracted) to an |
| | | | electrode divided by the |
| | | | charge extracted (or |
| | | | inserted) from the electrode |
| | | | during a complete |
| | | | electrochemical cycle within |
| | | | given voltage limits. Because |
| | | | the direction of charge flow |
| | | | is opposite for cathodes and |
| | | | anodes, the definition is |
| | | | dependent on the electrode. |
| | | | Coulombic Efficiency is |
| | | | measured for both materials |
| | | | by constructing a so-called |
| | | | half-cell, which is an |
| | | | electrochemical cell |
| | | | consisting of a cathode or |
| | | | anode material of interest as |
| | | | the working electrode and a |
| | | | lithium metal foil which |
| | | | functions as both the counter |
| | | | and reference electrode. |
| | | | Then, charge is either |
| | | | inserted or removed from |
| | | | the material of interest until |
| | | | the cell voltage reaches an |
| | | | appropriate limit. Then, the |
| | | | process is reversed until a |
| | | | second voltage limit is |
| | | | reached, and the charge |
| | | | passed in both steps is used |
| | | | to calculate the Coulombic |
| | | | Efficiency, as described |
| | | | above. |
| Battery Cell | Rate | Potentiostat | This is the time it takes to |
| | Performance | | charge or discharge a |
| | | | battery between a given state |
| | | | of charge. It is measured by |
| | | | charging or discharging a |
| | | | battery and measuring the |
| | | | time until a specified amount |
| | | | of charge is passed, or until |
| | | | the battery operating voltage |
| | | | reaches a specified value. |
| Battery Cell | Cell | Potentiostat | A battery consisting of a |
| | Discharge | | relevant anode and cathode |
| | Voltage (e.g., | | is charged and discharged |
| | V) | | within certain voltage limits |
| | | | and the charge-weighted cell |
| | | | voltage during discharge is |
| | | | computed. |
| Battery Cell | Operating | Potentiostat and | Average temperature of |
| | Temperature | thermocouples | battery cell as measured at |
| | | | the positive/negative |
| | | | terminal/cell shaft/etc. |
| | | | while charging/discharging, |
| | | | or at a certain voltage level, |
| | | | or while a load is applied, |
| | | | etc. |
| Battery | Anode | Potentiostat | An electrode containing an |
| Half-Cell | Discharge | | active anode material (or a |
| | (de- | | mixture of active materials) |
| | lithiation) | | of interest is charged and |
| | Potential | | discharged (by passing |
| | (e.g., V) | | electrical current to the |
| | | | electrode) within certain |
| | | | potential limits using an |
| | | | electrochemical cell with a |
| | | | suitable reference electrode, |
| | | | typically lithium metal. The |
| | | | charge-averaged cell |
| | | | potential upon discharge |
| | | | (corresponding to de- |
| | | | lithiation of the anode) is |
| | | | computed. |
| Battery | Cathode | Potentiostat | An electrode containing an |
| Half-Cell | Discharge | | active cathode material (or a |
| | (lithiation) | | mixture of active materials) |
| | Potential | | of interest is charged and |
| | (e.g., V) | | discharged (by passing |
| | | | electrical current to the |
| | | | electrode) within certain |
| | | | potential limits using an |
| | | | electrochemical cell with a |
| | | | suitable reference electrode, |
| | | | typically lithium metal. The |
| | | | charge-averaged cell |
| | | | potential upon discharge |
| | | | (corresponding to lithiation |
| | | | of the cathode) is computed. |
| Battery Cell | Volumetric | Potentiostat | The VED is calculated by |
| | Energy | | first calculating the energy |
| | Density | | per unit area of the battery, |
| | (VED) | | and then dividing the energy |
| | | | per unit area by the sum of |
| | | | the illustrative anode, |
| | | | cathode, separator, and |
| | | | current collector thicknesses |
| Battery Cell | Internal | Potentiostat | The internal resistance (also |
| | Resistance | | known as impedance in |
| | (impedance) | | many contexts) is measured |
| | | | by applying small pulses of |
| | | | current to the battery cell |
| | | | and recording the |
| | | | instantaneous change in cell |
| | | | voltage. |

In certain aspects, the disclosure relates to batteries. While the description below may describe certain examples in the context of Li metal and Li-ion batteries (for brevity and convenience, and because of the current popularity of Li technology), it will be appreciated that various aspects may be applicable to other rechargeable and primary batteries (such as Na and Na-ion, Mg and Mg-ion, K and K-ion, Ca and Ca-ion, and other metal and metal-ion batteries, dual ion batteries, alkaline or alkaline ion batteries, flow batteries, etc.) as well as electrochemical capacitors and hybrid energy storage devices.

In one or more embodiments of the present disclosure, a separator coating comprises ceramic particles comprising a mixture of higher-aspect ratio ceramic particles (HARCPs) (including higher-aspect ratio ceramic nanoparticles) and lower-aspect ratio ceramic particles (LARCPs) (including lower-aspect ratio ceramic nanoparticles). The HARCPs may also be referred to as elongate ceramic (nano) particles.

As used herein, elongate (nano) particles (such as dense and porous (nano) fibers, (nano) wires, whiskers, (nano) tubes, (nano) ribbons, etc.) of suitable size (e.g., diameter [or, more generally, average transverse dimensions (e.g., widths) in directions perpendicular to the elongate direction (longitudinal direction)] from around 1.0 nm to around 950.0 nm), shape, aspect ratios, density, porosity, crystal structure, and morphology may be generally referred to herein as either “(nano) fibers” or “(nano) wires”. Herein, the terms “higher-aspect ratio (nano) particles,” “elongate (nano) particles,” “(nano) fibers,” and “(nano) wires” may be used interchangeably.

In one or more embodiments of the present disclosure, a suitable aspect ratio (width-to-length) of individual elongate (nano) particles (of various compositions) may preferably range from around 1:3 to around 1:1,000,000 (e.g., around 1:3-1:10; around 1:10-1:30; around 1:30-1:100; around 1:3-1:30; around 1:10-1:100,000; around 1:10-1:100; around 1:100-1:1,000; around 1:100-10,000; around 1:1,000-10,000; around 1:10,000-1:100,000, or around 100,000-1,000,000). Too high aspect ratio may make it difficult for the (nano) fibers to be properly dispersed in a slurry formulation, while too low aspect ratio may make them less effective. In some designs, an aspect ratio in the range from around 1:3 to around 1:100 (e.g., around 1:3-1:30) may be advantageously used. Herein, an aspect ratio of 1:x (e.g., 1:3) is also sometimes written as x (e.g., 3).

In one or more embodiments of the present disclosure, a suitable aspect ratio (width-to-length) of individual lower-aspect ratio (nano) particles (of various compositions) may preferably range from around 1:1 to around 1:3 (around 1:1 to 1:2; around 1:2-1:3; around 1:1-1:1.5; in yet other designs, from around 1:1.5-1:3). The lower-aspect ratio (nano) particles may be, for example, approximately spheroidal, approximately ellipsoidal, jagged, branched, or have a flake-like shape.

While the description below may describe certain examples in the context of metal oxide (nano) particles (e.g., (nano) wires, nanofibers, fibers, lower-aspect ratio (nano) particles), it will be appreciated that various aspects may be applicable to metal fluoride, metal oxy-fluoride, metal hydroxide, metal phosphate, metal phosphate-hydroxide, metal phosphate-oxy-hydroxide, metal oxy-hydroxide, their various mixtures and combinations, polymer-coated ceramic and other ceramic (nano) particles (e.g., (nano) wires or nanofibers or fibers or lower-aspect ratio (nano) particles). It will also be appreciated, that elongated polymer (nano) particles (nanofibers), polymer fibers, polymer-ceramic composite (nano) particles (nanofibers) or fibers may be used in addition to or instead of the ceramic (nano) particles, in some designs.

While the description below may describe certain examples of aluminum (Al)-based ceramic (nano) wires or (nano) fibers or fibers or lower-aspect ratio (nano) particles (e.g., Al₂O₃ or AlO(OH) or Al(OH)₃), it will be appreciated that metals other than Al or their various combinations (incl. various combinations with Al) may be used for the formation of such ceramic (nano) wires or nanofibers or fibers or lower-aspect ratio (nano) particles (e.g., silicon (Si), magnesium (Mg), niobium (Nb), lithium (Li), sodium (Na), potassium (K), calcium (Ca), zinc (Zn), etc.). In some designs, more than one metal may be utilized in the ceramic (nano) wires or nanofibers or fibers or lower-aspect ratio (nano) particles. The optimum ceramic composition may be affected by the desired mechanical, physical, chemical and electrochemical stability properties needed for a given application and a given battery electrode chemistry. For example, if ceramic fibers are used in a separator for a LIB with a low-potential anode (e.g., Li metal anode or graphite anode or Si-based anode), it is important that there would be a low probability for these to get electrochemically reduced during LIB operation and so their composition and distribution within a membrane may be selected accordingly. In some designs, for example, a portion of the composite membrane (e.g., about 0.005-5.0 micron (μm)) in a direct contact with an anode may preferably not comprise any ceramic nanowires or nanofibers or fibers or lower-aspect ratio (nano) particles in order to prevent their electrochemical reduction.

While the description below may describe certain examples in the context of solid or porous ceramic (nano) wires (or (nano) fibers), it will be appreciated that other shapes of solid or porous ceramic materials (e.g., dendritic particles and nanoparticles; branched fibers or nanofibers; flakes or nanoflakes; etc.) and their various combinations may be utilized in some membrane designs.

While the description below may describe certain examples in the context of one type of ceramic (nano) particle (e.g., (nano) wire, (nano) fiber, lower-aspect ratio (nano) particle) composition, it will be appreciated that two, three or more distinctly different (nano) particle (e.g., (nano) wire, (nano) fiber, lower-aspect ratio (nano) particle) compositions may be advantageously used in some designs. It may be, in fact, advantageous to combine (nano) wires (or (nano) fibers or lower-aspect ratio (nano) particle) having different dimensions (e.g., use larger diameter and longer dimensions nanofibers or fibers for enhanced dimensional stability and mechanical properties in combination with smaller diameter and shorter (nano) fibers or lower-aspect ratio (nano) particles for templating smaller pores, etc.). In some designs, the (nano) wires or (nano) fibers or lower-aspect ratio (nano) particles having different dimensions or composition, may also exhibit different chemical formula or microstructure or aspect ratio or roughness or porosity or other chemical or physical properties or belong to entirely different class of materials (e.g., one being a ceramic and another being a polymer or a polymer composite).

While the description below may describe certain examples in the context of ceramic (nano) particle (e.g., (nano) wire, (nano) fiber, lower-aspect ratio (nano) particle) composition, it will be appreciated that in some designs the separator membrane or the separator layer (separator coating) may comprise polymer (nano) fibers (or fibers or lower-aspect ratio (nano) particles) (e.g., on their own or in combination with the ceramic (nano) particles). In some designs, composite polymer-ceramic nanofibers or fibers or lower-aspect ratio (nano) particles may be used instead of or in addition to the polymer nanofibers or fibers or lower-aspect ratio (nano) particles.

Depending on the application, in an example, the suitable true density (taking into consideration closed porosity) of (nano) fibers (or (nano) wires or lower-aspect ratio (nano) particles) may range from around 0.3 to around 4 g/cm³ (e.g., for ceramic particles comprising only Al metal in their composition) and to around 6 g/cm³ (e.g., for particles comprising metals other than Al in their composition) in the context of one or more embodiments of the present description. Depending on the application and the processing conditions, in an example, the suitable pore volume (e.g., open pore volume) within individual fibers or nanofibers or lower-aspect ratio (nano) particles may range from around 0 to around 5 cm³/g (e.g., around 0.01-3 cm³/g; or around 0.05-1 cm³/g). Depending on the application and the processing conditions, in an example, the microstructure may range from amorphous to nanocrystalline to polycrystalline to single crystalline to a mixture of those other types. Depending on the application and processing conditions, in an example, the suitable surface roughness of the nanofibers may range from around 0 nm to around 100 nm.

Depending on the application, in an example, the suitable Brunauer-Emmett-Teller (BET) specific surface area (SSA) of the nanowires (or nanofibers or lower-aspect ratio (nano) particles) may range from around 2.0 m²/g to around 4000.0 m²/g (e.g., around 2.0-50.0 m²/g; around 50.0-100.0 m²/g; around 100.0-250.0 m²/g; around 250.0-500.0 m²/g; around 500.0-1000.0 m²/g; around 1000.0-4000.0 m²/g; around 2.0-30.0 m²/g; around 30.0-50.0 m²/g; around 30.0-400.0 m²/g; around 250.0-400.0 m²/g; around 400.0-500.0 m²/g; or around 3.0-400.0 m²/g). In some designs, the optimal range may depend on the specific membrane composition, properties of (nano) wires or (nano) fibers or lower-aspect ratio (nano) particles (such as composition, morphology, crystal structure, porosity, etc.), desired mechanical properties of the membrane required for battery cell assembling or safe cell operation, among other factors.

In one or more embodiments of the present disclosure, the suitable diameter (or width) of individual (nano) wires or (nano) fibers or lower-aspect ratio (nano) particles (of various compositions) may range from around 1 nm to around 950 nm (e.g., about 5.0-500.0 nm; about 5-950 nm; about 1.0-500.0 nm; or about 500-950 nm).

In one or more embodiments of the present disclosure, the suitable length (i.e., length along the elongate direction of each respective (nano) particle) of elongate (nano) particles (also referred to as higher-aspect ratio (nano) particles) (of various compositions) may range from around 50.0 nm to around 5.0 mm (e.g., in some designs, an average length may range from around 250.0 nm to around 500.0 μm; around 50.0 nm-2.5 μm; around 2.5 μm-25.0 μm; around 25.0 μm-100.0 μm; around 100.0 μm-5.0 mm; around 2.0 μm-25.0 μm; around 25.0 μm-50.0 μm; around 2.0 μm-50.0 mm; around 1.0 μm-25.0 μm; or around 1.0 μm-30.0 μm).

In one or more embodiments of the present disclosure, the suitable length of lower-aspect ratio (nano) particles (of various compositions) may range from around 50 nm to around 5.0 μm (e.g., in some designs, an average length may range from around 50 nm to around 0.1 μm; around 0.1 μm-1.0 μm; around 1.0 μm-2.0 μm; around 2.0 μm-3.0 μm; around 3.0 μm-5.0 μm; around 0.1 μm-3.0 μm; around 1.0 μm-3.0 μm; around 0.1 μm-5.0 μm; or around 1.0 μm-5.0 μm).

In some designs and applications, the individual (nano) fibers may be agglomerated into bundles or into flexible threads or into flexible yarns and may be parts of the final separator coating and/or membrane composition.

In one or more embodiments of the present disclosure, the elongate (nano) particles (higher-aspect ratio (nano) particles) comprise ceramic material, and hence may be referred to as elongate ceramic (nano) particles (higher-aspect ratio ceramic (nano) particles). In one or more embodiments of the present disclosure, the lower-aspect ratio (nano) particles comprise ceramic material, and hence may be referred to as lower-aspect ratio ceramic (nano) particles. In some implementations, the ceramic material may comprise aluminum (Al) and/or magnesium (Mg) and may comprise an oxide, an oxyhydroxide, and/or a hydroxide. In some implementations, the ceramic material may additionally comprise lithium (Li) (in some designs, the fraction of Li may range from about 10 ppm to about 1 at. % relative to the total ceramic material composition). In implementations in which the ceramic comprises Al, the ceramic may comprise aluminum oxide (e.g., alumina (Al₂O₃) such as γ-alumina and α-alumina), aluminum oxyhydroxide (e.g., boehmite (AlO(OH)) or another polymorph crystalline or amorphous microstructure), and/or aluminum hydroxide (e.g., Al(OH)₃-having, for example, bayerite, gibbsite, nordstrandite, pseudoboehmite, or another polymorph microstructure).

In the context of one or more embodiments of the present description, the term “dispersion” refers to a mixture of solid(s) and liquid(s) whereas the solid(s) interact(s) with the liquid(s) in a way which changes the fluid properties of both the solid(s) and liquid(s). For example, solid (nano) particles of various shapes and sizes may be dispersed in a liquid causing the viscosity of the liquid to increase and the Brownian motion of the particles to increase. The term “dispersion” may further refer to the condition where solid (nano) particles of various shapes and sizes are being suspended in a liquid (solvent). In the context of one or more embodiments of the present description, the term “stable dispersion” refers to the conditions where particles (such as fibers, flakes, nanoparticles or particles of various other shapes and sizes) remain suspended for a timescale that is sufficient for a given processing stage (e.g., such as casting the dispersion into a film on a substrate, etc.).

While the description below may also describe certain examples of the material formulations in a Li-free state (for example, as in silicon-comprising (nano) composite anodes or metal fluoride cathodes or sulfur cathodes, etc.), it will be appreciated that various aspects may be applicable to Li-comprising electrodes and active materials (for example, partially or fully lithiated Si-comprising anodes or partially or fully lithiated Si-comprising anode particles, partially or fully lithiated metal fluoride comprising cathodes (such as a mixture of LiF and metals such as Cu, Fe, Ni, Bi, Zr, Ti, Mg, Nb, and various other metals and metal alloys and mixtures of such and other metals, etc.) or partially or fully lithiated metal halide comprising cathode particles, partially or fully lithiated chalcogenides (such as Li₂S, Li₂S/metal mixtures, Li₂Se, Li₂Se/metal mixtures, Li₂S—Li₂Se mixtures, various other compositions comprising lithiated chalcogenides etc.), partially or fully lithiated metal oxides (such as Li₂O, Li₂O/metal mixtures, etc.), partially or fully lithiated intercalation-type cathode materials, partially or fully lithiated carbons, among others). In some designs, various material properties (e.g., at particle level, at inter-particle level, at electrode level, etc.) may change based on whether active material particle(s) are in a Li-free state, a partially lithiated state, or a fully lithiated state. Such Li-dependent material properties may include particle pore volume, electrode pore volume, and so on. Unless stated or implied otherwise, reference to such Li-dependent anode material properties (e.g., at particle level, at inter-particle level, at electrode level, etc.) may be assumed to be provided as if the active material particles are in the Li-free state. Further, some examples below are characterized at the electrode level (e.g., as opposed to particle level or interparticle level or cell level, etc.). Below, unless stated or implied otherwise, reference to such electrode level properties (e.g., electrode porosity or areal capacity loading or gravimetric/volumetric capacity, etc.) may be assumed to refer to the electrode components (e.g., active material particles, binder, conductive additives, etc.), excluding the current collector.

While the description below may describe certain examples in the context of some specific alloying-type, conversion-type and intercalation-type chemistries for anode active materials and conversion-type and intercalation-type chemistries for cathode active materials for Li-ion batteries (such as silicon-comprising anodes or metal fluoride-comprising or lithium sulfide-comprising cathodes), it will be appreciated that various aspects may be applicable to other chemistries for Li-ion batteries (other conversion-type and alloying-type electrodes as well as various intercalation-type anodes and cathodes) as well as to other battery chemistries. In the case of metal-ion batteries (such as Li-ion batteries), examples of other suitable conversion-type electrodes include metal fluorides, metal oxyfluorides, metal chlorides, metal iodides, metal bromides, sulfur, metal sulfides (including lithium sulfide), selenium, metal selenide (including lithium sulfide), metal oxides, metal nitrides, metal phosphides, metal hydrides, their various mixtures, composites (including nanocomposites) and alloys and others.

During battery (such as a Li-ion battery) operation, conversion materials change (convert) from one crystal structure to another (hence the name “conversion”-type), where a material structure and composition may chemically and structurally change to one or multiple structures. This process is also accompanied by breaking chemical bonds and forming new ones. During battery (e.g., Li-ion battery) operation, Li ions are inserted into alloying-type materials forming lithium alloys (hence the name “alloying”-type). Sometimes, “alloying”-type electrode materials are considered to be a subclass of “conversion”-type electrode materials.

While the description below may describe certain examples in the context of Si—C composite (e.g., nanocomposite) anode active materials (e.g., (nano) composite particles which comprise silicon (Si) and carbon (C) and may comprise other elements, such as nitrogen (N), phosphorus (P), boron (B), oxygen (O), hydrogen (H), sulfur(S), fluorine (F), to name a few and where a total mass of the Si and the C atoms may contribute from about 75 wt. % to about 100 wt. % of the total mass of the composite particles), it will be appreciated that various aspects may be applicable to other types of the high-capacity silicon-comprising anode active materials (including, for example, various silicon-comprising or silicon oxide-comprising or silicon nitride-comprising or silicon oxy-nitride-comprising or silicon phosphide-comprising particles or particles comprising a mixture or alloy or other combinations of such active materials, various other types of Si-comprising composites including core-shell or hierarchical or (nano) composite particles, etc.).

An aspect is directed to a battery anode composition comprising a population of Si-comprising particles (e.g., nanocomposite particles, among others), in which some or all of the Si-comprising particles comprise silicon (Si) and carbon (C) elements and may comprise other elements, such as nitrogen (N), phosphorus (P), boron (B), oxygen (O), hydrogen (H), sulfur(S), fluorine (F), to name a few. In some embodiments, the total mass of the Si and the C (on average) in the Si-comprising particles may contribute from about 75 wt. % to about 100 wt. % of the total mass of the Si-comprising particles. Such composite particles are sometimes referred to herein as Si—C composites (or nanocomposites, if Si and/or C are nanostructures, for example). In some embodiments, Si—C nanocomposites are produced by infiltrating Si (e.g., nanoparticles) into porous C particles (e.g., by CVD) and sealing or closing the remaining pores with protective coatings (e.g., C coating; e.g., by CVD). In some embodiments, it may be preferable for the Si—C composite particles to exhibit one or more of the following characteristics: (i) BET specific surface area (BET SSA) of less than 10 m²/g, preferably less than 5 m²/g, more preferably less than 2 m²/g); (ii) D₅₀ in the range from 3 to 10 micron (preferably from 4 to 8 micron); (iii) span of less than 1.5 (preferably less than 1.2, more preferably less than 1.0).

In some embodiments, a total atomic fraction of the Si and the C may contribute from about 75 at. % to about 100 at. % of the overall composite particles. Such composite particles are sometimes referred to herein as Si—C composites. In some embodiments, such composite particles comprise nano-sized or nanostructured elements (e.g., nano-sized or nanostructured Si, nano-sized or nanostructured C, or both), which may be referred to as nanocomposite particles. In some implementations, the Si or Si-comprising active material present in such nanocomposites may be in the form of nanoparticles. In some implementations, the mass-average size of Si or Si-comprising active material nanoparticles (or nanocrystals) may range from about 1 nm to about 200 nm (e.g., about 1.0-10.0 nm; about 10.0-30.0 nm; about 30.0-100.0 nm; or about 100-200 nm), as measured using image analysis of electron microscopy (e.g., transmission electron microscopy (TEM), scanning transmission electron microscopy (STEM), scanning electron microscopy (SEM)), X-ray microscopy, X-ray diffraction, neutron scattering and other suitable techniques. X-ray diffraction may be particularly convenient and easy for identifying the average size of Si nanocrystals. Too small (e.g., smaller than about 1.0 nm in some designs or, e.g., about 2 nm in other designs) Si nanocrystals may exhibit too high reactivity during synthesis and become less active or induce too high first cycle capacity losses, while too large (e.g., larger than about 200 nm in some designs or, e.g., about 100 nm in other designs) Si crystals may reduce cycle stability of such Si—C composites (nanocomposites) or, broadly, nanocomposite silicon. As used here, a “nano”-material (e.g., nanostructure or nanoparticle or nanocomposite, etc.) may refer to any material that exhibits at least one dimension that is less than about 200 nm.

An aspect is directed to a battery anode composition comprising a population of Si-comprising particles (e.g., nanocomposite particles, among others), in which each of the particles comprises Si and C, and the Si-comprising (e.g., composite) particles exhibit, on average, specific reversible capacity (as measured in half cells using a proper charge-discharge protocol such as, for example, by lithiation of the anode at the constant current density of about 0.1 C to about 0.01 V vs. Li/Li⁺ followed by taper till the current density decreases to about 0.01 C and then followed by delithiation at the constant current density of about 0.1 C to about 1.5 V vs. Li/Li⁺; note that the capacity of the Si-comprising (e.g., composite) particles may be estimated from the anodes comprising known wt. % blends with known graphite that have known specific capacity of its own) in the range of about 1400 mAh/g to about 2800 mAh/g (e.g., about 1400-1600 mAh/g; about 1600-1800 mAh/g; about 1800-2000 mAh/g; about 2000-2200 mAh/g; about 2200-2400 mAh/g; about 2400-2600 mAh/g; about 2600-2800 mAh/g). Similarly, the irreversible (first cycle) specific capacity of the particles that comprise Si and C may preferably range from about 1500 mAh/g to about 2900 mAh/g (e.g., about 1500-1700 mAh/g; about 1700-1900 mAh/g; about 1900-2100 mAh/g; about 2100-2300 mAh/g; about 2300-2500 mAh/g; about 2500-2700 mAh/g; or about 2700-2900 mAh/g).

An aspect is also directed to a Li-ion battery comprising: (i) a suitable battery anode, wherein the suitable anode may comprise one or more of the following, in some designs: (ia) Si-comprising anode comprising Si-comprising anode particles (e.g., nanocomposite Si—C particles, silicon oxide particles, silicon nitride particles, among others), which, in some design may also be a blended battery anode (wherein both the Si-comprising active anode particles (e.g., nanocomposite Si—C particles or silicon oxide particles or silicon nitride particles, among others) and suitable graphite (or, broadly, carbon-based) active anode particles are present in the anode), (ib) intercalation-type carbon (C)-comprising anode comprising natural graphite, synthetic graphite, hard carbon or soft carbon or their various combinations or (ic) metal oxide-comprising anode (e.g., Li, Ti, Nb, Mo, V and/or W-comprising metal oxides, such as, for example, lithium titanium oxide, niobium titanium oxide, niobium molybdenum oxide, niobium molybdenum titanium oxide, niobium tungsten oxide, niobium tungsten molybdenum oxide, niobium tungsten molybdenum titanium oxide, vanadium oxide, their various combinations and mixtures, etc.) or (id) their various combinations and (ii) a suitable battery cathode, wherein the suitable cathode may comprise one or more of the following, in some designs: (iia) intercalation-type cathode or (iib) conversion-type cathode (which may include a displacement-type cathode, a chemical transformation type cathode or a true conversion-type cathode) or (iic) a mixed intercalation/conversion type cathode (either a physical mixture of (iia) and (iib) or a cathode that exhibits both intercalation-type or conversion-type Li-ion storage).

In some designs, a suitable cathode may advantageously comprise one, two, or more of the following additives (e.g., in the form of particles, nanoparticles, nanofibers, flakes or nanoflakes): natural graphite, synthetic graphite, graphene, graphene oxide, exfoliated graphite, hard carbon, soft carbon, carbon black, carbon fibers, carbon nanofibers, carbon nanotubes in the total amount from around 0.1 wt. % to about 15 wt. % relative to the total weight of the cathode layer (including any part of the cathode layer that infiltrates into pores of the cathode current collector) but not counting the weight of the cathode current collector (e.g., about 0.1-0.5 wt. %; about 0.5-2.0 wt. %; about 2.0-5.0 wt. %; about 5.0-15.0 wt. %).

Illustrative examples of suitable intercalation-type cathodes to be used in preferable cells may include: lithium nickel cobalt aluminum oxides (NCA), lithium nickel cobalt manganese aluminum oxides (NCMA), lithium nickel oxides (LNO), lithium manganese oxides (LMO), lithium manganese rich layered oxide cathodes (LMR), lithium nickel manganese cobalt oxides (NCM) (or NCM-type layered cathodes with little-to-no cobalt), lithium cobalt oxide (LCO), lithium cobalt aluminum oxides (LCAO), lithium iron phosphate (LFP), lithium cobalt phosphate (LCP), lithium manganese phosphate (LMP), lithium manganese iron phosphate (LMFP), lithium nickel phosphate (LiNiPO₄), lithium vanadium fluoro phosphate (LiVFPO₄), lithium iron fluoro sulfate (LiFeSO₄F), various Li excess materials (e.g., lithium excess (rocksalt) transition metal oxides and oxy-fluorides such as those comprising Mn, Mo, Cr, Ti, and/or Nb, such as, for example, Li_{1.211}Mo_{0.467}Cr_{0.3}O₂, Li_{1.3}Mn_{0.4}Nb_{0.3}O₂, Li_{1.2}Mn_{0.4}Ti_{0.4}O₂, Li_{1.2}Ni_{0.333}Ti_{0.333}Mo_{0.133}O₂), various high capacity Li-ion based materials with partial substitution of oxygen for fluorine or iodine (e.g., disordered or ordered rocksalt compositions comprising Mn, Mo, Cr, Ti and/or Nb, such as, for example, Li₂Mn_{2/3}Nb_{1/3}O₂F, Li₂Mn_{1/2}Ti_{1/2}O₂F, Li_{1.5}Na_{0.5}MnO_{2.85}I_{0.12}) and many other types of Li-comprising disordered, layered, tavorite, olivine, or spinel type active materials or their mixtures comprising at least oxygen or fluorine or sulfur and at least one transition metal and other lithium transition metal (TM) oxides or phosphates or sulfates (or mixed) cathode active materials that rely on the intercalation of lithium (Li) and changes in the TM oxidation state. In some implementations, the cathode active material comprises at least one transition metal, selected from nickel (Ni), manganese (Mn), cobalt (Co), and iron (Fe).

Illustrative examples of suitable conversion-type cathodes to be used in preferable cells may include: metal fluorides, metal oxy-fluorides, metal chlorides, metal sulfides, metal selenides, their various mixtures, composites and others. Illustrative examples of metal fluorides, in a Li-free state, include FeF₃, FeF₂, MnF₃, CuF₂, NiF₂, BiF₃, BiF₃, SnF₂, SnF₄, SbF₃, SbF₅, CdF₂, ZnF₂, TiF₃, TiF₄, AgF, AgF₂, NbF₅, NbF₄, MoF₅, MoF₄, MoF₃, ZrF₄, BaF₂, SrF₂, YF₃, LaF₃, PbF₂, PbF₄, CeF₃, CeF₄, SmF₃, CaF₂, their various mixtures, alloys and combinations. In some designs, Fe may contribute to the majority (e.g., about 50-100 at. %; in some designs, about 75-100 at. %) of the transition metals in the metal fluoride cathodes. In some designs, Cu may contribute to the majority (e.g., about 50-100 at. %; in some designs, about 75-100 at. %) of the transition metals in the metal fluoride cathodes.

In some of the preferred examples, a surface of cathode active materials (e.g., intercalation-type cathode materials, such as LCO, NCM, NCMA, NCA, LMO, LMNO, LFP, LMP, LMFP, etc. or conversion-type active materials comprising S, Li₂S, metal sulfides, metal fluorides, etc.) may be coated with a layer of ceramic (e.g., oxide) material (e.g., comprising one, two or more of Li, Mg, Al, Ti, Zr, W and/or Nb, among other metals). In some of the preferred examples, a surface of cathode active materials may be coated with a layer of a polymeric material. In some designs, a preferred cathode current collector material is aluminum or aluminum alloy or an aluminum-comprising composite. In some designs, a preferred anode current collector material is copper or copper alloy or a copper-comprising composite. In some designs, a preferred battery cell includes a polymer or polymer-comprising separator membrane or a polymer-comprising separator layer.

An aspect is directed to a Li-ion battery with a Si-comprising anode or with a blended anode (e.g., comprising Si-comprising active material (e.g., Si—C composite particles) and graphite active material, etc.) that exhibits a relatively high areal capacity loading and properly matched (by areal capacity) cathode (with slightly smaller areal capacity loadings, selected according to the desired negative (N) to positive (P) ratio, N/P (the N/P ratio corresponds to the ratio of the reversible areal capacities of the anode to cathode) in a range of around 0.95 to around 1.35 (e.g., around 0.95-1.01; around 1.01-1.05; around 1.05-1.10; around 1.10-1.15; around 1.15-1.20; around 1.20-1.25; or around 1.25-1.35). Note that both the performance characteristics and cycle stability of Li-ion battery cells may become particularly unsatisfactory for applications requiring long calendar life or long cycle life or low first cycle losses, or other properties if the electrode areal capacity loading exceeds around 1-2 mAh/cm², even more, if the electrode areal capacity exceeds around 4-5 mAh/cm², yet even more if the electrode areal capacity exceeds around 6 mAh/cm² and yet even more if the electrode areal capacity exceeds around 8 mAh/cm². Higher loading, however, is advantageous for reducing the cost of energy storage devices and increasing their energy density. One or more embodiments of the present disclosure are directed to fabrication processes, compositions and various physical and chemical properties of anodes and cathodes that enable satisfactory performance for electrode areal loadings in the range from around 2 mAh/cm² to around 16 mAh/cm² (e.g., around 2-4 mAh/cm², around 4-8 mAh/cm², or around 8-16 mAh/cm²).

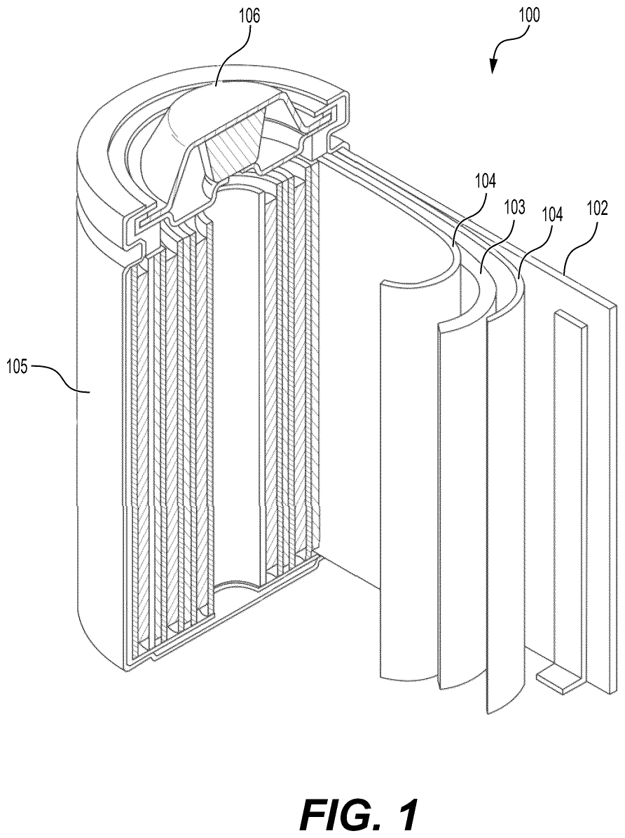

FIG. 1 illustrates an example metal-ion (e.g., Li-ion) battery in which the ceramic (nano) particles (including mixtures of higher-aspect ratio ceramic (nano) particles and lower-aspect ratio ceramic (nano) particles), separators, electrodes, integrated electrode-separator components, other components, materials, processes, and other techniques described herein, or combinations thereof, may be applied according to various embodiments. A cylindrical battery is shown here for illustration purposes, but other types of arrangements, including prismatic or pouch (laminate-type) batteries, may also be used as desired. The example battery 100 includes a negative electrode (anode electrode or anode) 102, a positive electrode (cathode electrode or cathode) 103, a separator 104 interposed between the anode 102 and the cathode 103, an electrolyte (shown implicitly) impregnating the separator 104, a battery case 105, and a sealing member 106 sealing the battery case 105. The electrolyte ionically couples the anode (negative electrode) and the cathode (positive electrode). The electrolyte is interposed between the anode electrode and the cathode electrode. In some implementations, battery 100 also includes an anode current collector and a cathode current collector. The anode is disposed on and/or in the anode current collector and the cathode is disposed on and/or in the cathode current collector. Note that a battery anode disposed “on and/or in” a current collector may refer to a battery anode that is deposited on top of the current collector, or a battery anode that is at least partially disposed inside one or more pores of a porous current collector, in some designs (in addition to and/or in place of an anode part that is deposited on top of the current collector).

Conventional electrolytes for Li- or Na-based batteries of this type are generally composed of an about 0.8-1.2 M (about 1M±about 0.2 M) solution of a single Li or Na salt (such as LiPF₆ for Li-ion batteries and NaPF₆ or NaClO₄ salts for Na-ion batteries) in a mixture of carbonate solvents with about 1-2 wt. % of other organic additives. Common organic additives may include nitriles, esters, sulfones, sulfoxides, phosphorous-based solvents, silicon-based solvents, ethers, ketones, boron-based compounds, and others. Such additive solvents may be modified (e.g., sulfonated or fluorinated). Higher (e.g., about 1.2-4 M) or lower (e.g., about 0.1-0.8 M) salt concentration may be used in some electrolyte designs in the context of aspects of the present disclosure. Furthermore, two, three or more different salts may be used in some electrolyte designs in the context of aspects of the present disclosure. In some designs, the main electrolyte solvents may not be carbonates, but be esters, ethers, sulfones, ketones or others. In some designs, electrolytes may also comprise ionic liquids (ILs). In some designs, so-called “localized high concentration electrolytes” (e.g., with florinated dilutants) may be employed to reduce the metal dissolution. Such electrolytes may work particularly well with the proposed separator technologies due to improved wetting and other complementary features.

The conventional salt used in most conventional Li-ion battery electrolytes is LiPF₆. Examples of less common salts (e.g., explored primarily in research publications or, in some cases, never even described in Li-ion battery electrolyte applications, but may still be applicable and useful) include: lithium tetrafluoroborate (LiBF₄), lithium perchlorate (LiClO₄), lithium hexafluoroantimonate (LiSbF₆), lithium hexafluorosilicate (Li₂SiF₆), lithium hexafluoroaluminate (Li₃AlF₆), lithium bis(oxalato) borate (LiB(C₂O₄)₂), lithium difluoro (oxalate) borate (LiBF₂(C₂O₄)), various lithium imides (such as SO₂FN⁻(Li⁺)SO₂F, CF₃SO₂N⁻(Li⁺)SO₂CF₃, CF₃CF₂SO₂N⁻(Li⁺)SO₂CF₃, CF₃CF₂SO₂N⁻(Li⁺)SO₂CF₂CF₃, CF₃SO₂N⁻(Li⁺)SO₂CF₂OCF₃, CF₃OCF₂SO₂N⁻(Li⁺)SO₂CF₂OCF₃, C₆F₅SO₂N⁻(Li⁺)SO₂CF₃, C₆F₅SO₂N⁻(Li⁺)SO₂C₆F₅ or CF₃SO₂N⁻(Li⁺)SO₂PhCF₃, and others), lithium difluorophosphate, and others.

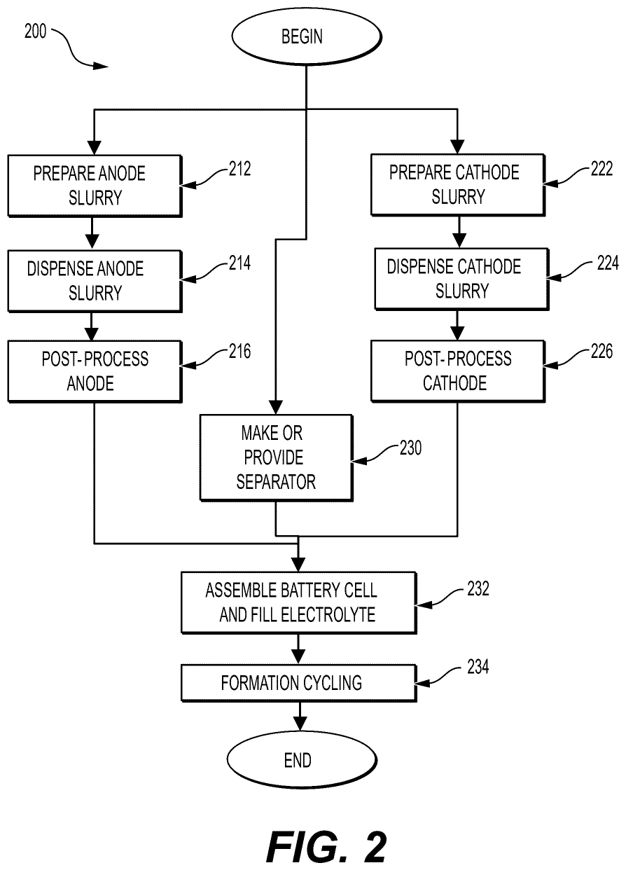

FIG. 2 illustrates an example process 200 of making a Li-ion battery. This example shows the formation of both electrodes (anode and cathode). The flow diagram includes a left branch, a right branch, and a middle branch. The left branch relates to the formation of an anode, and includes stages 212, 214, and 216. The right branch relates to the formation of a cathode, and includes stages 222, 224, and 226. The middle branch relates to making or providing a separator and includes stage 230. For each of the left and right branches, an electrode (an anode or a cathode) may be formed by casting from a slurry onto and/or into a current collector. At stage 230, a separator is made or otherwise provided. In the example shown, the left, the middle, and the right branches may be carried out concurrently or sequentially as desired. In addition, process 200 also includes stages 232 and 234, which are carried out after the left, the middle, and the right branches have been carried out. At stage 230, a separator is made or otherwise provided, as described herein. Stage 232 includes assembling of the battery cell from the battery components (e.g., anode, cathode, separator, battery case, sealing member) and filling the cell with an electrolyte. Stage 234 includes carrying out any formation cycling on the assembled battery, to form a solid-electrolyte interphase (SEI) layer in the anode and/or the cathode.

The battery electrode may comprise a current collector and an electrode material disposed on and/or in the current collector (e.g., the electrode material may be deposited at least partially “in” the current collector if the current collector is (internally) porous and/or has a rough or porous surface). In still further aspects, the electrode material may be disposed as an electrode coating. In still further aspects, the electrode coating may have an average thickness in a range of about 5 μm to about 200 μm (e.g., about 5-10 μm, about 10-20 μm, about 20-40 μm, about 40-60 μm, about 60-80 μm, about 80-100 μm, or about 100-200 μm). The electrode material may comprise a battery electrode composition and a binder. In some embodiments, a coating density of the battery anode is in a range of about 0.8 to about 1.7 g/cm³ (e.g., about 0.8-0.9 g/cm³; about 0.9-1.0 g/cm³; about 1.0-1.2 g/cm³; about 1.2-1.4 g/cm³, or about 1.4-1.7 g/cm³). In some embodiments, a coating density of the battery cathode is in a range of about 1.2 to about 4.6 g/cm³ (e.g., about 1.2-2.0 g/cm³; about 2.0-2.8 g/cm³; about 2.8-3.5 g/cm³; about 3.5-4.0 g/cm³, or about 4.0-4.6 g/cm³).

In still further aspects, the battery electrode composition may comprise active materials suitable for a specific battery. The battery electrode composition may comprise, for example, (e.g., particles comprising) graphite or graphitic active materials (e.g., synthetic graphite, natural graphite, hard carbon, and/or soft carbon, etc.), silicon oxide, silicon nitride or, more broadly, silicon-comprising active materials (including composites or nanocomposites, such as Si—C nanocomposites, among others), metal oxide (e.g., lithium titanate, niobium oxide, niobium titanium oxide, lithium niobium titanium oxide, vanadium oxide, lithium vanadium oxide, etc.) and other active anode materials, conductive additives, other functional additives, but may be substantially free of solvents (e.g., after the solvents of the slurry have evaporated to form an electrode coating). In certain aspects, the anode active materials may be provided as particles or as core-shell particles or composite anode particles. In still further aspects, the anode active materials may comprise Si-comprising composite particles whereby Si-comprising active material is deposited within pore(s) of a particle core.

The battery electrode (e.g., anode electrode) composition, as described herein, may comprise composite particles, wherein each of the composite particles may comprise carbon and silicon. It is understood that a ratio of carbon and silicon in the composite particles can be any ratio that provides the desired battery performance. In some embodiments, a mass fraction of the silicon in the Si-comprising composite particles is in a range of about 3 wt. % to about 80 wt. % (e.g., about 3-20 wt. %; about 20-35 wt. %; about 35-50 wt. %; about 50-80 wt. %; about 50-60 wt. %; about 60-70 wt. %; about 70-80 wt. %; about 20-80 wt. %; or about 35-60 wt. %).

In certain aspects, each or some of the composite particles may be present in a core-shell configuration.

In still further aspects, the suitable electrode materials may advantageously comprise conductive fillers (conductive additives). It is understood that the terms conductive fillers and conductive additive compositions can be used interchangeably. In such exemplary and non-limiting aspects, the conductive additive compositions may comprise one, two, or more of the following: carbon, carbon black, modified carbon, modified carbon black, dendritic carbon, graphene (incl. single-layered graphene and/or multi-layered graphene with about 2 to about 40 layers, on average (e.g., about 2-10 layers; about 10-20 layers; about 20-30 layers; or about 30-40 layers, on average), graphene oxide, graphite, exfoliated graphite, carbon nanotubes (e.g., single-walled carbon nanotubes (SWCNTs), multi-walled carbon nanotubes (MWCNTs)), carbon nanofibers, carbon fibers, carbon nano-flakes, graphite ribbons, salts of carboxymethyl cellulose (CMC) or salts of alginic acid or salts of (poly) acrylic acid (PAA) or PAA-comprising copolymer or salts of acrylamide or acrylamide-comprising copolymer (note that CMC, PAA, acrylamide and alginates are not conductive, but may help to disperse conductive additives), or any combination thereof.

In some aspects, the anode electrode material comprises lower-capacity particles (e.g., separate from higher-capacity particles such as Si—C composite particles). In some aspects, the lower-capacity particles have a charge capacity of about 400 mAh/g or less, including exemplary values of about 380 mAh/g or less, about 372 mAh/g or less, or 350 mAh/g or less. In still further aspects, the lower-capacity particles can comprise graphite-based active material particles. In some aspects, such graphite-based active material may comprise natural, artificial or a mixture of natural and artificial graphites. In some aspects, at least some of the graphite-based active material particles exhibit a specific capacity in a range of about 320 mAh/g to about 372 mAh/g. Graphite-based active material that may be useful in various aspects include various soft-type synthetic graphite (or soft carbon, broadly), various hard-type synthetic graphite (or hard carbon, broadly), and various natural graphite (which may, for example, be pitch carbon coated, among others); including those which exhibit discharge capacity from about 320 to about 372 mAh/g (e.g., about 320-350 mAh/g; or about 350-362 mAh/g; or about 362-372 mAh/g).

In some aspects, an anode for a battery cell may comprise a mixture of Si-comprising active material particles (e.g., nanocomposite Si—C particles, nanocomposite Si particles, among others) and graphite active material particles (or, more broadly, carbon active material particles) as the anode active material, a so-called blended anode. In addition to the anode active material particles (e.g., Si—C composite particles and/or graphite particles), an anode may comprise inactive material (in addition to and separate from any inactive material that may be an integral part of the anode active material particles themselves, such as a C part of a Si—C composite particle), such as binder(s) (e.g., polymer binder) and other functional additives (e.g., surfactants, electrically conductive additives, etc.). Note that blended anode active material particles refer to a mixture of distinct active material particles (e.g., Si—C composite particles and graphite particles), and, by way of example, a homogeneous mixture of Si—C composite particles by itself is not considered to be a “blend” (e.g., because the C part of the Si—C composite particles is an integral part of the Si—C composite particles). For example, blended anode active material particles instead refer to a blend of different active material particle types (e.g., Si—C composite particles and graphite particles) that are held together by a binder and would be independent particles without the presence of the binder.

In still further aspects, the composite particles and lower-capacity particles in a blended anode can be present in any ratio that provides for desired battery performance. In some aspects, a mass ratio of the composite particles to the lower-capacity particles is in a range of about 5:95 to about 99:1 (e.g., about 5:95, about 10:90, about 15:85, about 20:80; about 30:70, about 40:60, about 50:50, about 60:40, about 70:30, about 80:20, about 90:10, and about 95:5 (note that each of the foregoing example values may constitute an upper bound or a lower bound to a sub-range that is bounded to any of the other stated values, as explained in a preceding paragraph related to numerical ranges)).

Referring to FIG. 2, the method of forming the electrode first comprises preparing an electrode slurry (stages 212 and 222). At stage 212, the anode slurry may be formed by mixing the anode active material with a binder, a solvent, any conductive additives, and any other functional additives. At stage 222, the cathode slurry may be formed by mixing the cathode active material with a binder, a solvent, any conductive additives, and any other functional additives.

Alternatively, a dry electrode formation process may be utilized instead. In some designs, for example, the anode slurry at stage 212 may comprise little or no solvent, and a polymerizable binder precursor (e.g., polymerizable monomer(s), oligomer(s) or polymer(s)) and be formed by mixing the anode active material with a binder precursor, (optional small amount of solvents), any conductive additives, and any other functional additives. At stage 222, the cathode slurry may be formed by mixing the cathode active material with a binder precursor (e.g., polymerizable monomer(s), oligomer(s) or polymer(s)), (optional small amount of solvents), any conductive additives, and any other functional additives. In some designs, the anode or cathode (or both) may comprise polytetrafluoroethylene (PTFE) or PTFE-comprising co-polymer binder(s).

In still further aspects, an electrode slurry (anode slurry or cathode slurry) is dispensed onto and/or into a respective current collector at stages 214 and 224, respectively. The dispensing may be carried out using any suitable coating process, including slot die coating and blade coating. The dispensing may be carried out in a roll-to-roll process, with the current collector being in the form of a roll and being in an unrolled state during the dispensing.

In certain aspects, the current collector can comprise a metal foil, metal-coated (metallized) polymer film or porous film or mesh, metal wire, metal mesh, or any combination thereof. In certain aspects, the current collector can comprise a metallized foil. Metallized foils may be employed in some applications for which the mass of the current collector is preferably reduced as much as possible, e.g., in applications for which the gravimetric energy density is preferably as high as possible. Metallized foils are formed by forming a thin layer of metal (e.g., Cu or Cu alloy, Al or Al alloy) on a substrate that is lighter than the metal (e.g., a plastic substrate such as poly(ethylene terephthalate) (PET), polyamids, polyetheretherketone (PEEK), polyimids, aramid or para-aramid (e.g., Kevlar, Nomex, Twaron, Technora, Heracron or other polymers of similar compositions), ultra-high-molecular-weight polyethylene, high-performance liquid crystal polymer or other suitable polymer substrate, polysulfones, nanocomposite polymer films (which may include clay particles), preferably combining strength and lightweight). In certain aspects, the current collector can comprise Cu or Cu-alloy foil for anodes and Al or Al-alloy foil for cathodes, in many instances. In some designs, it may be preferable for the total current collector thickness to be in the range from about 2 micron to about 12 micron (e.g., 2-4 micron, 4-6 micron, 6-8 micron, 8-10 micron, 10-12 micron). Thinner foils may be preferable for attaining higher volumetric and gravimetric energy densities of batteries.

In still further aspects, at stages 216 and 226, the dispensed electrode compositions (either an anode composition or a cathode composition, formed by dispensing the respective slurry) are typically heated to completely evaporate the solvent and dry the electrode (e.g., in case of a wet coating process) or (e.g., in case of a dry coating process) to polymerize the binder precursor, to form an electrode coating. In case of dry electrode formation, electron beam (e-beam) polymerization (cross-linking) may also be used in some designs. In case of dry electrode formation, radical polymerization may be used in some designs. In case of dry electrode formation, cationic or anionic polymerization may be used in some designs. In case of dry electrode formation, photo (UV) polymerization may be used in some designs. In case of dry electrode formation, polytetrafluoroethylene (PTFE) or PTFE-comprising copolymer or other fluorinated polymer/copolymer or polymer/copolymer fibers may be used to entangle electrode particles (e.g., instead of or in addition to polymerizing the polymer binder precursor) and form an electrode composition. At stages 216 and 226, any other post-dispensing process steps may be carried out on the electrode coating. For example, the dispensed compositions may undergo a calendering process (compaction), which may be carried out after the drying (solvent evaporation) process (or, in some designs, after at least partial polymerization of the binder precursor or after another step of dry electrode formation). Stages 216 and 226 may additionally include other processes, such as cutting the electrode-current collector to suitable dimensions (e.g., cutting a roll of the electrode-current collector into individual pieces for assembly into a battery).

In still further aspects, stage 230 includes making or otherwise providing a separator. In some implementations, stage 230 may include providing a commercially available separator, such as a separator comprising a polymer (e.g., polyolefin) membrane. In some cases, a commercially available separator may comprise a polymer membrane and a coating of ceramic particles formed on either major surface or both major surfaces of the polymer membrane. Stages 230 may additionally include other processes, such as cutting the separator to suitable dimensions (e.g., cutting a roll of the separator into individual pieces for assembly into a battery). In some implementations, the separator may comprise ceramic (nano) particles (e.g., suitable mixtures of higher-aspect ratio ceramic (nano) particles and lower-aspect ratio ceramic (nano) particles) (e.g., within a surface coating on the separator and/or within a bulk of the separator). In some implementations, the separator may comprise the ceramic (nano) particles and other particles (e.g., other ceramic particles, polymer particles). In some examples, the ceramic (nano) particles and the other particles may be present in the separator as a mixture. In some implementations, the separator may be a stand-alone membrane. In other implementations, the separator may be integrated into the anode or the cathode or both (e.g., as a porous, electronically insulative separator layer, which may comprise ceramic (nano) particles; the separator layer, in combination with an electrolyte permeating it, may be ionically conductive).

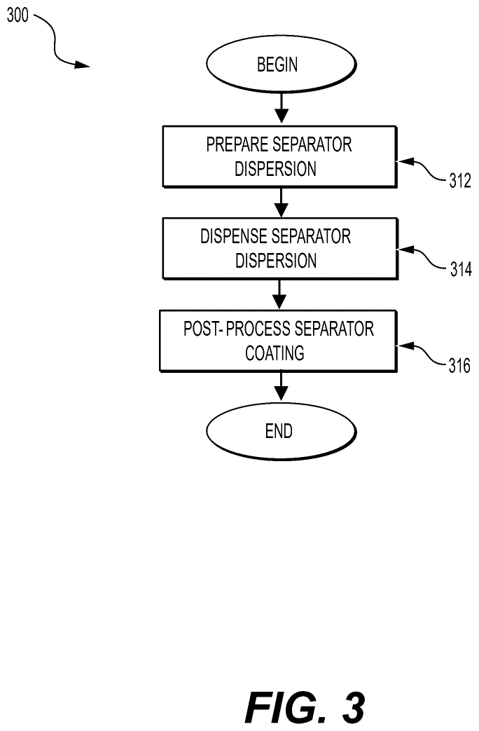

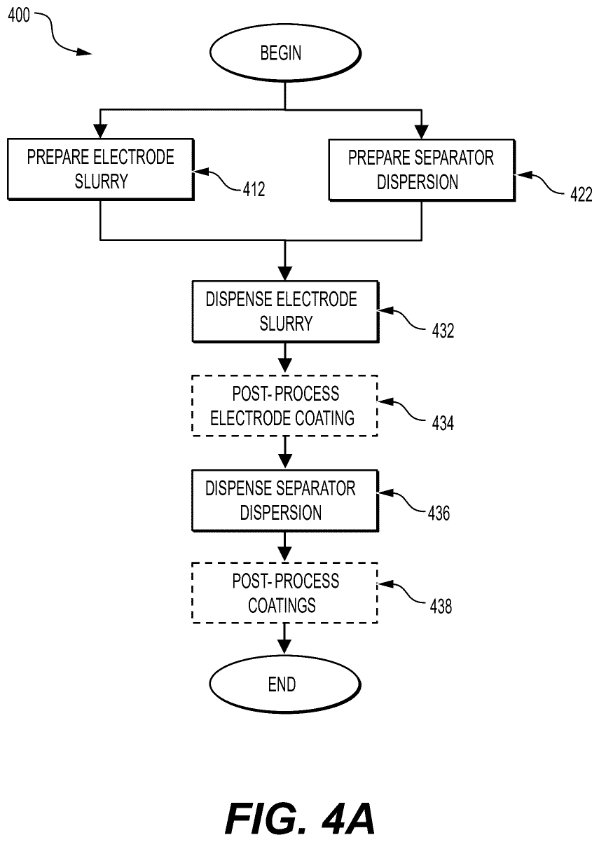

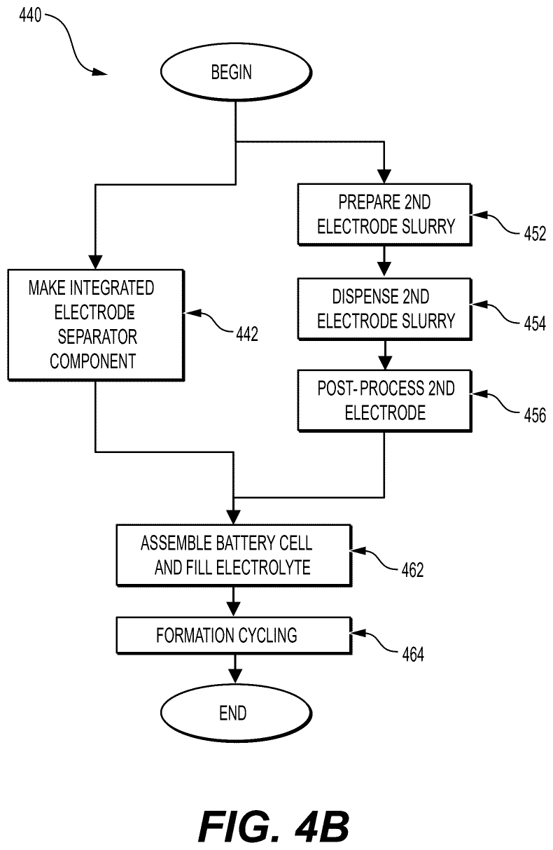

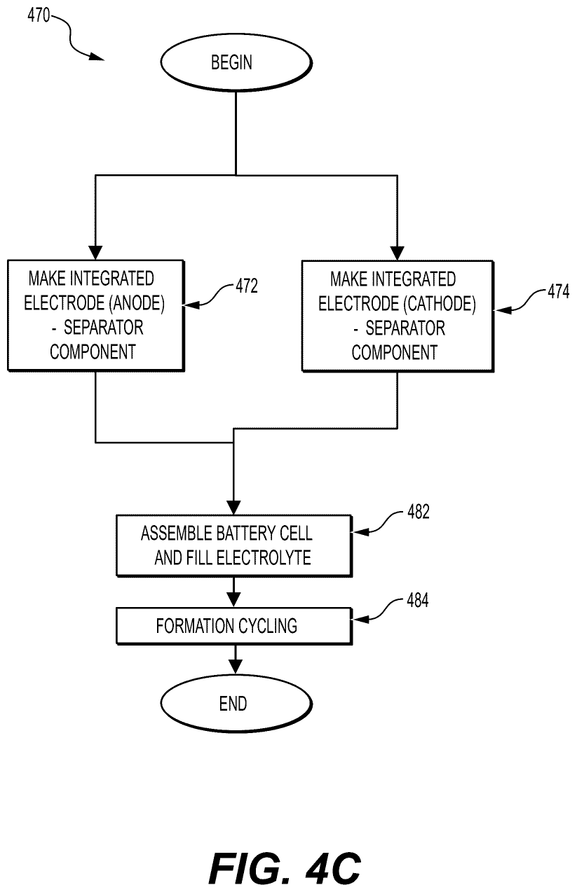

In some implementations, stage 230 may include making a separator. An example process 300 for making a separator is shown in FIG. 3. Process 300 includes stages 312, 314, and 316. Stage 312 includes preparing a separator dispersion. At stage 312, the separator dispersion may be formed by mixing ceramic (nano) particles (e.g., mixture of higher-aspect ratio ceramic (nano) particles (elongate ceramic (nano) particles) and lower-aspect ratio ceramic (nano) particles) with a binder, a solvent, and any other functional additives (e.g., surfactants, dispersants, flame retardants). Herein, examples of solvents include water and organic solvents including alcohols and N-Methyl-2-pyrrolidone (NMP). Herein, a solvent may be a mixture of suitable solvent compounds. At stage 314, the separator dispersion (e.g., obtained from stage 312) is dispensed on a substrate (e.g., a porous polymer membrane or an electrode or a sacrificial substrate, etc.). The dispensing may be carried out using any suitable coating process, including slot die coating, reverse gravure coating (kiss coating), blade coating, spray-based coating, and electrostatic jet coating. The dispensing may be carried out in a roll-to-roll process, with the substrate being in the form of a roll and being in an unrolled state during the dispensing. At stage 316, the dispensed separator composition is dried to completely evaporate the solvent, to form the separator coating. At stage 316, any other post-dispensing process steps may be carried out on the separator coating. Stage 316 may additionally include other processes, such as cutting the separator to suitable dimensions (e.g., cutting a roll of the separator into individual separator pieces for assembly into a battery). Accordingly, a separator is formed from carrying out process 300. In some implementations, the dispensing at stage 312 is carried out on a polymer membrane (e.g., polyolefin membrane) as the substrate. In some implementations, the separator comprises a polymer membrane (e.g., polyolefin membrane) and a separator coating disposed on the polymer membrane. In other implementations, the substrate on which the separator coating is formed may be an electrode coating. In some implementations, the separator coating and an electrode coating may be formed in a single roll-to-roll process (e.g., by a wet-on-wet process). In some implementations, an additional porous adhesive layer (e.g., made of PVDF or other suitable polymers) may be deposited on the surface of the separator (e.g., ceramic) coating by suitable means (e.g., spray coating, micro-rall coating, spot coating, etc.). In some implementations, the separator coating may be formed roll-to-roll on a dry (e.g., calendered) electrode (e.g., by a wet-on-dry process or by a dry-on-dry process). Such implementations are described with reference to FIGS. 4A and 4B below.

Alternatively, in some designs, a separator dispersion may comprise polymerizable monomers and/or oligomers. In some implementations, dry (or semi-dry) separator coating may be utilized. In some implementations, little or no solvent may be used to form such a dispersion. In this case (e.g., at stage 312), the separator dispersion may be formed by mixing ceramic (nano) particles (e.g., mixture of higher-aspect ratio ceramic (nano) particles (elongate ceramic (nano) particles) and lower-aspect ratio ceramic (nano) particles) with a binder (or a binder precursor, such as polymerizable monomers and/or oligomers and/or polymers), and any other functional additives (e.g., surfactants, dispersants, flame retardants). In case of dry or semi-dry separator formation, electron beam (e-beam) polymerization (cross-linking) may also be used in some designs. In case of dry or semi-dry separator formation, radical polymerization may be used in some designs. In case of dry or semi-dry separator formation, cationic or anionic polymerization may be used in some designs. In case of dry or semi-dry separator formation, photo (UV) polymerization may be used in some designs. In case of dry or semi-dry separator formation, polytetrafluoroethylene (PTFE) or PTFE-comprising copolymer or other fluorinated polymer/copolymer or polymer/copolymer fibers may be used to entangle ceramic particles (e.g., instead of or in addition to polymerizing the polymer binder precursor) and form a separator coating composition.

In some aspects, the substrate on which the separator coating is formed (e.g., at stage 314) may be a porous polymer membrane, such as a polyethylene (PE) membrane or a polypropylene (PP) membrane or a multilayer polymer membrane (e.g., a multilayer structure comprising a PP layer, a PE layer, and another PP layer). These porous polymer membranes may be commercially available and may themselves be employed as separators in batteries but may lack the desired thermal and mechanical properties. In some implementations, the final thickness (e.g., after solvent evaporation) of the (e.g., ceramic particle-comprising) separator coating on such polymer membrane substrates may preferably be as thin as possible, while maintaining the desired properties. In some implementations, the final thickness (e.g., after solvent evaporation) of the separator coating on such polymer membrane substrates (herein, the thickness refers to the thickness of the separator coating only, excluding the thickness of the underlying substrate such as a polymer membrane substrate or an electrode coating) may be in a range of about 0.5 μm to about 20.0 μm (e.g., about 0.5-1.0 μm; about 0.5-5.0 μm; about 1.0-4.0 μm, about 1.0-3.5 μm, about 1.0-2.0 μm; about 1.0-3.0 μm; about 2.0-5.0 μm; about 3.0-5.0 μm; about 5.0-10.0 μm; about 10.0-20.0 μm; about 1.0-1.2 μm; about 1.2-1.5 μm; about 1.5-1.8 μm; about 1.8-2.0 μm; about 1.2-2.0 μm; or about 1.2-1.8 μm). In some implementations, the separator coating may exhibit a composition that changes with position (e.g., have less ceramic material near the surface relative to near the substrate or vice versa, have fewer ceramic particles near the surface relative to near the substrate or vice versa, have a lower porosity near the surface relative to near the substrate or vice versa, have smaller ceramic particles near the surface relative to near the substrate or vice versa, have different shape or different morphology of ceramic particles near the surface relative to near the substrate, have a different polymer binder composition near the surface relative to near the substrate or vice versa, etc.).

An example process 400 for making an integrated electrode-separator component is shown in FIG. 4A. Process 400 includes stages 412, 422, 432, 434, 436, and 438. Some aspects of stages 434 and 438 may be optional, as explained below. Stage 412 includes preparing an electrode slurry. At stage 412, an electrode slurry (anode slurry or cathode slurry) may be formed by mixing the electrode active material (anode active material or cathode active material) with a binder (or a binder precursor), a solvent (e.g., in case of the wet coating process), any conductive additives, and any other functional additives. Stage 422 includes preparing a separator dispersion. At stage 422, the separator dispersion may be formed by mixing ceramic (nano) particles (e.g., mixture of higher-aspect ratio ceramic (nano) particles (elongate ceramic (nano) particles) and lower-aspect ratio ceramic (nano) particles) with a binder (or a binder precursor), a solvent (e.g., in case of the wet coating process), and any other functional additives (e.g., surfactants, dispersants, flame retardants). Herein, examples of solvents include water and organic solvents including alcohols and N-Methyl-2-pyrrolidone (NMP). Herein, a solvent may be a mixture of suitable solvent compounds. Stage 432 includes dispensing the electrode slurry (anode slurry or cathode slurry) onto and/or into a current collector. The dispensing of the electrode slurry may be carried out using any suitable coating process, including slot die coating and blade coating. The dispensing of the electrode slurry may be carried out in a roll-to-roll process, with the current collector being in the form of a roll and being in an unrolled state during the dispensing of the electrode slurry. At stage 434, the dispensed electrode composition (either an anode composition or a cathode composition, formed by dispensing the respective slurry) is dried to completely evaporate the solvent, to form an electrode coating. At stage 434, any other post-dispensing process steps may be carried out on the electrode coating. For example, the dispensed compositions may undergo a calendering process (compaction), which may be carried out after the drying (solvent evaporation) process. At stage 436, the separator dispersion (e.g., obtained from stage 422) is dispensed on the substrate, which is the current collector with the electrode coating formed thereon and/or therein. The dispensing of the separator dispersion is carried out such that the separator coating comes into intimate contact with the electrode coating. The dispensing of the separator dispersion may be carried out using any suitable coating process, including slot die coating, reverse gravure coating (kiss coating), blade coating, spray-based coating, and electrostatic jet coating. The dispensing of the separator dispersion may be carried out in a roll-to-roll process, with the substrate being in the form of a roll and being in an unrolled state during the dispensing of the separator dispersion. At stage 438, the dispensed separator composition is dried to completely evaporate the solvent (e.g., in case of a wet processing), to form the separator coating. At stage 438, any other post-dispensing process steps may be carried out on the separator coating. For example, the dispensed compositions may undergo a calendering process (compaction), which may be carried out after the drying (solvent evaporation) process. Stage 438 may additionally include other processes, such as cutting the integrated electrode-separator to suitable dimensions (e.g., cutting a roll of the integrated electrode-separator into individual integrated electrode-separator pieces for assembly into a battery). In some implementations, portions of the post-dispensing processes at stage 434 may be omitted. For example, a calendering process during stage 434 may be omitted since the subsequent stage 438 may include a calendering process which would result in the compaction of both the separator coating and the electrode coating. For example, a solvent drying process during stage 434 may be partially omitted, such that the separator coating is dispensed on the electrode coating before the solvents of the electrode slurry have completely evaporated. For example, a solvent drying process during stage 434 may be omitted, such that the separator coating is dispensed on the electrode coating immediately after the dispensing of the electrode coating, or the separator coating and the electrode coating are dispensed concurrently, in wet-on-wet coating process (or dry-on-dry if dry coating processes are used). In some implementations, portions of the post-dispensing processes at stage 438 may be omitted. For example, a calendering process may be carried out at stage 434, which results in a compaction of the electrode coating, but a calendering process may be omitted at stage 438. In this example, the electrode coating undergoes calendering (compaction) but the electrode coating-separator coating combination does not undergo calendering (compaction).

In some aspects, an integrated electrode-separator component comprises an electrode coating disposed on and/or in a current collector and a separator coating disposed on the electrode coating. In some implementations, the final thickness (e.g., after solvent evaporation) of the separator coating on such substrates (electrode coating formed on current collector) may be in a range of about 1.0 μm to about 20 μm (e.g., a bout 1.2-2.0 μm; about 1.0-3.0 μm; about 3.0-5.0 μm; about 1.0-5.0 μm; about 1.0-7.0; about 5.0-10 μm; about 1.0-10 μm; about 10-15 μm; about 15-20 μm; or about 1.0-15 μm). In some aspects, the term “integrated electrode-separator component” is used to refer to an electrode-separator component in which a slurry of the separator material (separator dispersion) is dispensed on the electrode coating. Such an integrated electrode-separator component is distinguished from other electrode-separator components in which a separator membrane (formed elsewhere) is disposed on (e.g., brought into contact with) the electrode coating.

In some aspects, an integrated electrode-separator component that comprises an electrode coating disposed on and/or in a current collector and a separator coating disposed on the electrode coating, may additionally comprise an adhesive layer (e.g., porous adhesive layer). In some designs, such a layer may be “activated” (e.g., softened to enhance adhesion) by application of pressure and/or heat or both. In some designs, such a layer may be deposited at the same time (e.g., roll-to-roll) as the separator coating to form an integrated electrode-separator-adhesive layer component. In other designs, such a layer may be deposited after the separator coating (e.g., by casting or spraying or other means). In some designs, an adhesive layer may be deposited on one electrode (e.g., cathode) thus forming an electrode-adhesive layer component, while the separator layer may be deposited on another electrode (e.g., anode) forming an electrode-separator layer component, or vice versa. In some designs, the adhesive layer(s) may be deposited on both electrodes. Such an adhesive layer may be used to attach the anode or the anode-comprising integrated electrode-separator component and the cathode or the cathode-comprising integrated electrode-separator component together during cell fabrication (e.g., stacking in case of stacked pouch or stack prismatic cells or winding in case of cylindrical cells or wound prismatic cells or wound coin cells) in order to increase fabrication (alignment) precision or increase fabrication speed or reduce fabrication complexity or to attain other manufacturing benefits (e.g., improved yield, improved process robustness, etc.).

While the disclosed processes above often describe wet-on-wet or wet-on-dry separator layer coating methods (e.g., on one or both of the electrodes or on one or both sides of the polymer base film), it should be appreciated that some aspects would be applicable for dry-on-dry separator layer coating methods, where the separator layer is coated essentially solvent-free (e.g., on dry-coated electrode or on dried wet-coated electrode or on dry-processed base separator film or on wet-processed base separator film). In some designs, it may be highly advantageous for this dry-on-dry separator coating process to be roll-to-roll. In some designs, the roll-to-roll dry-on-dry integrated electrode-separator component fabrication may take place “in one step” when both the separator coating and the electrode coating are dispensed concurrently. In this case, in some designs it may be advantageous for the binder in the electrode coating to be of similar or the same composition as the binder in the separator coating.

In some designs of the dry-on-dry separator coating method, the dry separator layer coating (and/or dry electrode layer coating) may comprise polymerization of the separator layer binder precursor component (and/or the electrode layer binder precursor component). A suitable binder precursor may be a reactive precursor which undergoes polymerization under certain conditions to form a binder or binder component. Such a polymerizable binder precursor may be in a liquid form at ambient temperatures (e.g., any temperature within a range of about 20° C. to about 30° C.). The polymerizable binder precursor may include polymerizable organic compounds (e.g., monomers, oligomers, and/or polymers). Such a suitable binder precursor (e.g., including liquid monomers or liquid oligomers or liquid polymers) may be mixed with suitable ceramic elongate and/or lower-aspect ratio particles and (optionally) additional (liquid or solid) binder component(s), thus obtaining a separator precursor composition. Accordingly, a battery separator precursor composition may comprise a liquid component (i.e., a polymerizable binder precursor in a liquid form) although (in some designs) the separator precursor composition may be substantially free of conventional solvents (e.g., water, conventional organic solvents). The separator precursor composition may be deposited onto a suitable substrate (dried electrode or porous polymer base film) by a suitable process. Then, the separator layer precursor may be converted into a battery separator layer. As part of this conversion, in an aspect, the polymerizable binder precursor in the separator precursor undergoes partial or complete polymerization and is transformed into polymers suitable for use as a binder in the battery separator produced thereby. In some implementations, the transformation of the polymerizable binder precursor to binder may occur prior to assembly of the electrodes into a battery or prior to electrolyte (e.g., liquid electrolyte) infiltration into the battery or into the respective electrodes of the battery. In some designs, the reactive (e.g., polymerizable) binder precursor(s) for the final binder formation may be selected from the following: (i) a liquid, (ii) a mixture of two or more liquids, (iii) a solid that melts in the temperature range about 30 to about 450° C., and (iv) a mixture of a liquid and solid, where the solid is either meltable (e.g., with a melting point in a range of about 30 to about 450° C.) or a non-melting solid (e.g., with a melting point above about 450° C.). In some designs, the formation of polymer binder(s) from the polymerizable binder precursor (e.g., liquid monomer or oligomer precursor(s)) may include (i) homo-polymerization reactions or (ii) hetero-polymerization reactions or (iii) both homo- and hetero-polymerization reactions. Illustrative examples for the formation of polymer binder(s) from the polymerizable binder precursor include, but are not limited to, the following reactions: (i) free radical polymerization (e.g., acrylate/(meth)acrylates), (ii) ring opening copolymerization of epoxies with anhydrides or amines, (iii) condensation polymerization of amino acids (e.g., glutamic acid), (iv) condensation of isocyanates with polyols or amines (e.g., polyurethane and polyurea, respectively), (v) azide-alkyne cycloaddition, (vi) thiol-ene click reaction, (vii) Diels-Alder cycloaddition, (viii) Michael addition reaction, (ix) olefin metathesis polymerization reaction, (x) acid (including both Lewis and Bronsted acids) or base (including both Lewis and Bronsted bases) mediated condensation polymerization, (xi) Friedel-Crafts polymerization, (xii) heat mediated condensation hetero-polymerization (e.g., between amine/alcohol and carboxylic acids/carboxylic acid anhydrides/esters/boronic acids), and (xii) heat mediated homocondensation polymerization (e.g., boronic acid condensation). Note that the binder curing (polymerization) method is chemistry-specific. For example, in case of the acrylate chemistry, it may be advantageous to use one or more of the following: (i) application of heat with thermal initiators, (ii) application of ultraviolet (UV) light with UV initiators, (iii) a combination of both heat and UV light, including use of respective initiators.

In some designs, some or all of the following properties (numbered i through xiv) of the polymerizable binder precursor (e.g., monomers, oligomers, polymers) are particularly advantageous in the context of one or more embodiments of the present disclosure: (i) In some designs, the polymerizable binder precursor allows or enhances dispersion or individualization of the ceramic particles such that formed polymers are attached to individual particles and not their agglomerates (in some designs, the viscosity of the precursor can range between about 0.001 to about 1 Pascal seconds (Pas)). In some designs, the polymerizable binder precursor may be transparent and in others opaque. (ii) In some designs, the reactivity of the polymerizable binder precursor is such that an external stimulus allows initiation of a controllable polymerization. (iii) In some designs, the polymerizable binder precursor is selected to have no or minimal amount of reactive functional groups remaining in the formed polymer binder after the polymerization (for example, no or minimal amount of nitro or carboxaldehyde groups which may be reduced at the anode, or no or minimal amount of hydroxy, ether, or carboxaldehyde groups which may be oxidized at the cathode). (iv) In some designs, the backbone of the formed polymer binder may preferably be (mostly or fully) composed of unreactive chemical bonds (such as carbon-carbon), which may remain intact during electrode operation (battery cycling) (note that only specific carbon-carbon bond forming polymerization reactions would lead to attaining this property). (v) In some designs where a flexible binder is needed, the polymer binder backbone may preferably have fragment(s) composed of a monomer (or oligomer) with reactive units (responsible for polymerization) which are separated by a flexible spacer (such as oligoether, alkyl oligoether, propyl, butyl, or longer alkyl chains, to name a few). (vi) In some designs where a stiffer binder is needed, the polymerizable binder precursor may preferably contain short spacer(s), such as ethyl (as in polystyrene) in one example. (vii) In some designs where a flexible binder is needed, the pendant groups of the polymerizable binder precursor may preferably be also flexible and devoid of functional groups (for example, hydroxy, carboxylic acids or their salts with Li⁺, Na⁺, K⁺, Ca²⁺, Mg²⁺, etc., sulfonic acids or their salts with Li⁺, Na⁺, K⁺, Ca²⁺, Mg²⁺, amides, imides, sulfonamides, etc.) that can participate in inter/intra-chain interactions, such as hydrogen-bonding. (viii) In some designs where a stiffer binder is needed, the pendant groups polymerizable binder precursor may preferably contain functional groups (hydroxy, carboxylic acids or their salts with Li⁺, Na⁺, K⁺, Ca²⁺, Mg²⁺, etc., sulfonic acids or their salts with Li⁺, Na⁺, K⁺, Ca²⁺, Mg²⁺, amides, imides, sulfonamides, etc.). (ix) In some designs where strong adhesion to the ceramic particle surface is desirable, functional groups such as hydroxy, carboxylic acids or their salts with Li⁺, Na⁺, K⁺, Ca²⁺, Mg²⁺, etc., sulfonic acids or their salts with Li⁺, Na⁺, K⁺, Ca²⁺, Mg²⁺, amides, imides, sulfonamides, etc. may preferably be present in the polymerizable binder precursor. (x) In some designs where the swell of final binder may preferably be tuned, it may also be advantageous to utilize above discussed functional groups in the polymerizable binder precursor (e.g., the most preferable functional groups may be dictated by the electrolyte with which the binder will come into contact; for example, in order to reduce or minimize swell in commonly used carbonate-based electrolytes, the presence of more polar functional groups, such as carboxylic acids or their salts with Li⁺, Na⁺, K, Ca²⁺, Mg²⁺, etc., sulfonic acids or their salts with Li⁺, Na⁺, K⁺, Ca²⁺, Mg²⁺, amides, imides, sulfonamides may be preferred). (xi) In some designs, the polymerizable binder precursor may be functionalized with Li ions in order to supplement Li ions in the battery cell. (xii) In some designs, it may be advantageous for the polymerizable binder precursor to comprise oligoether pendant groups in order to promote ionic conduction through the polymer binder and thus reduce a binder-induced ionic resistance contribution. (xiii) In some designs, the formed binder's rigidity or hardness may additionally be improved by adding bi-/tri-/tetra-functional monomers in the polymerizable binder precursor which can cross-link and provide sufficiently rigid networks. (xiv) In some designs, the polymerizable binder precursor may be selected to allow wetting of the particle surfaces and, more importantly, the formed polymers may preferably form relatively smooth interface with the particle surface (note that this property is also dependent on particle surface chemistry and roughness, which means specific binder precursor compounds would be applicable for a particular particle surface).

In some designs, the use of ultra-low viscosity binder precursors in a range of about 0.3 to about 3 cP (e.g., monomers and/or oligomers, which can be polymerized after casting by a suitable process, such as a thermal, a UV light, an e-beam, or a chemical polymerization process) may be highly advantageous for electrode casting. In some designs, a binder precursor molecule (e.g., monomer, oligomer) may preferably bear at least two reactive functional groups (e.g., to enable effective cross-polymerization). In some designs, mixtures of two or more precursor molecules may be effectively employed. For example, a first precursor molecule may undergo linear polymerization, a second precursor molecule may act as a cross-linking agent, and a third precursor molecule may reduce binder viscosity. In some designs, a chemical initiator (in some designs, also a catalyst) may be added to the electrode mass (e.g., immediately before the casting procedure). In some designs, the initiator ignites (initiates) the polymerization, and the catalyst may increase the polymerization rate and/or decrease the polymerization temperature. In some designs, the catalyst may also contribute to adjusting the molecular weight or polydispersity index. In some designs, it may be advantageous to adjust the temperature ranges at which polymerization occurs. For example, suppose that casting of the separator layer is to be carried out at a first elevated temperature (e.g., a moderately high temperature range that is higher than ambient temperature, e.g., in a range of about 30-about 70° C.) in which the viscosity of the separator precursor composition is lower than at ambient temperature. In this case, it may be preferable to substantially prevent polymerization at this first elevated temperature range. After the separator layer precursor has been formed by the casting process, polymerization may be carried out by (1) heating the electrode precursor to a second temperature that is higher than the first temperature, e.g., in a range of about 60-about 200° C., or (2) another process such as UV light treatment or e-beam treatment. In such designs, for example, a polymerization inhibitor may be used instead of the catalyst. In some designs, an inhibitor prevents polymerization of polymerizable molecules (e.g., monomer, oligomer) at moderate or ambient temperature conditions (e.g., the first elevated temperature, ambient temperature). Accordingly, in some designs, the use of an inhibitor may lower the viscosity of a separator layer precursor composition such that it is in the form of a slurry or a paste. In some designs, a catalyst or initiator can effectively overcome this polymerization inhibiting effect of the inhibitor. Thus, in some designs, an initiator may be applied to the electrode precursor after the casting stage (e.g., onto a top surface electrode precursor, during or immediately before densification (e.g., hot calendering, hot press, etc.)) to enable casting of separator layer in a slurry or paste form. In some designs, the inhibitors may be removed from precursor molecules (e.g., monomer, oligomer) just prior to their use (e.g., mixing of the precursor molecules into a battery electrode precursor composition), because the efficiency of polymerization may be affected by the presence of the inhibitors. In other words, in some designs, the degree of polymerization can be tuned by removal of the inhibitor often present in ppm (parts per million) quantities in commercially available polymerizable monomers and oligomers.

In some designs, suitable elongate and/or lower-aspect ratio ceramic particles may be first dispersed in a polymer binder solution and then the binder may be precipitated on the particle surface by the addition of a non-solvent. In other designs, suitable elongate and/or lower-aspect ratio ceramic particles may be dispersed in a material (e.g., a solution) comprising a polymerizable binder precursor (e.g., liquid monomers, liquid oligomers, liquid polymers, or combinations thereof) followed by heterogeneous (e.g., on particle surface) polymerization. In some designs, grafting polymers to the suitable elongate and/or lower-aspect ratio ceramic particle surface may be performed by generation of active polymeric species (radicals or cations/anions) in a suspension of the particles (e.g., in an organic solvent or in aqueous solution, when possible). In some designs, a polymerizable binder precursor (e.g., monomers, oligomers, polymers) may be spray-coated onto and/or into the suitable elongate and/or lower-aspect ratio ceramic particle under constant stirring. In some designs, conversion to a polymer binder coating may be realized by using ready-made polymers (in the case of radical initiation) or in-situ polymerization of monomers or oligomers in various types of initiation. In some designs, a so-called “grafting from” approach may be effectively utilized for the formation of polymer binder coatings on the suitable elongate and/or lower-aspect ratio ceramic particle surface. In some designs, efficiency of the “grafting from” approach is higher than that of “grafting to” one. This “grafting from” method involves the growth of polymers from a surface-bound initiating moiety on the surface of (e.g., active electrode material) particles. In some designs, this results in the formation of high-density polymer brushes where the distance between anchor points (grafting density) can be smaller than the radius of gyration of a free polymer. In some designs, the attachment of initiators to surfaces results in a heterogeneous initiating system. In this case, the kinetics of initiation can be different from those of a free polymer. In some designs, this has important consequences for the final properties of the polymer binder coatings on the suitable elongate and/or lower-aspect ratio ceramic particle surfaces. In some designs, controlled radical polymerization techniques, such as stable nitroxide-mediated radical polymerization (NMRT), atom transfer radical polymerization (ATRP), reversible addition fragmentation chain-transfer (RAFT) polymerization, ring-opening metathesis (ROMP), and/or living anionic/cationic polymerization may be effectively utilized for “grafting from” approach. In some designs, a controlled “living” radical polymerization approach may be a particularly versatile and robust method to prepare well-defined organic polymers with pre-programmed size, composition, and architecture. One difference between conventional radical and controlled radical polymerizations is the lifetime of the propagating radical during the polymerization reaction. In conventional radical processes, radicals generated by decomposition of the initiator or in other ways undergo propagation and bimolecular termination reactions within a second. In contrast, the lifetime of a growing (living) radical polymerization may be tuned to exceed several hours.

In some designs, the “dry” or “solvent-free” separator layer (or integrated electrode-separator component) processing may rely on the use of fibrillated PTFE-like polymers (including copolymers). Such a processing may be further improved by using one or more aspects of this disclosure (e.g., to attain a higher electrode uniformity, reduced amount of agglomerates, reduced number of defects, improved yield, improved adhesion to current collector foils, etc.). In some implementations, a binder may comprise multiple binder components (e.g., a first binder component and a second binder component and optionally one or more additional binder components) a primary binder component and a secondary binder component. The first and second binder components may have the same or different relative significance (e.g., effectiveness in binding to the other constituents of the layer), the same or different relative quantity, and so on. The primary and secondary designations as used herein are not intended to attribute a relative significance or a relative quantity to the respective components. In some designs, suitable active materials (in case of the electrode layer) or suitable ceramic particles (in case of the separator layer) may be advantageously coated or functionalized with other polymers prior to “dry” processing with PTFE-like polymers. In some designs, suitable electrode active material particles (in case of the dry electrode layer processing) or suitable ceramic particles (in case of the separator layer) may be pre-mixed with suitable secondary polymerizable binder precursor(s) (e.g., monomers, oligomers, etc.) and/or suitable (e.g., F-free) secondary polymers (e.g., binder polymers) prior to “dry” processing with conventional primary PTFE-like polymers in order to (1) attain a higher level of electrode layer (and/or separator layer) uniformity without “over-fibrillating” the PTFE-like polymers or to (2) improve adhesion of or mechanical properties of the electrodes or to (3) use less (i.e., smaller amounts of) PTFE-like polymers. If monomers (or oligomers) are used as a polymerizable binder precursor, these could be further polymerized prior to battery assembling or prior to battery use. In some designs, a suitable secondary polymerizable binder precursor (e.g., monomers, oligomers, etc.) or suitable secondary (e.g., fluorine-free) polymers may be mixed with conductive additives and other additives, active materials, and conventional primary PTFE-like polymers to produce an improved “dry” electrode layer or separator layer “mass”. In some designs, the mass fraction (wt. %) of suitable monomers and/or suitable F-free polymers in such electrode layer or separator layer compositions may range from about 0.5 wt. % to about 5 wt. % (e.g., about 0.5-1 wt. %, about 1-2 wt. %, about 2-3 wt. %, about 3-4 wt. %, or about 4-5 wt. %) relative to the overall weight of the dry electrode or separator layer(s). In some designs, the ratio of the weight of suitable monomers and/or suitable F-free polymers to the weight of PTFE-like polymers may range from about 5:1 to about 1:20 (e.g., about 5:1-2:1; about 2:1-1:2; about 1:2-1:5; or about 1:5-1:20).

In some aspects, an integrated electrode-separator component comprises an electrode coating disposed on and/or in a current collector and a separator coating disposed on the electrode coating. Such an integrated electrode-separator component may be employed in making a lithium-ion battery, as illustrated in FIG. 4B. FIG. 4B illustrates an example process 440 of making a Li-ion battery. The flow diagram includes a left branch and a right branch. The left branch relates to the making of an integrated electrode-separator component, as detailed in FIG. 4A. The right branch relates to making a second electrode (i.e., polarity of the second electrode is opposite to that of the electrode of the integrated electrode-separator component). The left and right branches may be carried out concurrently or sequentially as desired. The left branch includes stage 442. In some implementations, stage 442 includes process 400 as shown in FIG. 4A. The right branch includes stages 452, 454, and 456. Stage 452 comprises preparing a second electrode slurry. At stage 452, the second electrode slurry may be formed by mixing the second electrode active material with a binder, a solvent, any conductive additives, and any other functional additives. At stage 454, the second electrode slurry is dispensed onto and/or into a suitable current collector. The dispensing may be carried out using any suitable coating process, including slot die coating and blade coating. The dispensing may be carried out in a roll-to-roll process, with the current collector being in the form of a roll and being in an unrolled state during the dispensing. In certain aspects, the current collector can comprise a metal foil, metallized foil, metal wire, metal mesh, or any combination thereof. In certain aspects, the current collector can comprise Cu or Cu-alloy foil for anodes and Al or Al-alloy foil for cathodes, in many instances. At stage 456, the dispensed electrode is dried to completely evaporate the solvent, to form an electrode coating. At stage 456, any other post-dispensing process steps may be carried out on the electrode coating. For example, the dispensed compositions may undergo a calendering process (compaction), which may be carried out after the drying (solvent evaporation) process. Stage 456 may additionally include other processes, such as cutting the electrode-current collector to suitable dimensions (e.g., cutting a roll of the electrode-current collector into individual pieces for assembly into a battery).

Process 440 (FIG. 4B) additionally includes stages 462 and 464. Stage 462 includes assembling of the battery cell from the battery components (e.g., integrated electrode-separator component from stage 442, second electrode from stage 456, battery case, sealing member) and filling the cell with an electrolyte. Stage 464 includes carrying out any formation cycling on the assembled battery, to form a solid-electrolyte interphase (SEI) layer in the anode and/or the cathode.

FIG. 4C illustrates an example process 470 of making a Li-ion battery. The flow diagram includes a left branch (stage 472) and a right branch (stage 474). The left branch (stage 472) relates to the making of an integrated anode electrode-separator component, and the right branch (stage 474) relates to the making of an integrated cathode electrode-separator component. Each of these stages 472, 474 may be implemented as detailed in FIG. 4A. The left and right branches may be carried out concurrently or sequentially as desired. Accordingly, process 470 differs from process 440 in that each of the electrodes (anode, cathode) is part of a respective integrated electrode-separator component. Process 470 additionally includes stages 482 and 484. Stage 482 includes assembling of the battery cell from the battery components (e.g., integrated anode-separator component from stage 472, integrated cathode-separator component from stage 474, battery case, sealing member) and filling the cell with an electrolyte. Stage 484 includes carrying out any formation cycling on the assembled battery, to form a solid-electrolyte interphase (SEI) layer in the anode and/or the cathode. At stage 482, the integrated electrode-separator components are assembled such that the separator coatings face each other. Since the separator comprises the two separator coatings in a stack, the likelihood of pinhole defects that extend continuously between the anode and the cathode is significantly reduced.

In still further aspects, disclosed herein is a battery. In such exemplary and unlimiting aspects, the battery is a lithium-ion battery (1) made according to process 200 (FIG. 2); (2) made according to process 440 (FIG. 4B); (3) comprising a separator made according to process 300 (FIG. 3); and/or (4) comprising an integrated electrode-separator component made according to process 400 (FIG. 4A). At stage 232 (FIG. 2) or stage 462 (FIG. 4B) or stage 482 (FIG. 4C), the lithium battery cell is assembled with an electrolyte interposed between the anode electrode and the cathode electrode. The electrolyte provides ionic conduction between the anode and the cathode. The electrolyte ionically couples the anode and the cathode. The electrolyte may comprise a liquid electrolyte or a solid electrolyte (or a mixture of liquid and solid electrolyte or a gel electrolyte) at battery operating temperatures (e.g., in some designs, the solid electrolyte may be molten or semi-molten during melt-infiltration and may subsequently solidify). In some implementations, e.g., implementations in which a liquid electrolyte is used, a separator (or the separator portion of an integrated electrode-separator component) may be used to maintain a space between the anode and the cathode electrodes. In such an implementation, the liquid electrolyte may infiltrate the separator (or the separator portion of an integrated electrode-separator component). Stage 232, stage 462, and stage 482 may also include packaging the battery into a desired configuration (e.g., a cylindrical cell configuration, a prismatic cell configuration, a pouch cell configuration), degassing, sealing and aging processes.

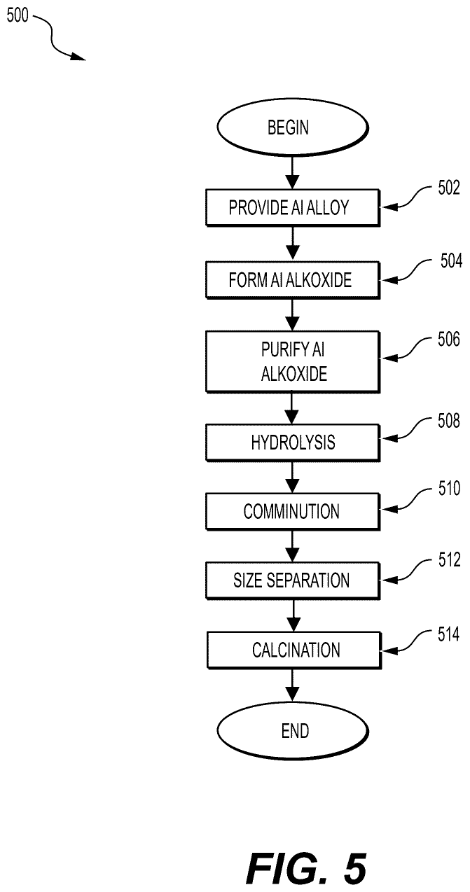

FIG. 5 shows an example process 500 of making elongate ceramic (nano) particles (higher-aspect ratio ceramic (nano) particles) and/or lower-aspect ratio ceramic (nano) particles. The ceramic (nano) particles may be employed in making separators (e.g., according to process 300 of FIG. 3 or process 400 of FIG. 4A). FIG. 5 shows a schematic of the ceramic (nano) particle synthesis process. At stage 502, a high-purity (e.g., purity of about 98% or greater, purity of about 99% or greater) aluminum-lithium (AlLi) alloy is provided. In some implementations, the mass fraction of Li in the AlLi alloy is in a range of about 0.1 wt. % to about 20 wt. %. At stage 504, particles of the AlLi alloy are dispersed in a dry alcohol, such as dry ethanol; reaction products formed from the reactions between the AlLi alloy and the dry alcohol include aluminum alkoxide particles (e.g., aluminum alkoxide nanofibers, bundles of aluminum alkoxide nanofibers, and other aluminum alkoxide particles). In implementations in which the dry alcohol is dry ethanol, the aluminum alkoxide is aluminum ethoxide. Stage 506 includes purification of the reaction product by filtration (e.g., using additional dry alcohol) to obtain aluminum alkoxide particles of greater purity. At stage 508, the purified aluminum alkoxide is hydrolyzed to form aluminum hydroxide. In some implementations, the hydrolysis is carried out via exposure of the solid phase aluminum alkoxide (e.g., aluminum ethoxide) to an H₂O saturated wet gas (e.g., air, Argon and Nitrogen may be used) at a temperature in a range of about 20 to about 140° C. with a water content of about 0.001 to about 20 vol. %. In some implementations, the population of aluminum hydroxide particles obtained upon completion of stage 508 comprises a relatively high fraction (e.g., high mass fraction or high volume fraction) of higher-aspect ratio (nano) particles (aspect ratio of about 3 or more), including aluminum hydroxide (nano) fibers and bundles of aluminum hydroxide (nano) fibers. At stage 510, the aluminum hydroxide particles undergo comminution (e.g., milling). For example, in the case of milling, the aluminum hydroxide particles may be milled by exposing to hard plastic or ceramic media in rotational or orbital motion in an orbital mixer or a shaker table. In some implementations, the population of aluminum hydroxide particles obtained upon completion of stage 510 comprises a mixture of higher-aspect ratio (nano) particles (e.g., aspect ratios of more than about 3) and lower-aspect ratio (nano) particles (e.g., aspect ratios of about 1 to about 3). At stage 512, the aluminum hydroxide particles (e.g., from stage 510, after comminution) undergo particle size selection. Stage 512 may be optional. For example, the particle size selection may be carried out by passing the aluminum hydroxide particles through a sieve (e.g., sieve screen with an opening size in a range of about 10 μm to about 5 mm). In another example, the particle size selection may be carried out to primarily remove fines (e.g., removing smaller particles smaller than about 100 nm or smaller than about 50 nm), primarily to remove extra large particles (e.g., removing particles that are larger than about 30 μm or larger than about 50 μm), or to otherwise adjust the particle size distribution (PSD). Stage 512 may also include combining two or more populations (e.g., batches) of (nano) particles. For example, stage 512 may include combining (e.g., thoroughly mixing) a first batch, primarily comprising higher-aspect ratio (nano) particles of certain desired characteristics (e.g., particle size distribution (PSD), aspect ratio, composition, pore size distribution, mechanical properties), and a second batch, primarily comprising lower-aspect ratio (nano) particles of certain desired characteristics (e.g., particle size distribution (PSD), aspect ratio, composition, pore size distribution, mechanical properties). At stage 514, the aluminum hydroxide particles undergo calcination (heat treatment) to be transformed to alumina (Al₂O₃) particles. The phase (or phase mixture) of the alumina particles has been found to depend on the calcination temperature: in some implementations, calcination at temperatures of about 900° C. and higher yields γ-alumina while calcination at temperatures of about 950° C. and higher yields α-alumina, with the mass fraction of α-alumina increasing with increasing calcination temperatures. In some implementations, stages 512 and 514 may be interchangeable such that the calcination treatment is carried out before the particle size selection process. In some implementations, stage 514 may be optional (i.e., no conversion of Al(OH)₃ (nano) particles to Al₂O₃ (nano) particles is carried out).

In some implementations, the population of aluminum hydroxide (nano) particles obtained upon completion of stage 508 comprises a relatively high fraction (e.g., relatively high mass fraction and/or relatively high volume fraction) of higher-aspect ratio (nano) particles (aspect ratios of at least about 3), including aluminum hydroxide (nano) fibers and bundles of aluminum hydroxide (nano) fibers. Such a relatively high mass fraction may be, for example, a mass fraction of greater than about 80 wt. %, a mass fraction of greater than about 85 wt. %, a mass fraction of greater than about 90 wt. %, a mass fraction of greater than about 95 wt. %, a mass fraction of greater than about 98 wt. %, or a mass fraction of greater than about 99 wt. %. Such a relatively high volume fraction may be, for example, a volume fraction of greater than about 80 vol. %, a volume fraction of greater than about 85 vol. %, a volume fraction of greater than about 90 vol. %, a volume fraction of greater than about 95 vol. %, a volume fraction of greater than about 98 vol. %, or a volume fraction of greater than about 99 vol. %. In some implementations, the average aspect ratio of the (nano) particles obtained upon completion of stage 508 may be in a range of about 1:3 to about 1:100 (e.g., about 1:3-1:10, about 1:10-1:30, about 1:30-1:100, or about 1:3-1:30). In some implementations, the average length of the (nano) particles obtained upon completion of stage 508 may be in a range of about 1 to about 30 μm (e.g., about 1-5 μm, about 5-10 μm, about 10-20 μm, about 20-30 μm, about 1-10 μm, about 1-15 μm, about 15-30 μm, about 1-20 μm, about 1-25 μm, or about 25-30 μm).

In some implementations, the population of aluminum hydroxide particles obtained upon completion of stage 510 comprises a mixture of higher-aspect ratio (nano) particles (e.g., aspect ratios of more than 3) and lower-aspect ratio (nano) particles (e.g., aspect ratios of about 1 to about 3). In some implementations, the average aspect ratio of the higher-aspect ratio (nano) particles obtained upon completion of stage 510 may be in a range of about 1:3 to about 1:100 (e.g., about 1:3-1:10, about 1:10-1:30, about 1:30-1:100, or about 1:3-1:30). In some implementations, the average length of the higher-aspect ratio (nano) particles obtained upon completion of stage 510 may be in a range of about 1 to about 30 μm (e.g., about 1-5 μm, about 5-10 μm, about 10-20 μm, about 20-30 μm, about 1-10 μm, about 1-15 μm, about 15-30 μm, about 1-20 μm, about 1-25 μm, or about 25-30 μm). In some implementations, the average aspect ratio of the lower-aspect ratio (nano) particles obtained upon completion of stage 510 may be in a range of about 1:1 to about 1:3 (e.g., about 1:1-1:2, about 1:2-1:3, about 1:1-1:1.5, or about 1:1.5-1:3). In some implementations, the average length of the lower-aspect ratio (nano) particles obtained upon completion of stage 510 may be in a range of about 50 nm to about 5.0 μm (e.g., about 50 nm-0.1 μm, about 0.1-1.0 μm, about 1.0-2.0 μm, about 2.0-3.0 μm, about 3.0-5.0 μm, about 0.1-3.0 μm, about 1.0 to 3.0 μm, about 0.1-5.0 μm, or about 0.1-5.0 μm). In some implementations, the higher-aspect ratio (nano) particles and the lower-aspect ratio (nano) particles are present in the (nano) particle mixture (upon completion of stage 510) in mass ratios (higher-aspect ratio (nano) particles to lower-aspect ratio (nano) particles) in a range of about 80:20 to about 20:80 (e.g., about 80:20-60:40, about 60:40-40:60, about 40:60-20:80). In some implementations, the higher-aspect ratio (nano) particles and the lower-aspect ratio (nano) particles are present in the (nano) particle mixture (upon completion of stage 510) in volume ratios (higher-aspect ratio (nano) particles to lower-aspect ratio (nano) particles) in a range of about 80:20 to about 20:80 (e.g., about 80:20-60:40, about 60:40-40:60, about 40:60-20:80).

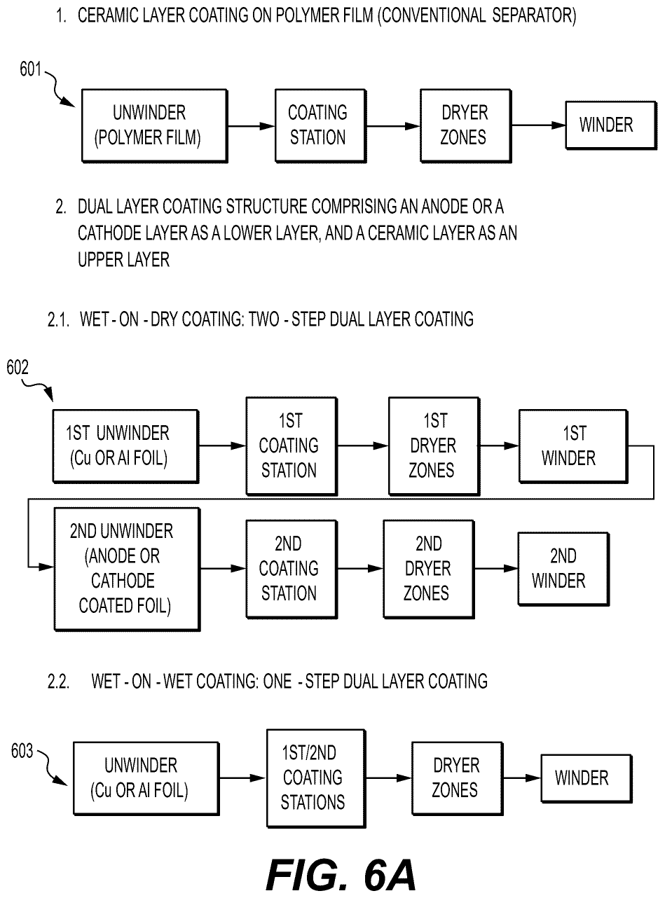

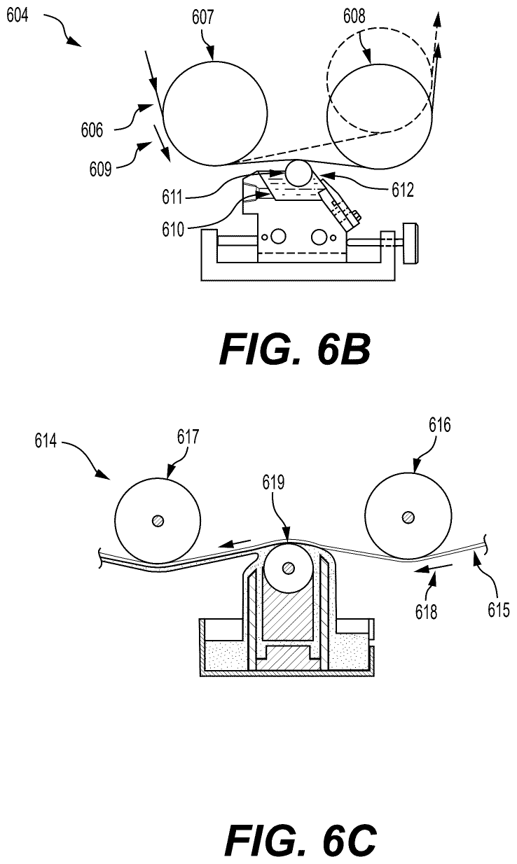

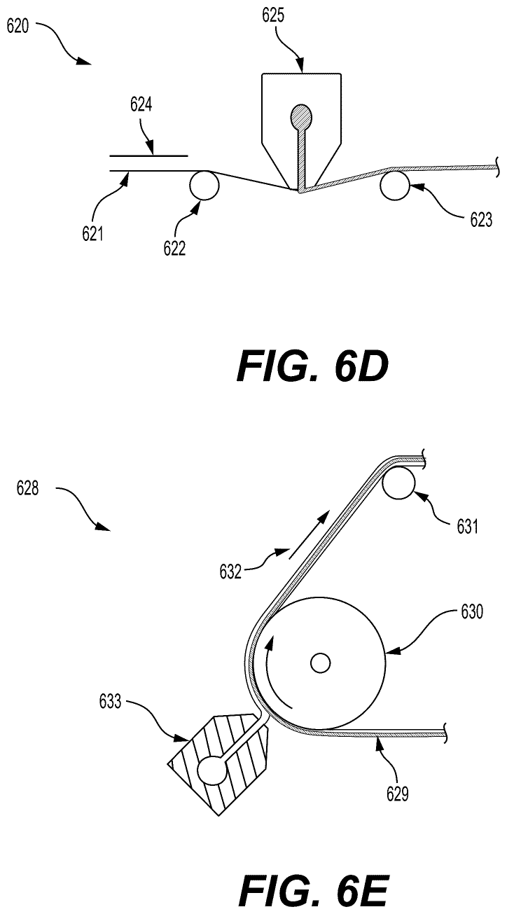

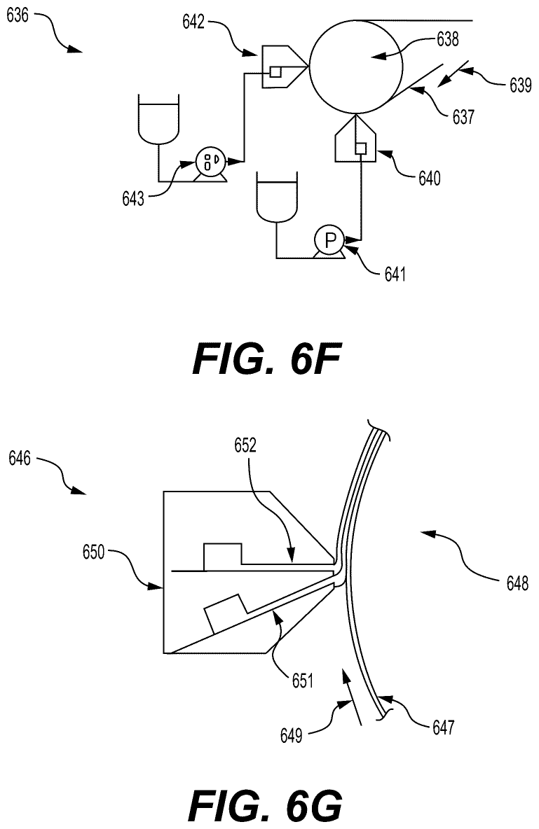

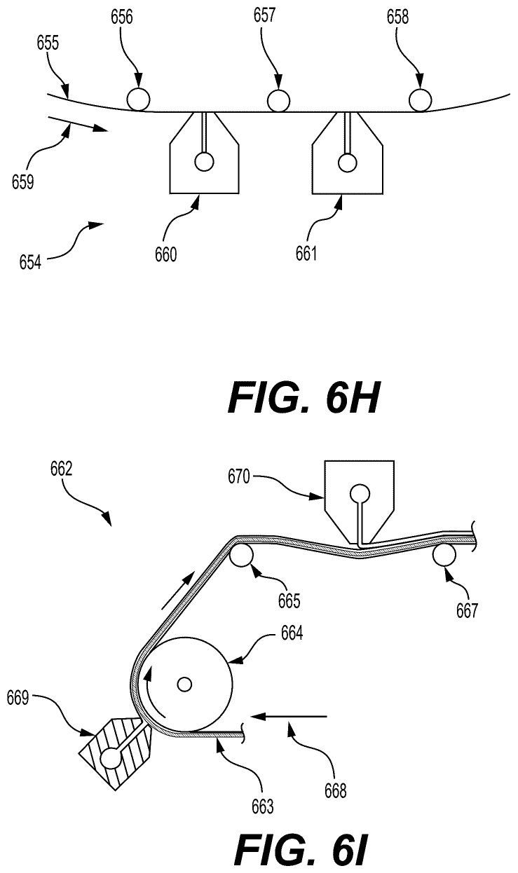

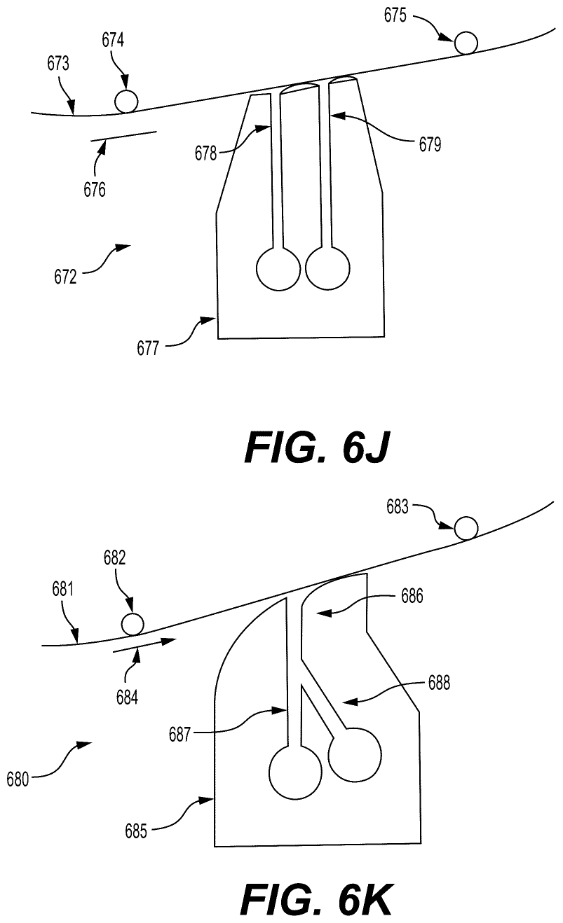

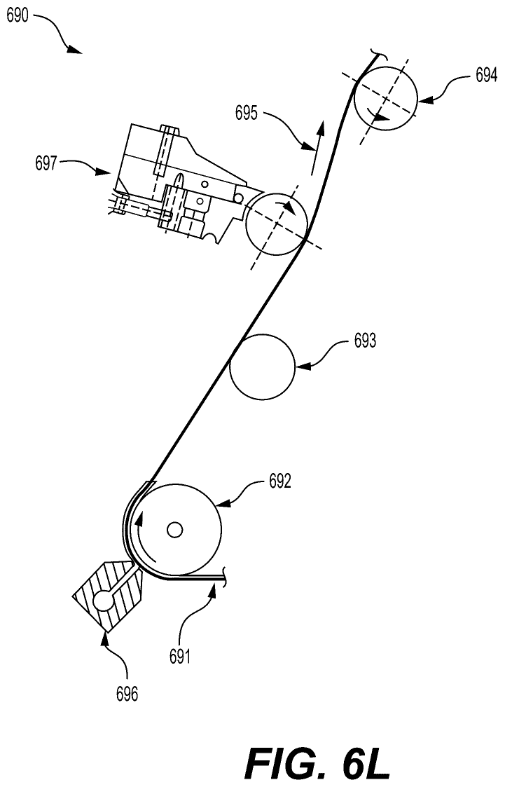

FIG. 6A schematically illustrates three types of coating process. Flow diagram 601 schematically illustrates a process (process 1) for forming a single layer of a ceramic coating (e.g., a coating of ceramic (nano) particles as described herein, or a coating of conventional inorganic (e.g., ceramic) particles) on a substrate (e.g., a polymer film). Conventional ceramic separator coatings are formed according to this process, by forming a coating of conventional inorganic (e.g., ceramic) particles. Flow diagram 601 includes unwinder (e.g., unwinding of a roll of polymer film), coating station (e.g., dispensing of the dispersion of the ceramic particles on the unrolled substrate film), dryer zones (e.g., drying to remove the solvent from the coating), and winder (e.g., winding the roll of polymer film with the ceramic coating formed thereon) stages. Coating processes may be employed to form a dual-layer coating structure including an anode or a cathode layer, as a lower layer, formed on a current collector foil, and a ceramic coating formed on the electrode layer as an upper layer. Herein, the term “lower layer” (or “lower coating layer”) is used to refer to the layer that is closer to the substrate (e.g., current collector foil) than is the “upper layer” (or “upper coating layer”). Herein, the lower layer (or lower coating layer) may also be referred to as a “first layer” (or a “first coating layer”) and the upper layer (or upper coating layer) may also be referred to as a “second layer” (or “second coating layer). An additional (optional) adhesive polymer layer may also be formed on the top of the ceramic coating, in some designs. The dual-layer structure may be formed according to a wet-on-dry coating process (process 2.1, shown by flow diagram 602) or a wet-on-wet coating process (process 2.2, shown by flow diagram 603). These dual-layer structures are integrated electrode-separator components. Process 2.1 includes forming a dual-layer coating via two process stages while process 2.2 includes forming a dual-layer coating via one process stage in which the two layers are formed either concurrently or sequentially with little time lag between the lower and upper layers (e.g., sequentially, wherein the upper layer is dispensed while the lower layer is still wet). Flow diagram 602 includes first unwinder (e.g., unwinding of a roll of a current collector foil, such as a Cu foil for anode coatings or Al foil for cathode coatings), first coating station (e.g., dispensing of the electrode slurry on the unrolled substrate film), first dryer zones (e.g., drying to remove the solvent from the electrode coating), first winder (e.g., winding the roll of current collector foil with the electrode coating formed thereon), second unwinder (e.g., unwinding of a roll of a current collector foil with an electrode coating formed thereon), second coating station (e.g., dispensing of the dispersion of ceramic (nano) particles on the unrolled substrate film), second dryer zones (e.g., drying to remove the solvent from the separator coating), and second winder (e.g., winding the roll of current collector foil with the electrode coating formed thereon and the separator coating formed on the electrode coating) stages. Flow diagram 603 includes unwinder (e.g., unwinding of a roll of a current collector foil, such as a Cu foil for anode coatings or Al foil for cathode coatings), first and second coating stations (e.g., dispensing of the electrode slurry and dispensing of the separator dispersion), dryer zones (e.g., drying to remove the solvents from the electrode coating and the separator coating), and winder (e.g., winding the roll of current collector foil with the electrode coating and the separator coating formed thereon) stages.

Flow diagrams 602, 603 illustrate coating processes that are carried out on one side of a substrate (e.g., a roll of a current collector foil). In some implementations, coating processes are carried out on both sides (side A and side B) of the substrate. The concepts illustrated in the flow diagrams 602, 603 can be extended to dual-sided coatings. For the case of wet-on-wet coating (process 2.2), both sides can be coated concurrently. A respective first and second coating station can be positioned on each side of the substrate, and a respective dryer zone can be positioned on each side of the substrate. For the case of wet-on-dry coating (process 2.1), an example process can employ additional (e.g., third, fourth) coating stations, dryer zones, unwinders, and winders as follows: first unwinder (e.g., unwinding of a roll of a current collector foil), first coating station (e.g., dispensing of the electrode slurry on side A of the unrolled substrate film), first dryer zones (e.g., drying to remove the solvent from the electrode coating on side A), first winder (e.g., winding the roll of current collector foil with the electrode coating formed on side A thereof), second unwinder (e.g., unwinding of a roll of a current collector foil with an electrode coating formed on side A thereof), second coating station (e.g., dispensing of the electrode slurry on side B of the unrolled substrate film), second dryer zones (e.g., drying to remove the solvent from the electrode coating on side B), second winder (e.g., winding the roll of current collector foil with the electrode coatings formed on side A and side B thereof), third unwinder (e.g., unwinding of the roll of electrode-coated film), third coating station (e.g., dispensing of the dispersion of ceramic (nano) particles on side A of the electrode-coated film), third dryer zones (e.g., drying to remove the solvent from the separator coating on side A), third winder (e.g., winding the roll of electrode-coated film with a separator coating formed on side A of the electrode coated-film), fourth unwinder (e.g., unwinding of the roll of electrode-coated film with separator coating formed on side A), fourth coating station (e.g., dispensing of the dispersion of ceramic (nano) particles on side B of the electrode-coated film), fourth dryer zones (e.g., drying to remove the solvent from the separator coating on side B), and fourth winder (e.g., winding the roll of separator and electrode-coated film).

FIG. 6B schematically illustrates a coater configuration for coating a single layer in which the coater comprises a reverse gravure roll with a knife bar to scrape excess slurry from the gravure cells on the gravure roll. A reverse gravure coating system 604 is shown. A substrate 606 travels toward guide rolls 607, 608 along a substrate moving direction 609. A slurry is filled in the reservoir 610 and the gravure roll 611 is dipped in the reservoir. Accordingly, the slurry fills the gravure cells in the gravure roll and excess slurry is scraped by a knife bar 612. The filled slurry in the gravure cells, which is post-metered slurry, is transferred to the substrate in a direction opposite to the direction 609 (hence, this process is called the reverse gravure coating process). This process may be suitable for forming a single thin ceramic coating layer coating on polymer substrate. This process may also be suitable for forming a thin ceramic coating layer (upper coating layer) on an anode coating layer or a cathode coating layer (lower coating layer) in a wet-on-wet or a wet-on-dry coating method.

FIG. 6C schematically illustrates a coater configuration for coating a single layer in which the coater comprises a wire bar. A wire bar coating system 614 is shown. A substrate 615 travels toward guide rolls 616, 617 along a substrate moving direction 618. A slurry is supplied to a wire bar 619 and the slurry fills the wire bar surface. The filled slurry in the wire bar, which is post-metered slurry, is transferred to the substrate as the wire bar rotates in the same direction as the substrate moving direction 618. This process may be suitable for forming a single thin ceramic coating layer coating on polymer substrate. This process may also be suitable for forming a thin ceramic coating layer (upper coating layer) on an anode coating layer or a cathode coating layer (lower coating layer) in a wet-on-wet or a wet-on-dry coating method.

FIG. 6D schematically illustrates a coater configuration for coating a single layer in which the coater comprises a tensioned web slot die. A tensioned web slot die coater 620 is shown. A substrate 621 travels toward guide rolls 622, 623 along a substrate moving direction 624. The substrate (web) is under tension in the region between the guide rolls 622, 623 because of the pressure applied by the slot die 625 against the substrate. The slurry is pre-metered by a pump and supplied from a tensioned web slot die 625 onto the substrate surface, and the slurry-coated substrate moves towards guide roll 623. This process may be suitable for forming a single thin ceramic coating layer coating on polymer substrate. This process may also be suitable for forming a thin ceramic coating layer (upper coating layer) on an anode coating layer or a cathode coating layer (lower coating layer) in a wet-on-wet or a wet-on-dry coating method.

FIG. 6E schematically illustrates a coater configuration for coating a single layer in which the coater comprises a slot die with a backing roll. A slot die coater 628 with a backing roll is shown. A substrate 629 travels towards a backing roll 630 and a guide roll 631 along a substrate moving direction 632. The slurry is pre-metered by a pump and supplied from a slot die 633 onto the substrate surface. The slot die 633 is positioned such that the slurry is coated on the portion of the substrate that is on the backing roll. After the dispensing of the slurry, the slurry-coated substrate moves towards guide roll 631. This process may be suitable for forming a single thin ceramic coating layer coating on polymer substrate. This process may also be suitable for forming an anode coating layer or a cathode coating layer (lower coating layer) as part of a wet-on-wet or a wet-on-dry coating method.

Wet-on-dry coating processes may be obtained by combining suitable single-layer coating processes as shown in FIGS. 6B, 6C, 6D, and 6E. For example, a slot die coating process with a backing roll (FIG. 6E) may be employed for the lower (first) coating (e.g., electrode coating) and a reverse gravure coating process (FIG. 6B) may be employed for the upper (second) coating. As shown in flow diagram 602 (FIG. 6A), the substrate with the lower layer (first coating layer) thereon may be dried in first dryer zones (e.g., dryer oven) between the first and second coating processes. In other implementations, the wire bar coating process (FIG. 6C) or the tensioned web slot die coating process (FIG. 6D) may be employed instead of the reverse gravure coating process (FIG. 6B) for a wet-on-dry coating process.

FIGS. 6F, 6G, 6H, 6I, 6J, 6K, and 6L schematically illustrate coater configuration for dual-layer structures obtained in wet-on-wet coating processes.

FIG. 6F schematically illustrates a coater configuration for coating a dual-layer structure in a wet-on-wet coating process in which the coater comprises two separate slot dies with a single backing roll. A slot die coater 636 with two slot dies and a backing roll is shown. A substrate 637 (e.g., current collector foil) travels towards a backing roll 638 along a substrate moving direction 639. A first slurry (for forming a lower coating layer (first coating layer), such as an anode coating or a cathode coating) is pre-metered by a pump 641 and supplied from a first slot die 640 onto the substrate surface. After the dispensing of the first slurry, the first-slurry-coated substrate moves to a second slot die 642. The second slurry (dispersion of ceramic particles, for forming a separator coating) is pre-metered by a pump 643 and supplied from the second slot die 642 onto the lower layer (anode or cathode layer), which is still wet, in a wet-on-wet coating process. The dispensing of the first and second slurries is carried out quasi-simultaneously.

FIG. 6G schematically illustrates a coater configuration for coating a dual-layer structure in a wet-on-wet coating process in which the coater comprises a dual-slot die with a backing roll. A slot die coater 646 with a dual-slot die and a backing roll is shown. A substrate 647 (e.g., current collector foil) travels on a backing roll 648 along a substrate moving direction 649. Slot die 650 includes a first slurry (lower layer) slot 651 and a second slurry (upper layer) slot 652. A first slurry (for forming a lower coating layer (first coating layer), such as an anode coating or a cathode coating) is pre-metered by a pump and supplied from the first slot 651 onto the substrate surface. Immediately after the dispensing of the first slurry, the second slurry (dispersion of ceramic particles, for forming a separator coating) is pre-metered by a pump and supplied by the second slot 652 onto the lower layer (anode or cathode layer), which is still wet, in a wet-on-wet coating process. The dispensing of the first and second slurries is carried out quasi-simultaneously.

FIG. 6H schematically illustrates a coater configuration for coating a dual-layer structure in a wet-on-wet coating process in which the coater comprises two tensioned web slot dies. A coater 654 comprising two tensioned web slot dies is shown. A substrate 655 (e.g., current collector foil) travels toward guide rolls 656, 657, 658 along a substrate moving direction 659. A first tensioned web slot die 660 is located between guide rolls 656, 657. A second tensioned web slot die 661 is located between guide rolls 657, 658. A first slurry (for forming a lower coating, such as an anode coating or a cathode coating) is pre-metered by a pump and supplied from the first tensioned web slot die 660 onto the substrate surface, and then immediately thereafter, a second slurry (an upper layer slurry) (dispersion of ceramic particles, for forming a separator coating (upper coating)) is pre-metered by a pump and supplied from the second tensioned web slot die 661 onto the lower layer (anode or cathode layer), which is still wet, in a wet-on-wet coating process. The dispensing of the first and second slurries is carried out quasi-simultaneously.

FIG. 6I schematically illustrates a coater configuration for coating a dual-layer structure in a wet-on-wet coating process in which the coater comprises a slot die with a backing roll for a lower layer coating (e.g., anode or cathode coating) and a tensioned web slot die for an upper layer coating (e.g., ceramic coating). A coater 662 comprising a slot die with a backing roll and a tensioned web slot die is shown. A substrate 663 (e.g., current collector foil) travels toward a backing roll 664 and guide rolls 665, 667 along substrate moving direction 668. A first slurry (for forming a lower coating, such as an anode coating or a cathode coating) is pre-metered by a pump and supplied from the slot die 669 (with a backing roll 664) onto the substrate surface, and then immediately thereafter, a second slurry (an upper layer slurry) (e.g., dispersion of ceramic particles, for forming a separator coating) is pre-metered by a pump and supplied from a tensioned web slot die 670 (located between guide rolls 665, 667) onto the lower layer (anode or cathode layer), which is still wet, in a wet-on-wet coating process. The dispensing of the first and second slurries is carried out quasi-simultaneously.

FIG. 6J schematically illustrates a coater configuration for coating a dual-layer structure in a wet-on-wet coating process in which the coater comprises a tensioned web slot die with two separate slots. A coater 672 with a tensioned web dual-slot slot die is shown. A substrate 673 (e.g., current collector foil) travels toward guide rolls 674, 675 along a substrate moving direction 676. A tensioned web slot die 677 is located between the guide rolls 674, 675. The tensioned web slot die 677 includes a first slurry (lower layer) slot 678 and a second slurry (upper layer) slot 679. A first slurry (for forming a lower coating, such as an anode coating or a cathode coating) is pre-metered by a pump and supplied from the first slot 678 onto the substrate surface. Immediately after the dispensing of the first slurry, the second slurry (dispersion of ceramic particles, for forming a separator coating) is pre-metered by a pump and supplied by the second slot 679 onto the lower layer (anode or cathode layer), which is still wet, in a wet-on-wet coating process. The dispensing of the first and second slurries is carried out quasi-simultaneously.

FIG. 6K schematically illustrates a coater configuration for coating a dual-layer structure in a wet-on-wet coating process in which the coater comprises a tensioned web slot die with two separate slurries supplying one slot. A coater 680 with a tensioned web single-slot slot die is shown. A substrate 681 (e.g., current collector foil) travels toward guide rolls 682, 683 along a substrate moving direction 684 during the coating process. A tensioned web slot die 685 is located between the guide rolls 682, 683. The tensioned web slot die 685 includes a first passageway 687 for transporting a first slurry (for forming a lower layer) and a second passageway 688 for transporting a second slurry (for forming upper layer). The tensioned web slot die 685 includes a slot 686. The passageways 687, 688 meet at the head of the slot 686. Accordingly, in some implementations, a length of the slot 686 affects the degree of intermixing of the two slurries. A first slurry (for forming a lower coating, such as an anode coating or a cathode coating) is pre-metered by a pump and supplied via the first passageway 687 to the slot 686. A second slurry (e.g., dispersion of ceramic particles, for forming a separator coating) is pre-metered by a pump and supplied via the second passageway 688 to the slot 686. The first and second slurries (dual-layer slurries) are dispensed concurrently onto the substrate 681 via the slot 686, in a wet-on-wet coating process. The dispensing of the first and second slurries is carried out simultaneously.

FIG. 6L schematically illustrates a coater configuration for coating a dual-layer structure in a wet-on-wet coating process in which the coater comprises a slot die with a backing roll for a lower layer coating (e.g., anode or cathode coating) and a reverse gravure coater for an upper layer coating (e.g., ceramic coating). A coater 690 comprising a slot die with a backing roll and a reverse gravure coater is shown. A substrate 691 (e.g., current collector foil) travels toward backing roll 692 and guide rolls 693, 694 along a substrate moving direction 695 during the coating process. A first slurry (for forming a lower coating, such as an anode coating or a cathode coating) is pre-metered by a pump and supplied from the slot die 696 (with a backing roll 692) onto the substrate surface, and then immediately thereafter, a second slurry (an upper layer slurry) (e.g., dispersion of ceramic particles, for forming a separator coating) is dispensed from the reverse gravure coater 697 (located between guide rolls 693, 694) onto the lower layer (anode or cathode layer), which is still wet, in a wet-on-wet coating process. The reverse gravure coater 697 may be implemented as shown in FIG. 6B or by other suitable techniques known in the art. The dispensing of the first and second slurries is carried out quasi-simultaneously.

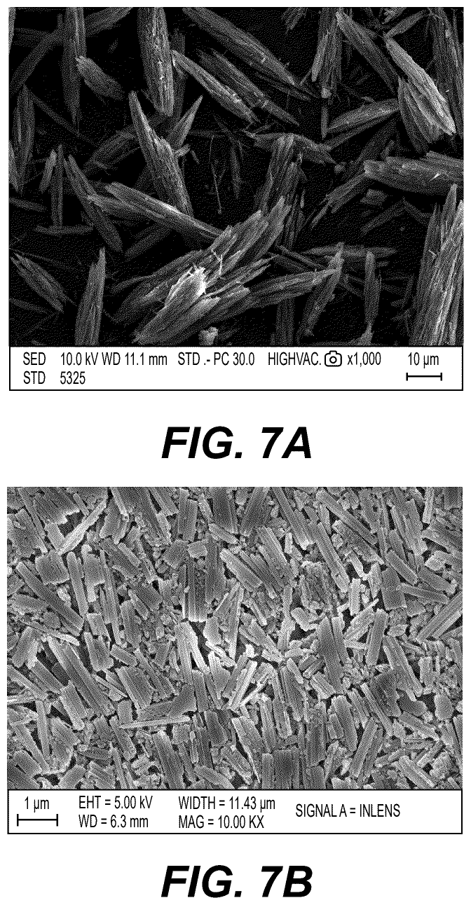

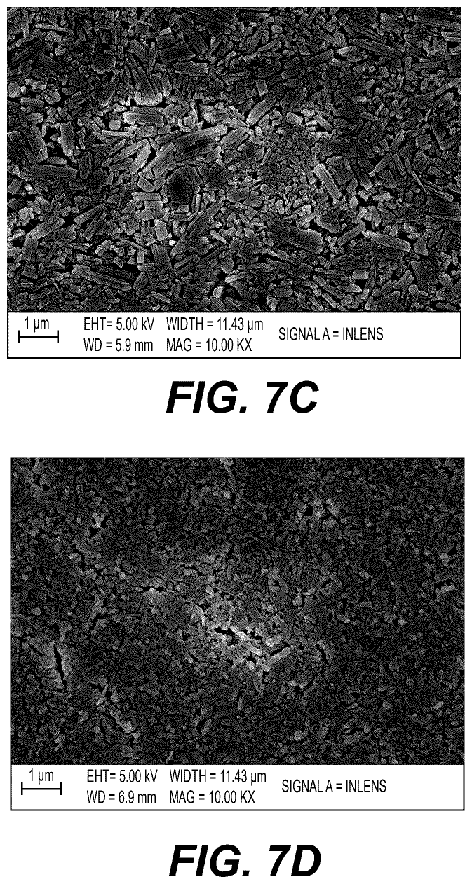

FIG. 7A is a scanning electron microscope (SEM) image of a sample of aluminum hydroxide (nano) particles, synthesized according to process 500 and imaged after hydrolysis (stage 508) and before comminution (stage 510). In the example shown, the (nano) particles are primarily in the form of bundles of aluminum hydroxide (nano) fibers. Elongate ceramic (nano) particles (higher-aspect ratio ceramic (nano) particles) exhibiting aspect ratios of about 1:3 or greater are visible. Elongate ceramic nanoparticles with lengths (i.e., lengths along the elongate direction of each respective elongate ceramic nanoparticle) of about 2 μm or greater (e.g., in a range of about 2 to about 50 μm) are visible. On the other hand, very few lower-aspect ratio (nano) particles (e.g, aspect ratios in a range of about 1:1 to about 1.3) are visible. It is estimated that the higher-aspect ratio (nano) particles and the lower-aspect ratio (nano) particles are present in volume ratios (higher-aspect ratio (nano) particles to lower-aspect ratio (nano) particles) in a range of about 100:0 to about 80:20 (e.g., about 100:0-90:10 or about 90:10-80:20).

FIGS. 7B, 7C, and 7D are SEM images of samples of ceramic (nano) particles, synthesized according to process 500 and obtained from the same batch as shown in FIG. 7A. The samples have undergone a pigment (ceramic (nano) particle) dispersion process under respective bead milling conditions (stage 510). The slurry preparation process, slurry components, and slurry dispersion conditions were as follows: The slurry preparation process includes a slurry premixing and a bead milling process. Slurry components (ceramic (nano) particles 100 grams (22.1 wt. %), binder 11 grams (2.4 wt. %), dispersant 2 grams (0.4 wt. %), and solvent (DI water) 339 grams (75 wt. %)) were weighed and put into a slurry tank, and the slurry was agitated by a high shear homogenizer at 10,000 rpm for 30 minutes. Then the slurry was supplied to a bead mill vessel with 0.1 mm zirconium-yttrium oxide beads at 60% beads loading ratio. A bead milling condition was set up and varied by a slurry residence time in the bead mill vessel and a rotor tip speed. The conditions at the bead milling for FIG. 7B were 10 minutes bead mill residence time and 6 m/see rotor tip speed, for FIG. 7C were 20 minutes and 6 m/see, and for FIG. 7D were 30 minutes and 6 m/see, respectively. Accordingly, FIG. 7B represents ceramic (nano) particles of moderate milling conditions, FIG. 7C represents ceramic (nano) particles of extensive milling conditions (i.e., more extensive than the milling conditions of FIG. 7B), and FIG. 7D represents ceramic (nano) particles of the most extensive milling conditions (i.e., more extensive than the milling conditions of FIG. 7C). Herein, more extensive means that more total energy is imparted to the particles during the milling, such as by longer duration, larger beads, and/or greater bead loading ratio. Very few higher-aspect ratio ceramic (nano) particles are visible in FIG. 7D. It is estimated that the higher-aspect ratio ceramic (nano) particles and the lower-aspect ratio ceramic (nano) particles are present in the ceramic (nano) particle mixtures as shown in FIGS. 7B and 7C in mass ratios in a range of about 80:20 to about 20:80 and/or in volume ratios in a range of about 80:20 to about 20:80. It is estimated that the higher-aspect ratio ceramic (nano) particles and the lower-aspect ratio ceramic (nano) particles are present in the ceramic (nano) particle mixture as shown in FIG. 7D in a mass ratio in a range of about 20:80 to about 0:100 (e.g., about 20:80-10:90, or about 10:90-0:100) and/or in volume ratios in a range of about 80:20 to about 20:80 (e.g., about 20:80-10:90, or about 10:90-0:100).

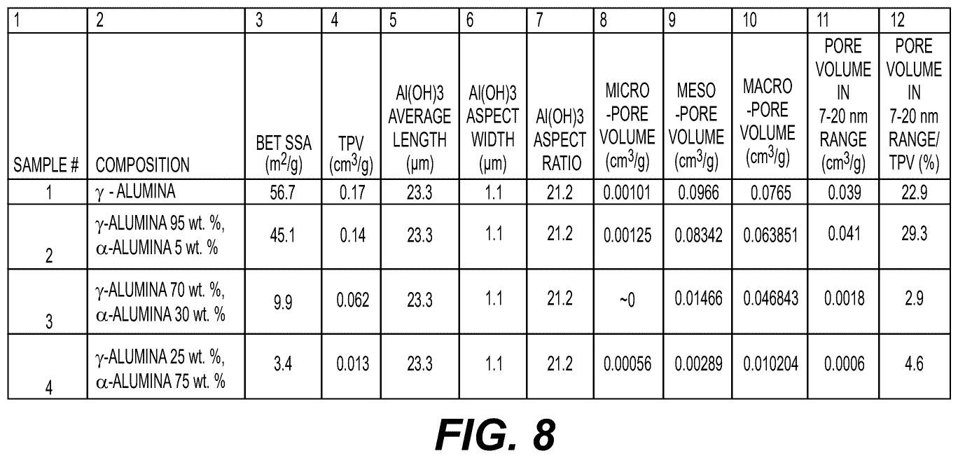

FIG. 8 (Table 1) shows selected data relating to composition and properties of elongate ceramic (nano) particle examples (Samples #1 through #4). These (nano) particles samples were synthesized according to process 500. During the operations of process 500, these samples belonged to one synthesis batch until calcination (stage 514) was carried out, which resulted in the respective compositions reported in column 2. Table 1 reports a sample number (column 1), an approximate composition, as determined by x-ray diffraction (column 2), a BET-SSA (in units of m²/g) of the samples in powder form, as measured by physisorption of nitrogen gas around 77 K (column 3), a total pore volume (TPV) of the samples in powder form, as measured by physisorption of nitrogen gas around 77 K (column 4), an average length (in units of μm) of the intermediate Al(OH)₃ particles, as determined by image analysis (column 5), an average width (in units of μm) of the intermediate Al(OH)₃ particles, as determined by image analysis (column 6), an average aspect ratio of the intermediate Al(OH)₃ particles obtained by dividing the average length by the average width (divide column 5 by column 6) (column 7), a cumulative pore volume (in units of cm³/g) of micropores (pore sizes of up to 2 nm) of the samples in powder form (column 8), a cumulative pore volume (in units of cm³/g) of mesopores (pore sizes in a range of 2 to 50 nm) of the samples in powder form (column 9), a cumulative pore volume (in units of cm³/g) of macropores (pore sizes in a range of at least 50 nm) of the samples in powder form (column 10), a cumulative pore volume (in units of cm³/g) of pores (of pore sizes in a range of 7 to 20 nm) of the samples in powder form (column 11), and a volume fraction obtained by dividing the 7-20 nm pore volume by the total pore volume (divide column 11 by column 4) (column 12). Herein, the intermediate Al(OH)₃ particles (columns 5, 6, and 7) are (nano) particles obtained upon completion of stage 508 (hydrolysis) and before comminution (stage 510). The physisorption measurements reported in columns 3, 4, 8-12 were carried out on (nano) particle samples upon completion of calcination (stage 514).

Specific surface area (SSA), pore size distribution (PSD), and single-point adsorption total pore volume (TPV) were calculated from N₂ physisorption isotherms measured using a MICROMERITICS TRISTAR II 3020 (software version 3.02). During measurement, N₂ is introduced into the sample cell at 77K and adsorbed to the sample by primarily van der Waals forces, and the adsorbed amount of N₂ is measured as a function of relative pressure p/p₀ (where p₀ is the saturation pressure of N₂). Both adsorption and desorption isotherms are measured, with the resulting hysteresis giving information on the pore network structure. Porosity regimes are defined by the IUPAC as follows: micropores: pore widths of <2 nm, mesopores: pore widths in a range of 2 to 50 nm, and macropores: pore widths >50 nm. Accurate micropore measurements typically require lower pressures (p/p₀<10⁻⁴) and/or the use of other adsorbate gasses (Ar, CO₂) for analysis. Thus, micropore volumes are estimated by these N₂ isotherms. Further, since pores of pore sizes >400 nm cannot be probed using N₂ physisorption, accurate characterization of macropores of pore sizes greater than 400 nm requires other techniques, such as mercury porosimetry, which has not been considered here. Accordingly, the pore volume fractions discussed herein are estimates based on N₂ physisorption. The Brunauer-Emmet-Teller (BET) method was used to extract the SSA of the materials from the linear regime of a 1/[n ((p₀/p)−1)] vs. p/p₀ plot (typically in the relative pressure range 0.05-0.3) using the BET equation (Equation 1):

$$\frac{\frac{p}{{p}_{0}}}{n ( 1 - \frac{p}{{p}_{0}} )} = \frac{1}{{n}_{m} C} + \frac{C - 1}{{n}_{m} C} ( \frac{p}{{p}_{0}} ) \qquad ( Equation 1 )$$

where p/p₀ is the relative pressure, n is the amount of adsorbed N₂ [mol/g], C is a constant (calculated from this linear fit), and nₘ is the BET monolayer capacity [mol/g] (also calculated from this linear fit). The SSA is then calculated from the following Equation 2:

$$S = {n}_{m} \cdot {N}_{a} \cdot σ \qquad ( Equation 2 )$$

where Nₐ=Avogadro's number and σ is the cross-sectional area of N₂. A combination of attractive fluid-solid and fluid-fluid interactions of N₂ within the pore network leads to a shift of vapor-liquid equilibrium, with condensation within pores typically shifted to lower relative pressures with decreased pore size. Nonlocal density functional theory (NLDFT, or often simply DFT), can account for these effects. A kernel, or a series of theoretical isotherms describing gas adsorption vs. pore size and relative pressure (at a fixed temperature and pore geometry), is generated using NLDFT modeling. Regression analysis is then used to compare an experimental isotherm with this kernel and calculate a distribution of pore sizes within the sample that fits this experimental isotherm. Finally, a single-point adsorption TPV is calculated based on Gurvich's rule, which states that the amount adsorbed at the limiting plateau of an isotherm is a measure of the total adsorption capacity. Herein, this was calculated at a relative pressure p/p₀ of 0.995, close to saturation.

Image analysis on scanning electron microscope (SEM) images was used to measure length and width of elongate ceramic nanoparticles. The samples were prepared by dispersing ˜1 g of elongate ceramic nanoparticles in ethanol, which were cast on a Si wafer and allowed to dry. For length measurements, THERMO FISHER PHENOM XL SEM (Model PW-100-018) was used with a 5 kV accelerating voltage and a backscatter electron detector (BSD) at 1,000× magnification. For width measurements, THERMO FISHER PHENOM XL SEM (Model PW-100-018) was used with a 5 kV accelerating voltage and a backscatter electron detector (BSD) at 10,000× magnification. Images were recorded for five random locations per sample for length and width measurements, and elongate ceramic nanoparticles were manually annotated to extract length and width. The aspect ratio was taken as the ratio of the average particle length to the average particle width.

Table 1 (FIG. 8) reports selected results from Sample Nos. 1-4. These in-house produced ceramic (nano) particles were calcined at or above about 900° C. However, lower calcination temperatures (e.g., about 300-900° C.; such as about 300-400° C. or about 400-500° C. or about 500-600° C. or about 600-700° C. or about 700-800° C. or about 800-900° C.) may be used in some implementations.

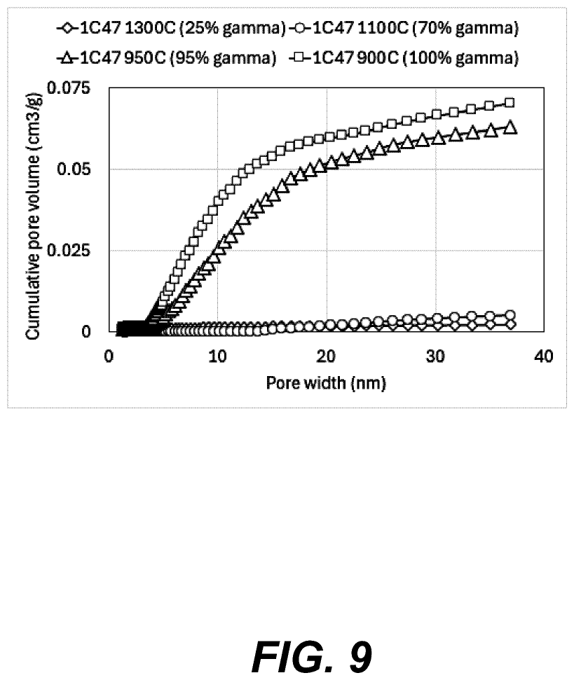

FIG. 9 shows cumulative pore volume of ceramic (nano) particle examples of respective mass fractions of γ-alumina and α-alumina phases. Each of the ceramic (nano) particle samples is a mixture of elongate ceramic (nano) particles and lower-aspect ratio ceramic (nano) particles. The ceramic nanoparticle examples considered are Sample #1 (1C47—900° C.), Sample #2 (1C47—950° C.), Sample #3 (1C47—1100° C.), and Sample #4 (1C47—1300° C.). Each of these samples is obtained from the same synthesis batch (i.e., synthesis outlined in Process 500) except for the respective calcination temperatures (i.e., respective calcination temperatures at stage 514) being different. For Sample #1, the calcination temperature was about 900° C. and only γ-alumina was detected by x-ray diffraction (XRD). For Sample #2, the calcination temperature was about 950° C. and the composition detected by XRD was γ-alumina 95 wt. %, α-alumina 5 wt. %. For Sample #3, the calcination temperature was about 1100° C. and the composition detected by XRD was γ-alumina 70 wt. %, α-alumina 30 wt. %. For Sample #4, the calcination temperature was about 1300° C. and the composition detected by XRD was γ-alumina 25 wt. %, α-alumina 75 wt. %. As the calcination temperature increases from about 900° C. to about 1300° C., the mass fraction of the α-alumina phase increases from about 0 to about 75 wt. % and the mass fraction of the γ-alumina phase decreases from about 100 to about 25 wt. %. In the examples shown, as the mass fraction of the α-alumina phase increases from about 0 to about 75 wt. % (and the mass fraction of the γ-alumina phase decreases from about 100 to about 25 wt. %), the BET specific surface areas decrease from about 56.7 m²/g to about 3.4 m²/g, and the TPV decreases from about 0.17 cm³/g to about 0.017 cm³/g (shown in Table 1). The decrease in pore volumes with increasing calcination temperature is visible in FIG. 9: the cumulative pore volumes for pore widths of up to about 38 nm are more than about 5×10⁻² cm³/g for Sample #1 (1C47—900° C.) and Sample #2 (1C47—950° C.) but about 5×10⁻³ cm³/g or less for Sample #3 (1C47—1100° C.) and Sample #4 (1C47—1300° C.). Each of Sample #1 (1C47—900° C.) and Sample #2 (1C47—950° C.′) exhibits an onset of a more rapid increase in a cumulative pore volume at pore widths of about 3 to about 6 nm.

X-ray diffraction (XRD) was used to quantify the weight (mass) fraction of α-Al₂O₃ and γ-Al₂O₃ in mixed-phase samples. XRD data was collected with a Rigaku SmartLab diffractometer equipped with a Cu source using Bragg-Brentano geometry illumination and a Ni foil K_{β} filter. Out-of-plane divergence was limited by two (incident and receiving) 5-degree Soller slits and a 10 mm height-limiting slit. Collimation within the diffraction plane was achieved using incident slits set to ⅔ degrees and both sets of receiving slits set to 20 mm. XRD patterns were collected in the 2θ range of 40-50° at intervals of 0.02° and at a scan speed of 3.0°/min (0.4 s dwell per interval). The α:γ phase ratio was determined for each sample by comparison to a calibration curve developed from samples of known α-Al₂O₃ and γ-Al₂O₃ weight fractions achieved by physically mixing pure α-Al₂O₃ and γ-Al₂O₃ samples produced from our synthesis method. The area of the (113) α-Al₂O₃ reflection at 2θ≈43.4 degrees (calculated by integrating a two Gaussian-Lorentzian function fit to the combined K_{α1} and K_{α2} signals) was selected as the calibration signal, as it was not convoluted with any γ-Al₂O₃ signals. In contrast, there were no suitable γ-Al₂O₃ peaks (for use as an internal standard for ratio determination) that did not significantly overlap with an α-Al₂O₃ signal. To account for any source intensity drift that may have occurred over time, all measurements were normalized by the peak intensity of the (113) reflection of a known pure α-Al₂O₃ sample at the beginning of each measurement session.

In some implementations, it may be preferable for the BET-SSA values of the ceramic (nano) particles to be in a range of about 30 to about 600 m²/g (e.g., about 30-60 m²/g, about 60-100 m²/g, about 100-150 m²/g, about 150-200 m²/g, about 200-300 m²/g, about 300-400 m²/g, about 400-500 m²/g, about 500-600 m²/g, about 30 to 400 m²/g, about 30-200 m²/g, about 30-150 m²/g, or about 30-100 m²/g). In some implementations, it may be preferable for a total pore volume (TPV) of the ceramic (nano) particles to be in a range of about 2.0×10⁻²-2.5 cm³/g (e.g., about 2.0×10⁻²-0.1 cm³/g, about 0.1-0.3 cm³/g, about 0.3-0.6 cm³/g, about 0.6-1.0 cm³/g, about 1.0-1.5 cm³/g, about 1.5-2.0 cm³/g, about 2.0-2.5 cm³/g, about 2.0×10⁻²-2.0 cm³/g, about 2.0×10⁻²-1.0 cm³/g, about 2×10⁻²-0.6 cm³/g, or about 2.0×10⁻²-0.3 cm³/g).

In some designs, the ceramic (nano) particles may comprise Al₂O₃, AlO(OH), AlPO₄ and/or Al(OH)₃. The ceramic particles can be undoped or doped, with Li or Mg or other metals, e.g., at the 0.1 ppm-1000 ppm doping range relative to all metals in the ceramic particles. Aluminum oxide hydroxide (AlO(OH)) is also sometimes referred to as boehmite. In some implementations, it may be preferable for the ceramic (nano) particles to comprise Al₂O₃(nano) particles, resulting from carrying out calcination (stage 514). The Al₂O₃ may be present in the γ-alumina phase, α-alumina phase, and other phases. In some implementations, it may be preferable for a mass fraction of the γ-alumina in the ceramic (nano) particles to be in a range of about 70 to about 100 wt. % (e.g., about 70-95 wt. %, about 75-95 wt. %, about 80-95 wt. %, about 85-95 wt. %, about 90-95 wt. %, about 75-100 wt. %, about 80-100 wt. %, about 85-100 wt. %, about 90-100 wt. %, or about 95-100 wt. %). In some implementations, it may be preferable for a mass fraction of the α-alumina in the ceramic (nano) particles to be in a range of about 0 to about 30 wt. % (e.g., about 5-30 wt. %, about 5-25 wt. %, about 5-20 wt. %, about 5-15 wt. %, about 5-10 wt. %, about 0-25 wt. %, about 0-20 wt. %, about 0-15 wt. %, about 0-10 wt. %, or about 0-5 wt. %). In some implementations, it may be preferable for a mass fraction of a boehmite phase in the ceramic (nano) particles to be quite low or negligible, such as in a range of about 0 to about 10 wt. % (e.g., about 0-5 wt. %, about 0-3 wt. %, or about 0-1 wt. %).

In the examples shown in Table 1 (FIG. 8), the cumulative pore volume of micropores is about 1×10⁻³ cm³/g and greater for Samples #1 and #2 but less than about 6×10⁻⁴ cm³/g for Samples #3 and #4. In some implementations, it may be preferable for a cumulative pore volume of micropores in the ceramic (nano) particles to be in a range of about 1×10⁻³ to about 2×10⁻² cm³/g (e.g., about 1×10⁻³-2×10⁻³ cm³/g, about 2×10⁻³-1×10⁻² cm³/g, or about 1×10⁻²-2×10⁻² cm³/g).

In the examples shown in Table 1 (FIG. 8), the cumulative pore volume of mesopores is greater than about 8×10⁻² cm³/g for Samples #1 and #2 but less than 2×10⁻² cm³/g for Samples #3 and #4. In some implementations, it may be preferable for a cumulative pore volume of mesopores in the ceramic (nano) particles to be in a range of about 5.0×10⁻² to about 1.0 cm³/g (e.g., about 5.0×10⁻²-0.1 cm³/g, about 0.1-0.3 cm³/g, about 0.3-0.5 cm³/g, about 5.0×10⁻²-0.3 cm³/g, about 5.0×10⁻²-0.5 cm³/g, or about 0.5-1.0 cm³/g).

In the examples shown in Table 1 (FIG. 8), the cumulative pore volume of macropores is greater than about 6×10⁻² cm³/g for Samples #1 and #2, in a range of 4×10⁻² cm³/g to 6×10⁻² cm³/g for Sample #3, but less than 2×10⁻² cm³/g for Sample #4. In some implementations, it may be preferable for a cumulative pore volume of macropores in the ceramic (nano) particles to be in a range of about 2.0×10⁻² to about 0.5 cm³/g (e.g., about 2.0×10⁻²-0.4 cm³/g, about 2.0×10⁻²-0.3 cm³/g, about 2.0×10⁻²-0.2 cm³/g, about 0.2-0.3 cm³/g, about 0.3-0.4 cm³/g, or about 0.4-0.5 cm³/g).

In the examples shown in Table 1 (FIG. 8), the cumulative pore volume in a pore width range of 7 to 20 nm is greater than about 3×10⁻² cm³/g for Samples #1 and #2 but less than 2×10⁻³ cm³/g for Samples #3 and #4. In some implementations, it may be preferable for the cumulative pore volume in a pore width range of 7 to 20 nm of the ceramic (nano) particles to be in a range of about 1.0×10⁻² to about 1.0 cm³/g (e.g., about 1.0×10⁻²-3.0×10⁻² cm³/g, about 3.0×10⁻²-0.5 cm³/g, about 3.0×10⁻²-0.4 cm³/g, about 3×10⁻²-0.3 cm³/g, about 3.0×10⁻²-0.2 cm³/g, about 0.5-1.0 cm³/g, about 0.4-1.0 cm³/g, about 0.3-1.0 cm³/g, about 0.2-1.0 cm³/g, about 1.0×10⁻²-0.5 cm³/g, about 1.0×10⁻²-0.4 cm³/g, about 1.0×10⁻²-0.3 cm³/g, or about 1.0×10⁻²-0.2 cm³/g).

A specific volume fraction may be calculated by dividing a cumulative pore volume of the ceramic (nano) particles in a pore width range of 7 to 20 nm, by a total pore volume (TPV) of the ceramic (nano) particles. The specific volume fraction is shown in column 12 of Table 1. The specific volume fraction is greater than about 20% for Samples #1 and 2 but less than about 5% for Samples #3 and #4. In some implementations, it may be preferable for the specific volume fraction (cumulative pore volume of the elongate ceramic nanoparticles in a pore width range of 7 to 20 nm, divided by a total pore volume (TPV) of the elongate ceramic nanoparticles) to be in a range of about 15 to about 65% (e.g., about 15-20%, about 20-30%, about 30-40%, about 40-60%, about 60-65%, about 20-40%, or about 20-60%).

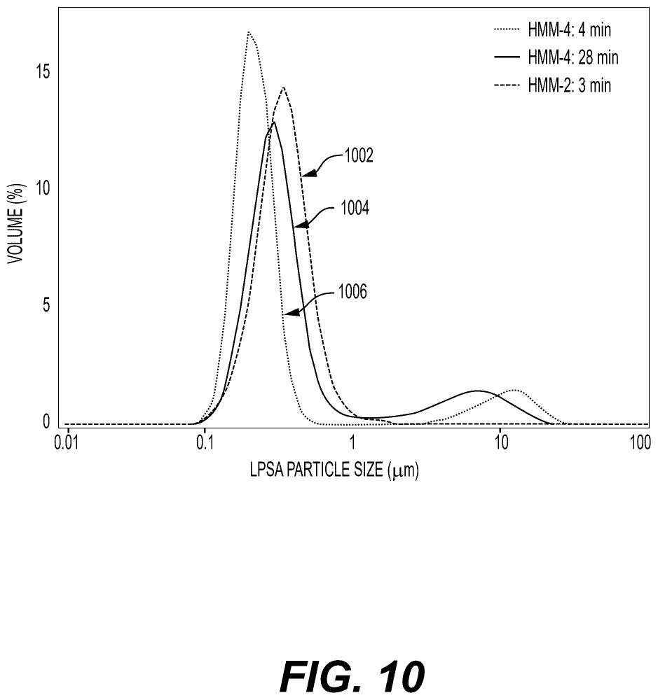

FIG. 10 shows volume-weighted particle size distribution (PSD) data of ceramic (nano) particle examples. Three graphical plots are shown: plot 1002 is the PSD of the ceramic (nano) particles that were milled under moderate milling conditions (shown in FIG. 7B); plot 1004 is the PSD of the ceramic (nano) particles that were milled under extensive milling conditions (shown in FIG. 7C); and plot 1006 is the PSD of the ceramic (nano) particles that were milled under the most extensive milling conditions (shown in FIG. 7D). The particle size distribution (PSD) that characterizes a particle population may be determined by laser particle size distribution analysis (LPSA) on well-dispersed particle suspensions in one example or by image analysis of electron microscopy images, or by other suitable techniques. While there are diverse processes of measuring PSDs, laser particle size distribution analysis (LPSA) is quite efficient for some applications. Herein, the PSD measurements were carried out using LPSA. Using LPSA, particle size parameters of a population's PSD can be measured, such as: a tenth-percentile volume-weighted particle size parameter (e.g., abbreviated as D₁₀), a fiftieth-percentile volume-weighted particle size parameter (e.g., abbreviated as D₅₀), a ninetieth-percentile volume-weighted particle size parameter (e.g., abbreviated as D₉₀), and a ninety-ninth-percentile volume-weighted particle size parameter (e.g., abbreviated as D₉₉). In FIG. 10, each of the PSDs (graphical plots 1002, 1004, 1006) exhibits a primary (larger) peak in a range of about 0.1 to about 1 μm. The primary peak shifts to smaller particle sizes with increasing milling. In addition, each of the PSDs of the two samples that have undergone more extensive milling (graphical plots 1004, 1006) exhibits a secondary (smaller) peak in a range of about 1 to about 20 μm. In some implementations, a particle size distribution of a population of ceramic (nano) particles comprising a mixture of higher-aspect ratio ceramic (nano) particles and lower-aspect ratio ceramic nanoparticles exhibits at least a first peak and a second peak in a range of about 0.1 μm to about 20 μm (e.g., about 0.1-8 μm). In some examples, the first peak (primary peak) is in a range of about 0.1-2.0 μm or about 0.1-1.0 μm. In some examples, the second peak (secondary peak) is in a range of about 1-8 μm or about 1-20 μm or about 2-20 μm.

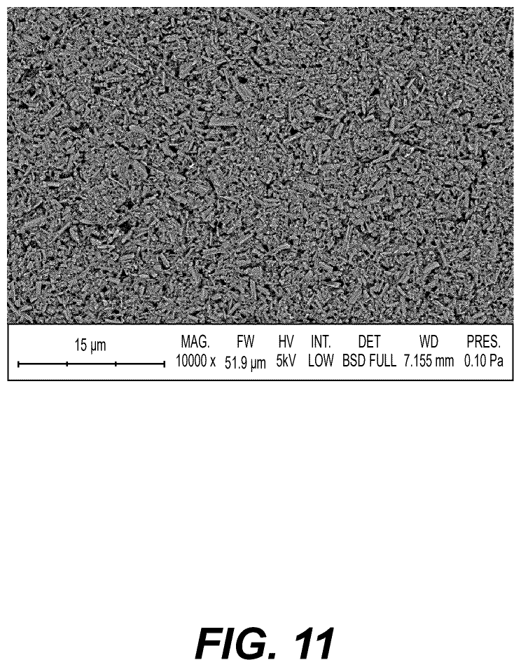

FIG. 11 shows a plan view SEM image of a separator, comprising a coating of ceramic (nano) particles, disposed on a polymer membrane. The ceramic (nano) particles were prepared in accordance with process 500 and the mass fraction of γ-alumina in the ceramic (nano) particles was estimated to be 100 wt. %, by XRD analysis. In the example shown, the population of ceramic (nano) particles comprises a mixture of higher-aspect ratio ceramic (nano) particles and lower-aspect ratio ceramic nanoparticles. The milling conditions for these ceramic (nano) particles were described with reference to FIGS. 7B, 7C, and 7D above. The milling conditions for the sample of FIG. 11 correspond to the conditions for FIG. 7B The slurry preparation process, slurry components, and slurry dispersion conditions were as follows: The slurry preparation process includes a slurry premixing and a bead milling process. Slurry components (ceramic (nano) particles 100 grams (22.1 wt. %), binder 11 grams (2.4 wt. %), dispersant 2 grams (0.4 wt. %), and solvent (NMP) 339 grams (75 wt. %)), were weighed and put into a slurry tank, and the slurry was agitated by a high shear homogenizer at 10,000 rpm for 30 minutes. Then the slurry was supplied to a bead mill vessel with 0.1 mm zirconium-yttrium oxide beads at 60% beads loading ratio. A bead milling condition was set up. The conditions at the bead milling for FIG. 11 were 20 minutes bead mill residence time and 6 m/see rotor tip speed. The slurry was coated on a polymer membrane (polyethylene film of 9 μm thickness) by using a bar coating method. The resulting separator coating had a thickness of about 1.5 μm.

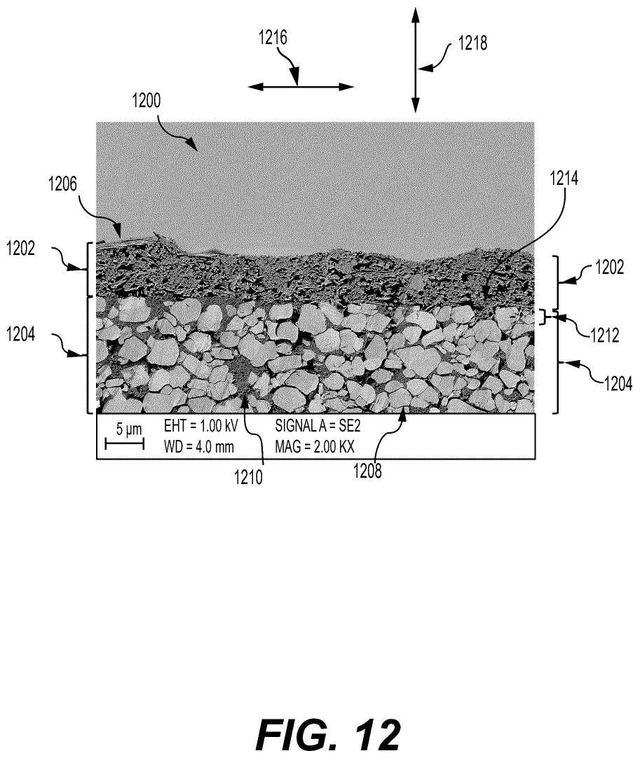

FIG. 12 shows a cross-sectional view SEM image of an integrated electrode-separator component 1200, comprising a coating of the sample of ceramic (nano) particles, disposed on an electrode coating on a current collector. The electrode coating was an anode coating, formed on a Cu foil current collector using a slot die with a backing roll. The ceramic (nano) particles were prepared in accordance with process 500 and the mass fraction of γ-alumina in the ceramic (nano) particles was estimated to be 100 wt. %, by XRD analysis. In the example shown, the population of ceramic (nano) particles comprises a mixture of higher-aspect ratio ceramic (nano) particles and lower-aspect ratio ceramic nanoparticles. The ceramic slurry preparation conditions were as described with reference to FIG. 11. The ceramic particle slurry was coated on the anode coated layer on the copper foil. The resulting separator coating had a thickness of about 5 μm.

Integrated electrode-separator component 1200 comprises a separator coating 1202 disposed on an anode coating 1204. The Cu current collector, on which the anode coating is disposed, is not shown in FIG. 12. Separator coating 1202 comprises a mixture of higher-aspect ratio ceramic (nano) particles and lower-aspect ratio ceramic nanoparticles. Note that the elongate ceramic (nano) particles (one example of an elongate ceramic (nano) particle is labeled as 1206) tend to be aligned along a longitudinal direction (shown by arrow 1216). The longitudinal direction 1216 is contained in a plane of the (original) substrate. For example, the (original) substrate may be a current collector for an integrated electrode-separator component and a polymer membrane for a separator comprising a separator coating disposed on a polymer membrane. For example, the longitudinal direction may be aligned along the machine direction (MD) which indicates the coating direction in a coater equipment. During the coating operation, shear forces may be imparted to the ceramic (nano) particles, causing the elongate ceramic (nano) particles (higher-aspect ratio ceramic (nano) particles) to tend to align along the longitudinal direction. In some implementations, the elongate ceramic (nano) particles are aligned more closely to the longitudinal direction 1216 than to a perpendicular direction 1218. The perpendicular direction is perpendicular to the substrate plane (e.g., the plane of the current collector or the plane of the polymer membrane). In the anode coating layer 1204, silicon-carbon composite particles 1208 (appearing as lighter gray) and graphite particles 1210 (appearing as darker gray) are visible. In the example shown, the anode coating layer includes a higher volume fraction of the silicon-carbon composite particles 1208 than of the graphite particles 1210. The separator coating 1202 may be identified as a coating layer in which the separator materials (e.g., ceramic (nano) particles) occupy a larger proportion (e.g., volume fraction) than the electrode (e.g., anode) materials (e.g., silicon-carbon composite particles, graphite particles). Similarly, the electrode coating 1204 may be identified as a coating layer in which the electrode materials (e.g., anode active materials such as silicon-carbon composite particles and graphite particles if the electrode is an anode, cathode active materials if the electrode is a cathode) occupy a larger proportion (e.g., volume fraction) than the separator materials (e.g., ceramic (nano) particles). The separator coating 1202 and the anode coating 1204 meet at an intermixing region 1212, which comprises the electrode active material (e.g., silicon-carbon composite particles, graphite particles) and the ceramic (nano) particles. At least a portion of the intermixing region 1212 may be included in the separator coating (layer) 1202 and at least another portion of the intermixing region 1212 may be included the anode coating (layer) 1204. In the example shown, the separator coating 1202 was coated on the anode coating 1204 in a wet-on-dry coating process. Accordingly, the separator coating material (e.g., ceramic (nano) particles) infiltrated into some recessed areas (e.g., recessed area 1214) of the anode coating 1204 and most of the intermixing region 1212 is included in the anode coating 1204. In other implementation such as in integrated electrode-separator components in which the electrode coating and the separator coating are formed in a wet-on-wet coating process, a large fraction of the intermixing region may be included in the separator coating (layer) and another large fraction of the intermixing region may be included in the electrode coating (layer). In some examples of such implementations, there may not be a clearly discernible boundary between the separator coating (layer) and the electrode coating (layer). In the example shown, a thickness of the intermixing region is estimated to be about 2 μm and a thickness of the separator coating is estimated to be about 5 μm. In some implementations, a thickness of the intermixing region is in a range of about 5 to about 60% of a thickness of the separator coating (e.g., about 5-20%, about 20-40%, about 40-60%, about 5-50%, about 20-50%, about 10-50%, or about 50-60%).

Test cells were fabricated for the battery test results reported herein. The anode electrode coatings comprised (1) anode active material comprising a mixture Si—C nanocomposite particles and graphite particles, (2) conductive carbon nanotube additive (0.1 wt. % in the electrode), and (3) a binder (6.47 wt. % in the electrode). The amount of anode active material (Si—C composite particles and graphite particles) in the electrode was about 93.43 wt. %. The Si—C nanocomposite particles (with specific capacity of around 1600 mAh/g and mass average size of 6-7 μm) and graphite particles were present in the electrode at 50:50 weight ratio. The binder was a polyacrylic acid (PAA)-based binder. The anode coating was formed by casting an aqueous suspension (slurry) comprising active material particles (e.g., Si—C nanocomposite active material particles, graphite particles), a respective binder composition or binder mixture, and conductive additives (single-walled carbon nanotubes (SWCNT)) on a Cu current collector foil. In test cells where anode active material comprised a mixture of about 50 wt. % of Si—C nanocomposite particles and about 50 wt. % of graphite particles, the areal capacity loading of the anode was about 5.40 mAh/cm². The anode coating comprises anode active material, binder composition or binder mixture, and conductive additives, as well as other functional additives, if any.

For the test cells reported herein, the cathode coating included high-voltage NMC811 (with an approximate composition of LiNi_{0.8}Co_{0.1}Mn_{0.1}O₂) active material (with specific reversible capacity of ˜200 mAh/g when normalized by the weight of active materials in the cathode) casted on Al current collector foil from an organic solvent suspension including a polyvinylidene fluoride (PVDF)-based binder and a carbon black conductive additive. The anode:cathode areal capacity ratio (N:P ratio) was in a range of about 1.05:1 to about 1.14:1 and the charge voltage was about 4.2 V. A polymer-ceramic separator was interposed between the anode coating and the cathode coating. An electrolyte was infiltrated in between the anode coating and the cathode coating. In the test cell examples in which the anode active material comprised a mixture of about 50 wt. % of Si—C nanocomposite particles and about 50 wt. % of graphite particles, an electrolyte of the following approximate composition was used: 13.92 wt. % LiPF₆, 13.33 wt. % FEC (fluoroethylene carbonate, a fluorinated cyclic carbonate), 5.04 wt. % EC (ethylene carbonate, a cyclic carbonate), 3.85 wt. % EMC (ethyl methyl carbonate, a linear carbonate), 62.49 wt. % DMC (dimethyl carbonate, a linear carbonate), 0.52 wt. % VC (vinylene carbonate, a cyclic carbonate), and 0.85 wt. % LFO (lithium difluorophosphate or LiDFP, as another lithium salt additive). In the test cell examples reported herein, the median cathode thickness was about 75 μm, and the median cathode loading was about 23 mg/cm². In the test cell examples in which the anode active material comprised a mixture of about 50 wt. % of Si—C nanocomposite particles and about 50 wt. % of graphite particles, the median anode loading was about 6.0 mg/cm², and the anode coating thickness was in a range of about 40 to 60 μm.

Example procedures for forming the separator coating are as follows: A slurry comprising ceramic particles, one or more binder(s), and an organic solvent or water is prepared and cast on (1) a polymer membrane or (2) directly on the anode or cathode. The binders for the separator slurry may include one or more of the following: carboxymethyl cellulose or other cellulose-based binders, styrene butadiene rubber, polyacrylic acid or its derivatives, polyvinyl butyral, polyacrylonitrile, poly(vinyl acetate), or polyimide-based binders. In the example shown, a polyacrylic acid (PAA)-based binder was employed as the binder for the separator coating.

In some implementations, the fully assembled cells undergo galvanostatic cycling and calendar aging (storage aging) using a testing system (e.g., Arbin LBT Series Tester). In some examples, a standard formation cycling protocol includes two charge/discharge cycles with a 10-hour charge (constant current, C/10) and 10-hour discharge (constant current, C/10) times. The charge portion of each charge/discharge cycle starts at the bottom of charge (e.g., 2.5 V) and ends at top of charge (e.g., 4.20 V). In some examples, a charge/discharge cycle according to a standard (long-term) cycling protocol includes a 1-hour charge step (constant current, 1 C) followed by a constant voltage (CV) step with a taper to a current density of C/20, and 1-hour discharge step (constant current, 1 C), wherein the charge portion of each cycle starts at the bottom of charge (e.g., 2.5 V) and ends at top of charge (e.g., 4.20 V). The cycling continues until the cell capacity reaches 80% of the cycling start capacity. In some examples, a standard calendar (storage) aging protocol includes storing the cell, at top of charge in open-circuit voltage condition, in a high-temperature chamber (e.g., 60° C.) for 1 month, followed by (1) a 3-hour discharge step (constant current, C/3) to the bottom of charge, (2) a 2-hour charge step (constant current, C/2) followed by a CV step with a taper to a current density of C/20, and (3) a 2-hour discharge step (constant current, C/2).

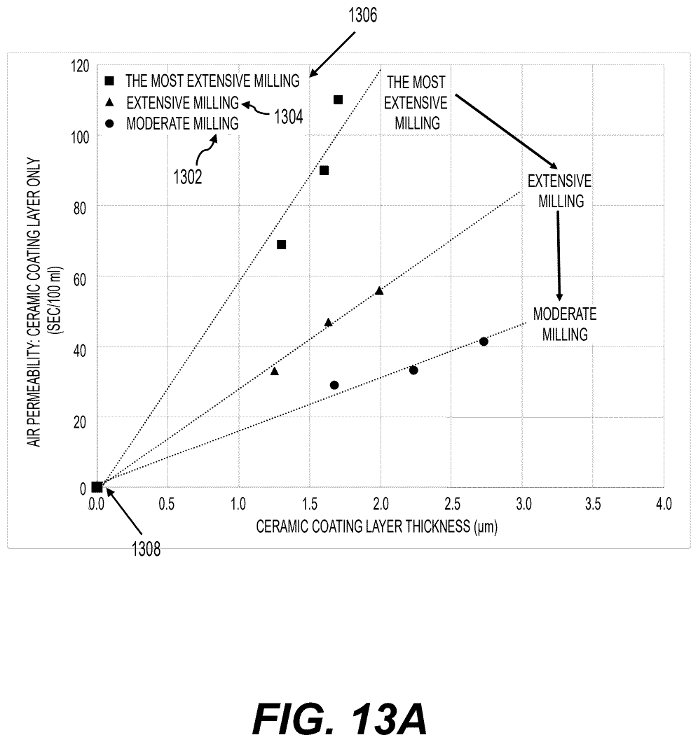

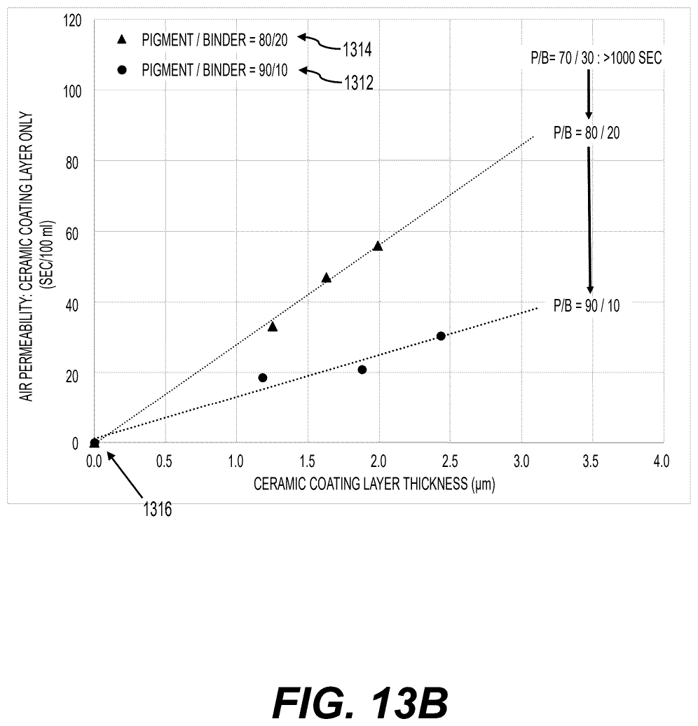

FIG. 13A is a graphical plot showing the dependence of Gurley air permeabilities of separator coatings on ceramic coating layer thickness, for samples of ceramic (nano) particles of respective milling conditions. The separator coatings are formed according to a process as described elsewhere herein. The mass ratio of the ceramic (nano) particles to the polymer binder was about 80:20 to about 97:3. These separator coatings are disposed on polymer membranes and these reported Gurley air permeabilities of separator coatings do not include the Gurley air permeabilities of the underlying substrates. The Gurley air permeability of a separator is obtained by measuring the time (expressed in seconds) required for 100 ml of air to pass through a 1 inch (25.4 mm) diameter circular area of the separator under a predetermined pressure (1.2 kPa). The reported Gurley air permeabilities of separator coatings are obtained by subtracting the measured Gurley air permeabilities of the polymer membranes only from the measured Gurley air permeabilities of the separators comprising the separator coatings disposed on the polymer membranes.

The Gurley air permeability (of separator coatings) data points of FIG. 13A include: (1) data points (circles, 1302) for separator coatings formed from ceramic (nano) particles that have undergone milling under moderate milling conditions (sample shown in FIG. 7B); (2) data points (triangles, 1304) for separator coatings formed from ceramic (nano) particles that have undergone milling under extensive milling conditions (sample shown in FIG. 7C); and (3) data points (squares, 1306) for separator coatings formed from ceramic (nano) particles that have undergone milling under the most extensive milling conditions (sample shown in FIG. 7D). Also shown for comparison is the Gurley air permeability 1308 of the polymer membrane substrate (Gurley air permeability of 0 sec/100 ml and separator coating thickness of 0 μm).

FIG. 13A indicates a general trend of increasing Gurley air permeabilities (of separator coatings) as milling of the ceramic (nano) particles becomes more extensive, for a given separator coating thickness. The separator coatings for the ceramic (nano) particles with the most extensive milling (1306) exhibit Gurley air permeabilities of greater than about 60 sec/100 ml. Gurley air permeabilities (of separator coatings) in a range of about 7 sec/100 ml to about 60 sec/100 ml (e.g., about 7-40 sec/100 ml, about 10-40 sec/100 ml, or about 40-60 sec/100 ml) may be achieved using ceramic (nano) particles of moderate or extensive milling (1302, 1304). Suitable separator coating thicknesses may be in a range of about 0.5 to about 5.0 μm (e.g., about 0.5-1.0 μm, about 1.0-4.0 μm, about 1.0-3.5 μm, about 1.0-3.0 μm; about 1.0-2.0 μm, about 2.0-3.0 μm, about 1.0-1.2 μm, about 1.2-1.8 μm, or about 1.8-2.0 μm). In some implementations, including implementations of integrated electrode-separator components, a suitable separator coating thickness may be in a range of about 1.0 to about 15 μm (e.g., about 1.0-10 μm, about 1.0-7.0 μm; about 1.0-5.0 μm, about 5.0-10 μm, about 10-15 μm, about 1.0-3.0 μm, about 1.2-2.0 μm, or about 3.0-5.0 μm).

FIG. 13B is a graphical plot showing the dependence of Gurley air permeabilities of separator coatings on separator coating thicknesses, for separator coatings comprising binders at respective mass ratios of ceramic (nano) particles to binders. The separator coatings are formed according to a process as described elsewhere herein. The ceramic (nano) particles were milled under moderate milling conditions (moderate milling conditions refers to the milling conditions employed to obtain the samples illustrated in FIG. 7B). The Gurley air permeabilities of separator coatings were measured as described with reference to FIG. 13A.

The Gurley air permeability (of separator coatings) data points of FIG. 13B include: (1) data points (circles, 1312) for separator coatings formed from dispersions comprising the ceramic (nano) particles and the polymer binder in a 90:10 mass ratio; (2) data points (triangles, 1314) for separator coatings formed from dispersions comprising the ceramic (nano) particles and the polymer binder in a 80:20 mass ratio. Also shown for comparison is the Gurley air permeability 1316 of the polymer membrane substrate (Gurley air permeability of 0 sec/100 ml and separator coating thickness of 0 μm).

FIG. 13B indicates a general trend of increasing Gurley air permeabilities (of separator coatings) as the mass fraction of the polymer binder increases, for a given separator coating thickness. The separator coatings with mass ratios of ceramic (nano) particles to polymer binder of 70:30 exhibited Gurley air permeabilities of greater than 1000 sec/100 ml, and are not plotted in FIG. 13B. Gurley air permeabilities (of separator coatings) in a range of about 7 to about 60 sec/100 ml (e.g., about 7-40 sec/100 ml, about 10-40 sec/100 ml, or about 40-60 sec/100 ml) may be achieved using mass ratios (ceramic (nano) particles to polymer binder) in a range of about 80:20 to about 90:10. In some implementations, mass ratios of the ceramic (nano) particles to the binder (e.g., polymer binder) may be in a range of about 80:20 to about 99:1 (e.g., about 80:20-85:15, about 85:15-90:10, about 90:10-95:5, or about 95:5-99:1). In some implementations, a separator coating may comprise ceramic (nano) particles, binder(s) (e.g., polymer binder(s)), and additives (e.g., surfactants), and the mass fraction of the additives in the separator coating may be quite small (e.g., less than about 3 wt. %, or less than about 1 wt. %). In some implementations, a mass fraction of the binder (e.g., polymer binder) in the separator coating may be about 20 wt. % or less (e.g., about 0-1 wt. %, about 1-5 wt. %, about 5-10 wt. %, about 10-15 wt. %, about 15-20 wt. %, or about 5-15 wt. %).

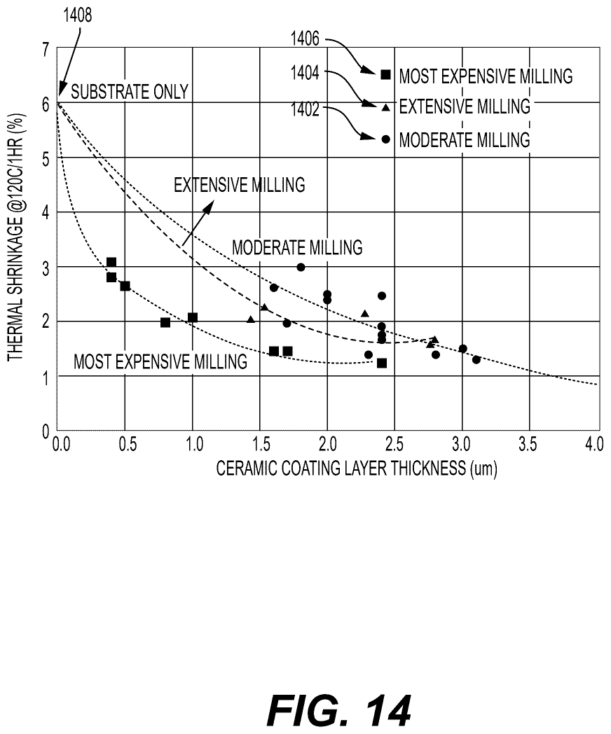

FIG. 14 is a graphical plot showing the dependence of thermal shrinkage of separators on separator coating thicknesses, for samples of ceramic (nano) particles of respective milling conditions. These separator coatings are disposed on polymer membranes. Thermal shrinkage without constraint is measured using an oven method. A rectangular piece of separator measuring approximately 100 mm (along MD)×80 mm (along TD) (MD is a machine direction of a separator layer coating; TD is a transverse direction relative to the machine direction (90 degrees relative to the coating direction)) is placed flat onto an aluminum cooking pan without any constraints. The pan is covered with aluminum foil and placed into the center of a convection oven at 120° C. for 60 minutes. Separator dimensions in the MD and in the TD at several locations on the sample are measured before and after conditioning by scanning the sample in a flatbed scanner. The dimension changes from before and after conditioning are calculated as thermal shrinkage.

The thermal shrinkage data points of FIG. 14 include: (1) data points (circles, 1402) for separator coatings formed from ceramic (nano) particles that have undergone milling under moderate milling conditions (sample shown in FIG. 7B); (2) data points (triangles, 1404) for separator coatings formed from ceramic (nano) particles that have undergone milling under extensive milling conditions (sample shown in FIG. 7C); and (3) data points (squares, 1406) for separator coatings formed from ceramic (nano) particles that have undergone milling under the most extensive milling conditions (sample shown in FIG. 7D). Also shown for comparison is the thermal shrinkage 1408 of the polymer membrane substrate (thermal shrinkage of about 6% and separator coating thickness of 0 μm).

FIG. 14 indicates a general trend that when a separator coating is added to a polymer membrane, the thermal shrinkage (as measured after storage at 120° C. for 60 minutes) of the separator decreases. Whereas the thermal shrinkage (as measured after storage at 120° C. for 60 minutes) of the polymer membrane is about 6%, the thermal shrinkage (as measured after storage at 120° C. for 60 minutes) of the separator comprising a separator coating disposed on a polymer membrane may be in a range of about 0.5 to about 5.0% (e.g., about 0.5-1.0%, about 1.0-2.0%, about 2.0-3.0%, about 3.0-4.0%, about 4.0-5.0%, about 1.0-3.0%, or about 0.5-3.0%). While ceramic (nano) particles of all three milling conditions were found to be effective in reducing the thermal shrinkage (as measured after storage at 120° C. for 60 minutes), the ceramic (nano) particles with the most extensive milling (1406) were employed to achieve thermal shrinkage (as measured after storage at 120° C. for 60 minutes) in a range of about 1 to about 3% for separator coating thicknesses of less than about 1.2 μm (e.g., in a range of about 0.3 to about 1.2 μm). For separator coating thicknesses in a range of about 1.2 to about 3.5 μm, ceramic (nano) particles with extensive and moderate milling conditions were employed to achieve thermal shrinkage (as measured after storage at 120° C. for 60 minutes) in a range of about 1 to 3%. An alternative testing protocol for testing thermal shrinkage of separators includes storage at 150° C. for 15 minutes, instead of the 120° C. for 60 minutes storage as described above. According to this alternative thermal shrinkage protocol, the measured thermal shrinkage is in a range of 5 to 25% (e.g., 15-25%, 10-25%) in some implementations.

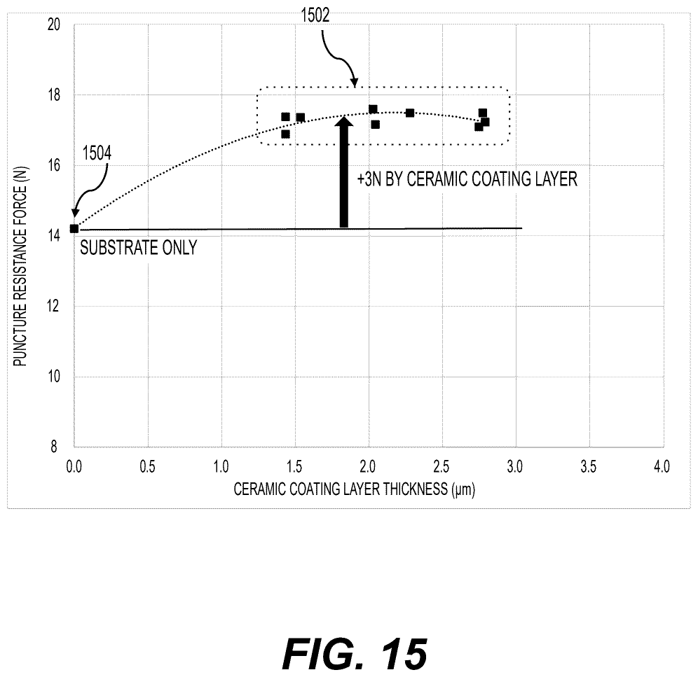

FIG. 15 is a graphical plot showing the dependence of the puncture strength (puncture resistance) of separators on separator coating thicknesses. These separator coatings are disposed on polymer membranes. The separator coatings are formed according to a process as described elsewhere herein. The ceramic (nano) particles were milled under moderate milling conditions. The puncture strength of the polymer membrane only is shown for comparison. The puncture strength was measured according to the ASTM F1306 “Standard Test Method for Slow Rate Penetration Resistance of Flexible Barrier Films and Laminates” standard.

The puncture strength data points of FIG. 15 include data points (squares, 1502) for separators comprising separator coatings disposed on polymer membranes. In the examples shown, the puncture strength values are in a range of about 16 to about 18 N for separators comprising separator coatings of thicknesses in a range of about 1.0 to about 3.0 μm disposed on polymer membranes. Also shown for comparison is a data point 1504 of the polymer membrane substrate (puncture strength of about 14 N and separator coating thickness of 0 μm). FIG. 15 indicates a general trend that when a separator coating is added to a polymer membrane, the puncture strength of the separator increases. Whereas the puncture strength of the polymer membrane is about 14 N, the puncture strength of the separator comprising a separator coating disposed on a polymer membrane may be in a range of about 15 to about 30 N (e.g., about 15-16 N, about 16-18 N, about 16-20 N, about 16-25 N, about 16-30 N, about 18-20 N, about 20-25 N, about 25-30 N, about 15-17 N, about 17-18 N, about 17-20 N, about 17-25 N, or about 17-30 N). In some designs, to attain these improved puncture strengths, suitable separator coating thicknesses may be in a range of about 1.0 to about 3.0 μm (e.g., about 1.0-2.0 μm, about 2.0-3.0 μm, about 1.0-1.2 μm, about 1.2-1.8 μm, or about 1.8-2.0 μm).

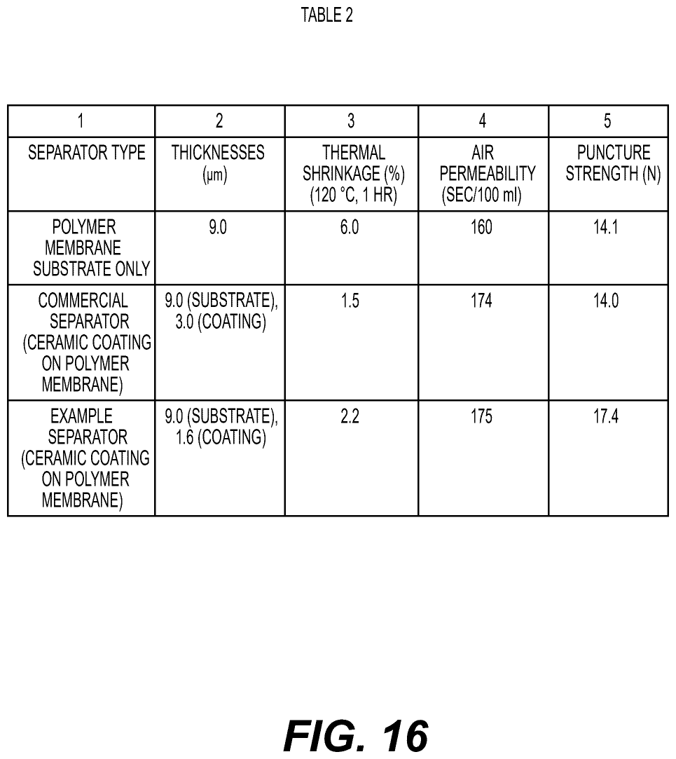

FIG. 16 (Table 2) shows selected data relating to properties of separators of respective types: (1) a (bare) polymer membrane substrate, (2) a commercially available ceramic-coated separator (CCS) (ceramic coating disposed on a polymer membrane), and (3) an example separator of a ceramic (nano) particle coating disposed on a polymer membrane. The polymer membrane substrate (type 1) is a commercially available model SB09B (9.0 μm), from W-SCOPE. This polymer membrane was also used as a substrate for example separators comprising ceramic (nano) particles disposed thereon (type 3). The CCS is a separator from W-SCOPE, comprising a ceramic coating on a polymer membrane. Table 2 reports the separator type (column 1), separator thickness (μm) (column 2), thermal shrinkage (as measured after storage at 120° C. for 60 minutes) (%) (column 3), Gurley air permeability (see/100 ml) (column 4), and puncture strength (N) (column 5). The example separator data are representative data selected from the measurement results. The Gurley air permeability data (column 4) are data for the entire separator (for the commercial separator sample and example separator sample) or the polymer membrane substrate (for the polymer membrane substrate only sample) including the underlying polymer membrane substrates and are different from the data shown in FIGS. 13A and 13B which exclude the substrates. Notably, the puncture strength of a CCS (14.0 N) is quite similar to the puncture strength of a (bare) polymer membrane substrate (14.1 N), while the puncture strength of an example separator is much higher (17.4 N). The Gurley air permeabilities of the CCS and the example separator are similar (174 sec/100 ml and 175 sec/100 ml, respectively). Both the CCS and the example separator show an improvement (decrease) of the thermal shrinkage (1.5% and 2.2%, respectively) compared to a (bare) polymer membrane substrate (6.0%). In the example shown, the thermal shrinkage of the example separator (2.2%) is higher than that of the CCS (1.5%); note, however, that the separator coating in the CCS is thicker than the separator coating in the example separator (3.0 μm and 1.6 μm). As illustrated in FIG. 14, thermal shrinkage values in a range of about 1.0 to about 2.0% can be achieved with example separators comprising ceramic (nano) particles disposed on polymer membranes.

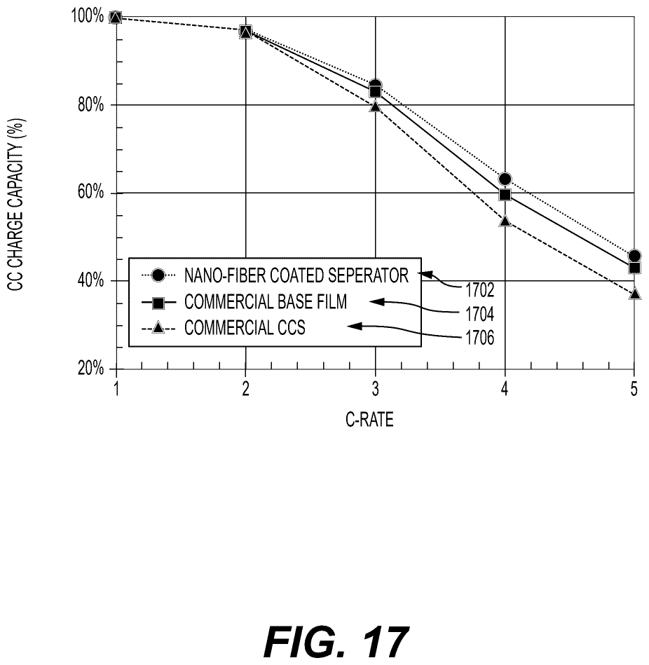

FIG. 17 is a graphical plot showing the dependence of the normalized charge capacity (normalized to respective charge capacities at a normalized charge rate of 1 C) on normalized charge rate (C-rate) for three types of lithium-ion battery test cells: (1) test cells each comprising an example separator comprising a ceramic (nano) particle coating on a polymer membrane (circles, 1702), (2) test cells each comprising a (bare) polymer membrane as the separator (squares, 1704), and (3) test cells each comprising a commercially available ceramic-coated separator (CCS) (ceramic coating disposed on a polymer membrane) (triangles, 1706). The type 3 test cells comprising CCS exhibited the greatest decay of normalized charge capacity for increasing normalized charge rates. Notably, the type 2 test cells comprising the (bare) polymer membranes exhibited a smaller decay of normalized charge capacity for increasing normalized charge rates, compared to the type 3 test cells comprising ceramic-coated separators. The type 1 test cells comprising the example separators exhibited the smallest decay of normalized charge capacity for increasing normalized charge rates.

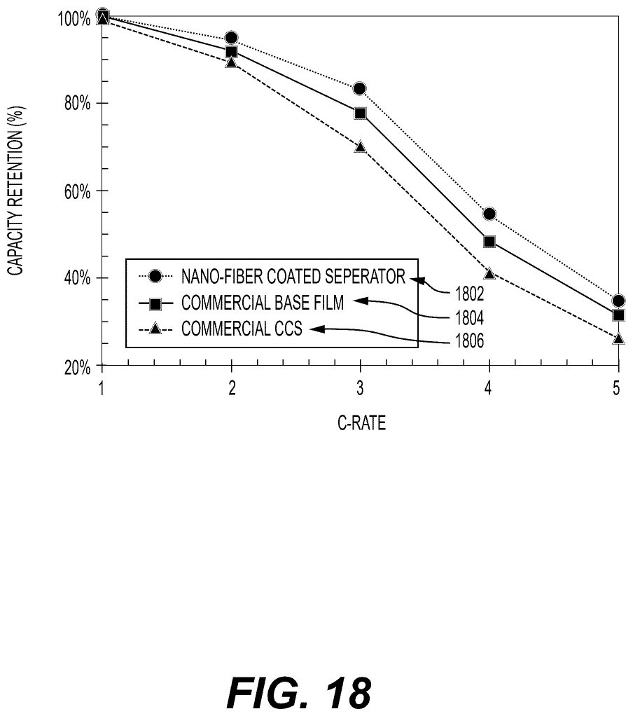

FIG. 18 is a graphical plot showing the dependence of the normalized capacity retention (normalized to respective capacity retention values at a normalized charge rate of 1 C) on the normalized charge rate (C-rate), for three types of lithium-ion battery test cells: (1) test cells each comprising an example separator comprising a ceramic (nano) particle coating on a polymer membrane (circles, 1802), (2) test cells each comprising a (bare) polymer membrane as the separator (squares, 1804), and (3) test cells each comprising a commercially available ceramic-coated separator (CCS) (ceramic coating disposed on a polymer membrane) (triangles, 1806). Capacity retention (at cycle n), which may be used to evaluate cycling stability, is the ratio of discharge capacity (at cycle n) to initial discharge capacity (cycling start discharge capacity). Li-ion battery's Coulombic efficiency (CE) is defined as the quotient of the discharge capacity and its antecedent charge capacity for a given set of operating conditions. It is a measure of how reversible the electrochemical energy storing reactions are, with any value less than unity indicating non-productive, often irreversible, reactions. While non-productive reactions can be reversible and result only in self-discharge of the battery, many are irreversible and have more severe consequences. The importance of CE is appreciated when considering that rechargeable Li-ion batteries are chemically isolated systems with a limited inventory of reactants (Li and anode/cathode active materials) that need to remain electrochemically active for hundreds of charge-discharge cycles over many years to ensure minimal energy or power loss. The type 3 test cells comprising CCS exhibited the greatest decay of normalized capacity retention for increasing normalized charge rates. Notably, the type 2 test cells comprising the (bare) polymer membranes exhibited a smaller decay of normalized capacity retention for increasing normalized charge rates, compared to the type 3 test cells comprising ceramic-coated separators. The type 1 test cells comprising the example separators exhibited the smallest decay of normalized capacity retention for increasing normalized charge rates.

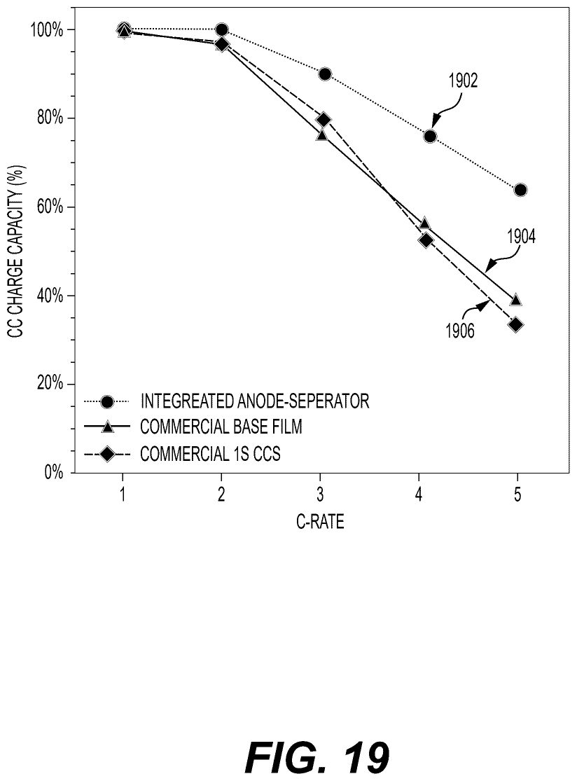

FIG. 19 is a graphical plot showing the dependence of the normalized charge capacity (normalized to respective charge capacities at a normalized charge rate of 1 C) on the normalized charge rate, for three types of lithium-ion battery test cells: (1) test cells each comprising an example integrated anode electrode-separator component (circles, 1902), (2) test cells each comprising a (bare) polymer membrane as the separator (triangles, 1904), and (3) test cells each comprising a commercially available ceramic-coated separator (CCS) (ceramic coating disposed on a polymer membrane) (rhombuses, 1906). The type 1 test cells comprising the example integrated anode electrode-separator components exhibited the smallest decay of normalized charge capacity for increasing normalized charge rates. For the type 1 test cells, the normalized capacity was in a range of about 60 to about 65% at a normalized charge rate of 5 C, and in a range of about 75 to about 80% at a normalized charge rate of 4 C. Accordingly, in some implementations, integrated anode-separator components and/or integrated cathode-separator components may be employed in lithium-ion batteries for fast-charge and/or fast-discharge applications.

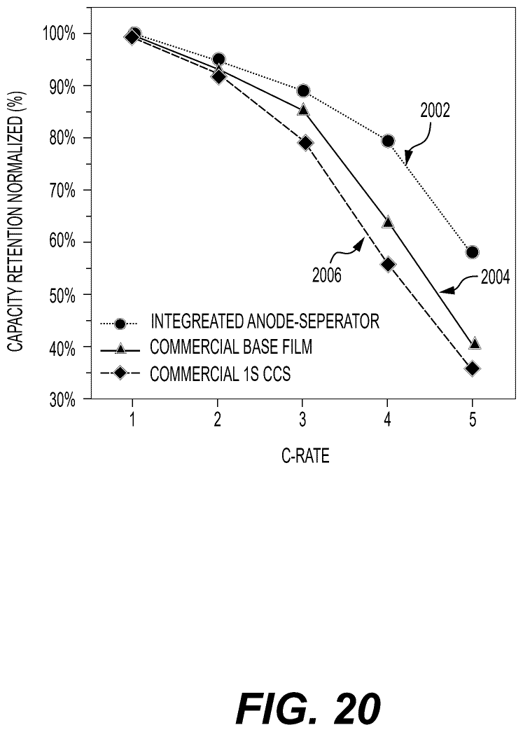

FIG. 20 is a graphical plot showing the dependence of the normalized capacity retention on the normalized charge rate, for three types of lithium-ion battery test cells: (1) test cells each comprising an example integrated anode electrode-separator component (circles, 2002), (2) test cells each comprising a (bare) polymer membrane as the separator (triangles, 2004), and (3) test cells each comprising a commercially available ceramic-coated separator (CCS) (ceramic coating disposed on a polymer membrane) (rhombuses, 2006). The type 1 test cells comprising the example integrated anode electrode-separator components exhibited the smallest decay of normalized capacity retention for increasing normalized charge rates. For the type 1 test cells, the normalized capacity retention was in a range of about 55 to about 60% at a normalized charge rate of 5 C, and in a range of about 75 to about 80% at a normalized charge rate of 4 C. Accordingly, in some implementations, integrated anode-separator components and/or integrated cathode-separator components may be employed in lithium-ion batteries for fast-charge and/or fast-discharge applications.

Battery cell modules or battery cell packs may advantageously comprise cells with anode electrodes, cathode electrodes, separators and/or electrolyte compositions provided in this disclosure. Such cell modules or packs may offer improved performance characteristics, simplified designs, better safety features, and/or lower cost.

By way of example, the disclosed herein batteries can be advantageously used in hand-held and/or wearable electronic devices, such as a phone, watch, or laptop computer; in stationary electronic devices, such as a desktop or mainframe computer; in an electric tool, such as a power drill; in an electric or hybrid land, water, or air-based vehicle, such as a boat, submarine, bus, train, truck, car, motorcycle, moped, powered bicycle, airplane, air taxi, drone, other flying vehicle, or toy versions thereof; for other toys; for energy storage, such as in storing electric power from wind, solar, wave, hydropower, or nuclear energy and/or in grid storage, or as a stationary power store for small-scale use, such as for a home, business, or hospital.

In addition, batteries, according to the present disclosure, may be multi-cell batteries containing at least about 10, at least about 100, at least about 500 batteries of the present disclosure. Batteries in multi-cell batteries may be arranged in parallel or in series. In some designs, it may be advantageous to utilize an adhesive coating on the one electrode (e.g., cathode) when pairing with an integrated separator deposited on another electrode (e.g., anode).

In the detailed description above, it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause is not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A separator, comprising: a polymer membrane; and a separator coating disposed on the polymer membrane comprising (1) ceramic particles comprising a mixture of higher-aspect ratio ceramic particles (HARCPs) and lower-aspect ratio ceramic particles (LARCPs) and (2) a binder, the separator coating having a thickness of about 1.0 μm to about 3.0 μm, a mass fraction of the binder in the separator coating being about 20 wt. % or less, wherein: the ceramic particles comprise (undoped or doped, e.g., with Li or Mg or other metals, e.g., at the 0.1 ppm-1000 ppm doping range relative to all metals in the ceramic particles) Al₂O₃, AlPO₄, AlO(OH), and/or Al(OH)₃; the HARCPs are characterized by an HARCP aspect ratio of more than about 3; and the LARCPs are characterized by an LARCP aspect ratio of about 1 to about 3.

Clause 2. The separator of clause 1, wherein: a Gurley air permeability of the separator coating is in a range of about 10 sec/100 ml to about 60 sec/100 ml.

Clause 3. The separator of clause 2, wherein: the Gurley air permeability is in a range of about 10 sec/100 ml to about 40 sec/100 ml.

Clause 4. The separator of any of clauses 1 to 3, wherein: the thickness of the separator coating is in a range of about 1.0 μm to about 2.0 μm.

Clause 5. The separator of clause 4, wherein: the thickness of the separator coating is in a range of about 1.2 μm to about 1.8 μm.

Clause 6. The separator of any of clauses 1 to 5, wherein: the mass fraction of the binder is in a range of about 5 wt. % to about 15 wt. %.

Clause 7. The separator of any of clauses 1 to 6, wherein: an average length of the HARCPs is in a range of about 1.0 μm to about 30.0 μm.

Clause 8. The separator of any of clauses 1 to 7, wherein: an average length of the LARCPs is in a range of about 0.1 μm to about 3.0 μm.

Clause 9. The separator of any of clauses 1 to 8, wherein: a Brunauer-Emmett-Teller specific surface area (BET-SSA) of the ceramic particles is in a range of about 30 to about 400 m²/g.

Clause 10. The separator of any of clauses 1 to 9, wherein: a particle size distribution of the ceramic particles, as measured by laser particle size distribution analysis (LPSA), exhibits at least one peak in a range of about 0.1 μm to about 20 μm.

Clause 11. The separator of clause 10, wherein: the peak is in a range of about 0.1 μm to about 2.0 μm.

Clause 12. The separator of any of clauses 1 to 11, wherein: the HARCPs are aligned more closely to a longitudinal direction within a plane of the polymer membrane than to a direction perpendicular to the plane.

Clause 13. The separator of any of clauses 1 to 12, wherein: a puncture strength of the separator is in a range of about 15 to about 30 N.

Clause 14. The separator of any of clauses 1 to 13, wherein: a thermal shrinkage of the separator, after storage at 120° C. for 60 minutes, is in a range of about 0.5 to about 5.0%.

Clause 15. The separator of clause 14, wherein: the thermal shrinkage of the separator, after the storage at 120° C. for 60 minutes, is in a range of about 0.5 to about 3.0%.

Clause 16. A lithium-ion battery, comprising: an anode; a cathode; an electrolyte ionically coupling the anode and the cathode; and the separator of clause 1 disposed in a space between the anode and the cathode.

Clause 17. An integrated electrode-separator component, comprising: an electrode coating disposed on a current collector and comprising electrode active material; and a separator coating disposed on the electrode coating comprising (1) ceramic particles comprising a mixture of higher-aspect ratio ceramic particles (HARCPs) and lower-aspect ratio ceramic particles (LARCPs) and (2) a binder, the separator coating having a thickness of about 1.0 μm to about 10 μm, a mass fraction of the binder in the separator coating being about 20 wt. % or less, wherein: the ceramic particles comprise Al₂O₃, AlO(OH), and/or Al(OH)₃; the HARCPs are characterized by an HARCP aspect ratio of more than about 3; and the LARCPs are characterized by an LARCP aspect ratio of about 1 to about 3.

Clause 18. The integrated electrode-separator component of clause 17, wherein: a Gurley air permeability of the separator coating is in a range of about 10 sec/100 ml to about 60 sec/100 ml.

Clause 19. The integrated electrode-separator component of clause 18, wherein: the Gurley air permeability is in a range of about 10 sec/100 ml to about 40 sec/100 ml.

Clause 20. The integrated electrode-separator component of any of clauses 17 to 19, wherein: the thickness of the separator coating is in a range of about 1.0 μm to about 5.0 μm.

Clause 21. The integrated electrode-separator component of clause 20, wherein: the thickness of the separator coating is in a range of about 1.0 μm to about 3.0 μm.

Clause 22. The integrated electrode-separator component of any of clauses 17 to 21, wherein: the mass fraction of the binder is in a range of about 5 wt. % to about 15 wt. %.

Clause 23. The integrated electrode-separator component of any of clauses 17 to 22, wherein: an average length of the HARCPs is in a range of about 1.0 μm to about 30.0 μm.

Clause 24. The integrated electrode-separator component of any of clauses 17 to 23, wherein: an average length of the LARCPs is in a range of about 0.1 μm to about 3.0 μm.

Clause 25. The integrated electrode-separator component of any of clauses 17 to 24, wherein: a Brunauer-Emmett-Teller specific surface area (BET-SSA) of the ceramic particles is in a range of about 30 to about 400 m²/g.

Clause 26. The integrated electrode-separator component of any of clauses 17 to 25, wherein: a particle size distribution of the ceramic particles, as measured by laser particle size distribution analysis (LPSA), exhibits at least one peak in a range of about 0.1 μm to about 20 μm.

Clause 27. The integrated electrode-separator component of clause 26, wherein: the peak is in a range of about 0.1 μm to about 2.0 μm.

Clause 28. The integrated electrode-separator component of any of clauses 17 to 27, wherein: the HARCPs are aligned more closely to a longitudinal direction within a plane of the current collector than to a direction perpendicular to the plane.

Clause 29. The integrated electrode-separator component of any of clauses 17 to 28, wherein: the binder is a separator binder; the electrode coating comprises an electrode binder; and the separator binder and the electrode binder share a common chemical structure.

Clause 30. The integrated electrode-separator component of any of clauses 17 to 29, wherein: the separator coating and the electrode coating meet at an intermixing region comprising the electrode active material and the ceramic particles; and a thickness of the intermixing region is in a range of about 5 to about 50% of the thickness of the separator coating.

Clause 31. A lithium-ion battery, comprising: the integrated electrode-separator component of clause 17, the electrode coating thereof being configured as a first electrode of the lithium-ion battery; a second electrode in contact with and facing toward the separator coating of the integrated electrode-separator component; and an electrolyte ionically coupling the first electrode and the second electrode.

Clause 32. A lithium-ion battery, comprising: a first instantiation and a second instantiation of the integrated electrode-separator component of clause 17, the electrode coating of the first instantiation being configured as an anode of the lithium-ion battery, the electrode coating of the second instantiation being configured as a cathode of the lithium-ion battery; the separator coating of the first instantiation and the separator coating of the second instantiation being in contact with each other and facing toward each other, constituting at least part of a separator; and an electrolyte ionically coupling the cathode and the anode.

Clause 33. A method comprising: (A1) preparing a dispersion comprising (1) ceramic particles comprising a mixture of higher-aspect ratio ceramic particles (HARCPs) and lower-aspect ratio ceramic particles (LARCPs), (2) a binder, and (3) a solvent; and (A2) dispensing the dispersion on a substrate to form a layer and drying the layer to form a separator coating on the substrate, wherein: a thickness of the separator coating is in a range of about 1.0 μm to about 10 μm; a mass fraction of the binder in the separator coating is about 20 wt. % or less; the ceramic particles comprise Al₂O₃, AlPO₄, AlO(OH), and/or Al(OH)₃; the HARCPs are characterized by an HARCP aspect ratio of more than about 3; and the LARCPs are characterized by an LARCP aspect ratio of about 1 to about 3.

Clause 34. The method of clause 33, wherein: a Gurley air permeability of the separator coating is in a range of about 10 sec/100 ml to about 60 sec/100 ml.

Clause 35. The method of clause 34, wherein: the Gurley air permeability is in a range of about 10 sec/100 ml to about 40 sec/100 ml.

Clause 36. The method of any of clauses 33 to 35, wherein: the thickness of the separator coating is in a range of about 1.0 μm to about 5.0 μm.

Clause 37. The method of clause 36, wherein: the thickness of the separator coating is in a range of about 1.0 μm to about 3.0 μm.

Clause 38. The method of clause 37, wherein: the thickness of the separator coating is in a range of about 1.0 μm to about 2.0 μm.

Clause 39. The method of clause 38, wherein: the thickness of the separator coating is in a range of about 1.2 μm to about 1.8 μm.

Clause 40. The method of any of clauses 33 to 39, wherein: the mass fraction of the binder is in a range of about 5 wt. % to about 15 wt. %.

Clause 41. The method of any of clauses 33 to 40, wherein: an average length of the HARCPs is in a range of about 1.0 μm to about 30.0 μm.

Clause 42. The method of any of clauses 33 to 41, wherein: an average length of the LARCPs is in a range of about 0.1 μm to about 3.0 μm.

Clause 43. The method of any of clauses 33 to 42, wherein: a Brunauer-Emmett-Teller specific surface area (BET-SSA) of the ceramic particles is in a range of about 30 to about 400 m²/g.

Clause 44. The method of any of clauses 33 to 43, wherein: a particle size distribution of the ceramic particles, as measured by laser particle size distribution analysis (LPSA), exhibits at least one peak in a range of about 0.1 μm to about 20 μm.

Clause 45. The method of clause 44, wherein: the peak is in a range of about 0.1 μm to about 2.0 μm.

Clause 46. The method of any of clauses 33 to 45, wherein: the dispensing of the dispersion is along a machine direction within a plane of the substrate; and the HARCPs are aligned more closely to the machine direction than to a direction perpendicular to the plane.

Clause 47. The method of any of clauses 33 to 46, wherein: the binder is a separator binder; the electrode coating comprises an electrode binder; and the separator binder and the electrode binder share a common chemical structure.

Clause 48. The method of any of clauses 33 to 47, wherein: the separator coating and the electrode coating meet at an intermixing region comprising the electrode active material and the ceramic particles; and a thickness the intermixing region is in a range of about 5 to about 50% of a thickness of the separator coating.

Clause 49. The method of any of clauses 33 to 48, wherein: the substrate is in the form of a roll.

Clause 50. The method of any of clauses 33 to 49, wherein: the substrate comprises a polymer membrane.

Clause 51. A separator comprising the separator coating made according to the method of any of clauses 33 to 50.

Clause 52. The separator of clause 51, wherein: a puncture strength of the separator is in a range of about 15 to about 30 N.

Clause 53. The separator of any of clauses 51 to 52, wherein: a thermal shrinkage of the separator, after storage at 120° C. for 60 minutes, is in a range of about 0.5 to about 5.0%.

Clause 54. The separator of clause 53, wherein: the thermal shrinkage of the separator, after the storage at 120° C. for 60 minutes, is in a range of about 0.5 to about 3.0%.

Clause 55. A lithium-ion battery, comprising: an anode; a cathode; an electrolyte ionically coupling the anode and the cathode; and the separator of clause 51 disposed in a space between the anode and the cathode.

Clause 56. The method of any of clauses 33 to 55, wherein: the substrate comprises an electrode coating disposed on a current collector and comprising electrode active material.

Clause 57. An integrated electrode-separator component comprising: the separator coating on the substrate made according to the method of clause 56.

Clause 58. A lithium-ion battery, comprising: the integrated electrode-separator component of clause 57, the electrode coating thereof being configured as a first electrode of the lithium-ion battery; a second electrode in contact with and facing toward the separator coating of the integrated electrode-separator component; and an electrolyte ionically coupling the first electrode and the second electrode.

Clause 59. A lithium-ion battery, comprising: a first instantiation and a second instantiation of the integrated electrode-separator component of clause 57, the electrode coating of the first instantiation being configured as an anode of the lithium-ion battery, the electrode coating of the second instantiation being configured as a cathode of the lithium-ion battery; the separator coating of the first instantiation and the separator coating of the second instantiation being in contact with each other and facing toward each other, constituting at least part of a separator; and an electrolyte ionically coupling the cathode and the anode.

Clause 60. A method comprising: (B1) preparing a slurry comprising (1) an electrode active material, (2) a first binder, and (3) a first solvent; (B2) preparing a dispersion comprising (1) ceramic particles comprising a mixture of higher-aspect ratio ceramic particles (HARCPs) and lower-aspect ratio ceramic particles (LARCPs) and (2) a second binder, and (3) a second solvent; (B3) dispensing the slurry on a current collector to form a first layer; (B4) dispensing the dispersion on the first layer to form a second layer, while the first layer is still wet; and (B5) drying the first and second layers concurrently to form an integrated electrode-separator component, the first layer becoming the electrode coating, the second layer becoming the separator coating, wherein: a first thickness of the electrode coating is in a range of about 10 μm to about 300 μm; a second thickness of the separator coating is in a range of about 1.0 μm to about 10 μm; a mass fraction of the binder in the separator coating is about 20 wt. % or less, the ceramic particles comprise Al₂O₃, AlPO₄, AlO(OH), and/or Al(OH)₃; the HARCPs are characterized by an HARCP aspect ratio of more than about 3; and the LARCPs are characterized by an LARCP aspect ratio of about 1 to about 3.

Clause 61. The method of clause 60, wherein: a Gurley air permeability of the separator coating is in a range of about 10 sec/100 ml to about 60 sec/100 ml.

Clause 62. The method of clause 61, wherein: the Gurley air permeability is in a range of about 10 sec/100 ml to about 40 sec/100 ml.

Clause 63. The method of any of clauses 60 to 62, wherein: the second thickness of the separator coating is in a range of about 1.0 μm to about 5.0 μm.

Clause 64. The method of clause 63, wherein: the second thickness of the separator coating is in a range of about 1.0 μm to about 3.0 μm.

Clause 65. The method of clause 64, wherein: the thickness of the separator coating is in a range of about 1.0 μm to about 2.0 μm.

Clause 66. The method of clause 65, wherein: the thickness of the separator coating is in a range of about 1.2 μm to about 1.8 μm.

Clause 67. The method of any of clauses 60 to 66, wherein: the mass fraction of the binder is in a range of about 5 wt. % to about 15 wt. %.

Clause 68. The method of any of clauses 60 to 67, wherein: an average length of the HARCPs is in a range of about 1.0 μm to about 30.0 μm.

Clause 69. The method of any of clauses 60 to 68, wherein: an average length of the LARCPs is in a range of about 0.1 μm to about 3.0 μm.

Clause 70. The method of any of clauses 60 to 69, wherein: a Brunauer-Emmett-Teller specific surface area (BET-SSA) of the ceramic particles is in a range of about 30 to about 400 m²/g.

Clause 71. The method of any of clauses 60 to 70, wherein: a particle size distribution of the ceramic particles, as measured by laser particle size distribution analysis (LPSA), exhibits at least one peak in a range of about 0.1 μm to about 20 μm.

Clause 72. The method of clause 71, wherein: the peak is in a range of about 0.1 μm to about 2.0 μm.

Clause 73. The method of any of clauses 60 to 72, wherein: the dispensing of the dispersion is along a machine direction within a plane of the current collector; and the HARCPs are aligned more closely to the machine direction than to a direction perpendicular to the plane.

Clause 74. The method of any of clauses 60 to 73, wherein: the binder is a separator binder; the electrode coating comprises an electrode binder; and the separator binder and the electrode binder share a common chemical structure.

Clause 75. The method of any of clauses 60 to 74, wherein: the separator coating and the electrode coating meet at an intermixing region comprising the electrode active material and the ceramic particles; and a thickness the intermixing region is in a range of about 5 to about 50% of a thickness of the separator coating.

Clause 76. The method of any of clauses 60 to 75, wherein: the current collector is in the form of a roll.

Clause 77. An integrated electrode-separator component made according to the method of any of clauses 60 to 76.

Clause 78. A lithium-ion battery, comprising: the integrated electrode-separator component of clause 77, the electrode coating thereof being configured as a first electrode of the lithium-ion battery; a second electrode in contact with and facing toward the separator coating of the integrated electrode-separator component; and an electrolyte ionically coupling the first electrode and the second electrode.

Clause 79. A lithium-ion battery, comprising: a first instantiation and a second instantiation of the integrated electrode-separator component of clause 77, the electrode coating of the first instantiation being configured as an anode of the lithium-ion battery, the electrode coating of the second instantiation being configured as a cathode of the lithium-ion battery; the separator coating of the first instantiation and the separator coating of the second instantiation being in contact with each other and facing toward each other, constituting at least part of a separator; and an electrolyte ionically coupling the cathode and the anode.

Additional implementation examples are described in the following numbered Additional Clauses:

Additional Clause 1: A separator, comprising: a polymer membrane; and a separator coating disposed on the polymer membrane comprising (1) ceramic particles comprising a mixture of higher-aspect ratio ceramic particles (HARCPs) and lower-aspect ratio ceramic particles (LARCPs) and (2) a binder, the separator coating having a thickness of about 0.5 μm to about 5.0 μm, a mass fraction of the binder in the separator coating being about 20 wt. % or less, wherein: the ceramic particles comprise Al₂O₃, AlO(OH), and/or Al(OH)₃; the HARCPs are characterized by an HARCP aspect ratio of more than about 3; and the LARCPs are characterized by an LARCP aspect ratio of about 1 to about 3.

Additional Clause 2: The separator of Additional Clause 1, wherein: a Gurley air permeability of the separator coating is in a range of about 7 sec/100 ml to about 60 sec/100 ml.

Additional Clause 3: The separator of any of Additional Clauses 1 to 2, wherein: the Gurley air permeability of the separator coating is in a range of about 7 sec/100 ml to about 40 sec/100 ml.

Additional Clause 4: The separator of any of Additional Clauses 1 to 3, wherein: the thickness of the separator coating is in a range of about 1.0 μm to about 4.0 μm.

Additional Clause 5: The separator of any of Additional Clauses 1 to 4, wherein: the thickness of the separator coating is in a range of about 1.0 μm to about 3.5 μm.

Additional Clause 6: The separator of any of Additional Clauses 1 to 5, wherein: the thickness of the separator coating is in a range of about 1.0 μm to about 3.0 μm.

Additional Clause 7: The separator of any of Additional Clauses 1 to 6, wherein: the mass fraction of the binder is in a range of about 5 wt. % to about 15 wt. %.

Additional Clause 8: The separator of any of Additional Clauses 1 to 7, wherein: an average length of the HARCPs is in a range of about 1.0 μm to about 30.0 μm; and/or an average length of the LARCPs is in a range of about 0.1 μm to about 3.0 μm.

Additional Clause 9: The separator of any of Additional Clauses 1 to 8, wherein: a Brunauer-Emmett-Teller specific surface area (BET-SSA) of the ceramic particles is in a range of about 30 to about 400 m²/g.

Additional Clause 10: The separator of any of Additional Clauses 1 to 9, wherein: a particle size distribution of the ceramic particles, as measured by laser particle size distribution analysis (LPSA), exhibits at least a first peak and a second peak in a range of about 0.1 μm to about 8 μm.

Additional Clause 11: The separator of any of Additional Clauses 1 to 10, wherein: the first peak is in a range of about 0.1 μm to about 1.0 μm and the second peak is in a range of about 1 μm to about 8 μm.

Additional Clause 12: The separator of any of Additional Clauses 1 to 11, wherein: the HARCPs are aligned more closely to a longitudinal direction within a plane of the polymer membrane than to a direction perpendicular to the plane.

Additional Clause 13: The separator of any of Additional Clauses 1 to 12, wherein: a puncture strength of the separator is in a range of about 15 to about 30 N; and/or a thermal shrinkage of the separator, after storage at 120° C. for 60 minutes, is in a range of 0.5 to 5.0%; and/or a thermal shrinkage of the separator, after storage at 150° C. for 15 minutes, is in a range of 10 to 25%.

Additional Clause 14: The separator of any of Additional Clauses 1 to 13, wherein: the thermal shrinkage of the separator, after the storage at 120° C. for 60 minutes, is in a range of about 0.5 to about 3.0%.

Additional Clause 15: A lithium-ion battery, comprising: an anode; a cathode; an electrolyte ionically coupling the anode and the cathode; and the separator of any of Additional Clauses 1 to 14 disposed in a space between the anode and the cathode.

Additional Clause 16: A method comprising: (A1) preparing a dispersion comprising (1) ceramic particles comprising a mixture of higher-aspect ratio ceramic particles (HARCPs) and lower-aspect ratio ceramic particles (LARCPs), (2) a binder, and (3) a solvent; and (A2) dispensing the dispersion on a substrate to form a layer and drying the layer to form a separator coating on the substrate, wherein: a thickness of the separator coating is in a range of about 0.5 μm to about 5.0 μm; a mass fraction of the binder in the separator coating is about 20 wt. % or less; the ceramic particles comprise Al₂O₃, AlO(OH), and/or Al(OH)₃; the HARCPs are characterized by an HARCP aspect ratio of more than about 3; and the LARCPs are characterized by an LARCP aspect ratio of about 1 to about 3; and the substrate comprises a polymer membrane.

Additional Clause 17: The method of Additional Clause 16, wherein: a Gurley air permeability of the separator coating is in a range of about 7 sec/100 ml to about 60 sec/100 ml.

Additional Clause 18: The method of any of Additional Clauses 16 to 17, wherein: the Gurley air permeability of the separator coating is in a range of about 7 sec/100 ml to about 40 sec/100 ml.

Additional Clause 19: The method of any of Additional Clauses 16 to 18, wherein: the thickness of the separator coating is in a range of about 1.0 μm to about 4.0 μm.

Additional Clause 20: The method of any of Additional Clauses 16 to 19, wherein: the thickness of the separator coating is in a range of about 1.0 μm to about 3.5 μm.

Additional Clause 21: The method of any of Additional Clauses 16 to 20, wherein: the thickness of the separator coating is in a range of about 1.0 μm to about 3.0 μm.

Additional Clause 22: The method of any of Additional Clauses 16 to 21, wherein: the mass fraction of the binder is in a range of about 5 wt. % to about 15 wt. %.

Additional Clause 23: The method of any of Additional Clauses 16 to 22, wherein: an average length of the HARCPs is in a range of about 1.0 μm to about 30.0 μm; and/or an average length of the LARCPs is in a range of about 0.1 μm to about 3.0 μm.

Additional Clause 24: The method of any of Additional Clauses 16 to 23, wherein: a Brunauer-Emmett-Teller specific surface area (BET-SSA) of the ceramic particles is in a range of about 30 to about 400 m²/g.

Additional Clause 25: The method of any of Additional Clauses 16 to 24, wherein: a particle size distribution of the ceramic particles, as measured by laser particle size distribution analysis (LPSA), exhibits at least at least a first peak and a second peak in a range of about 0.1 μm to about 8 μm.

Additional Clause 26: The method of any of Additional Clauses 16 to 25, wherein: the first peak is in a range of about 0.1 μm to about 1.0 μm and the second peak is in a range of about 1 μm to about 8 μm.

Additional Clause 27: The method of any of Additional Clauses 16 to 26, wherein: the dispensing of the dispersion is along a machine direction within a plane of the substrate; and the HARCPs are aligned more closely to the machine direction than to a direction perpendicular to the plane.

Additional Clause 28: The method of any of Additional Clauses 16 to 27, wherein: the substrate is in the form of a roll.

Additional Clause 29: A separator comprising the separator coating made according to the method of any of Additional Clauses 16 to 28.

Additional Clause 30: A lithium-ion battery, comprising: an anode; a cathode; an electrolyte ionically coupling the anode and the cathode; and the separator of any of Additional Clauses 16 to 29 disposed in a space between the anode and the cathode.

Additional Clause 31: An integrated electrode-separator component, comprising: an electrode coating disposed on and/or in a current collector and comprising electrode active material; and a separator coating disposed on the electrode coating comprising (1) ceramic particles comprising a mixture of higher-aspect ratio ceramic particles (HARCPs) and lower-aspect ratio ceramic particles (LARCPs) and (2) a binder, the separator coating having a thickness of about 1.0 μm to about 15 m, a mass fraction of the binder in the separator coating being about 20 wt. % or less, wherein: the ceramic particles comprise Al₂O₃, AlO(OH), and/or Al(OH)₃; the HARCPs are characterized by an HARCP aspect ratio of more than about 3; and the LARCPs are characterized by an LARCP aspect ratio of about 1 to about 3.

Additional Clause 32: The integrated electrode-separator component of Additional Clause 31, wherein: a Gurley air permeability of the separator coating is in a range of about 7 sec/100 ml to about 60 sec/100 ml.

Additional Clause 33: The integrated electrode-separator component of any of Additional Clauses 31 to 32, wherein: the Gurley air permeability of the separator coating is in a range of about 7 sec/100 ml to about 40 sec/100 ml.

Additional Clause 34: The integrated electrode-separator component of any of Additional Clauses 31 to 33, wherein: the thickness of the separator coating is in a range of about 1.0 μm to about 10 μm.

Additional Clause 35: The integrated electrode-separator component of any of Additional Clauses 31 to 34, wherein: the thickness of the separator coating is in a range of about 1.0 μm to about 7.0 μm.

Additional Clause 36: The integrated electrode-separator component of any of Additional Clauses 31 to 35, wherein: the thickness of the separator coating is in a range of about 1.0 μm to about 5.0 μm.

Additional Clause 37: The integrated electrode-separator component of any of Additional Clauses 31 to 36, wherein: the thickness of the separator coating is in a range of about 1.0 μm to about 3.0 μm.

Additional Clause 38: The integrated electrode-separator component of any of Additional Clauses 31 to 37, wherein: the thickness of the separator coating is in a range of about 1.2 μm to about 2.0 μm.

Additional Clause 39: The integrated electrode-separator component of any of Additional Clauses 31 to 38, wherein: the mass fraction of the binder is in a range of about 5 wt. % to about 15 wt. %.

Additional Clause 40: The integrated electrode-separator component of any of Additional Clauses 31 to 39, wherein: an average length of the HARCPs is in a range of about 1.0 μm to about 30.0 μm; and/or an average length of the LARCPs is in a range of about 0.1 μm to about 3.0 μm.

Additional Clause 41: The integrated electrode-separator component of any of Additional Clauses 31 to 40, wherein: a Brunauer-Emmett-Teller specific surface area (BET-SSA) of the ceramic particles is in a range of about 30 to about 400 m²/g.

Additional Clause 42: The integrated electrode-separator component of any of Additional Clauses 31 to 41, wherein: a particle size distribution of the ceramic particles, as measured by laser particle size distribution analysis (LPSA), exhibits at least a first peak and a second peak in a range of about 0.1 μm to about 8 μm.

Additional Clause 43: The integrated electrode-separator component of any of Additional Clauses 31 to 42, wherein: the first peak is in a range of about 0.1 μm to about 1.0 μm and the second peak is in a range of about 1 μm to about 8 μm.

Additional Clause 44: The integrated electrode-separator component of any of Additional Clauses 31 to 43, wherein: the HARCPs are aligned more closely to a longitudinal direction within a plane of the current collector than to a direction perpendicular to the plane.

Additional Clause 45: The integrated electrode-separator component of any of Additional Clauses 31 to 44, wherein: the binder is a separator binder; the electrode coating comprises an electrode binder; and the separator binder and the electrode binder share a common chemical structure.

Additional Clause 46: The integrated electrode-separator component of any of Additional Clauses 31 to 45, wherein: the separator coating and the electrode coating meet at an intermixing region comprising the electrode active material and the ceramic particles; and a thickness of the intermixing region is in a range of about 5 to about 50% of the thickness of the separator coating.

Additional Clause 47: A lithium-ion battery, comprising: the integrated electrode-separator component of any of Additional Clauses 31 to 46, the electrode coating thereof being configured as a first electrode of the lithium-ion battery; a second electrode in contact with and facing toward the separator coating of the integrated electrode-separator component; and an electrolyte ionically coupling the first electrode and the second electrode.

Additional Clause 48: A lithium-ion battery, comprising: a first instantiation and a second instantiation of the integrated electrode-separator component of any of Additional Clauses 31 to 47, the electrode coating of the first instantiation being configured as an anode of the lithium-ion battery, the electrode coating of the second instantiation being configured as a cathode of the lithium-ion battery; the separator coating of the first instantiation and the separator coating of the second instantiation being in contact with each other and facing toward each other, constituting at least part of a separator; and an electrolyte ionically coupling the cathode and the anode.

Additional Clause 49: A method comprising: (A1) preparing a dispersion comprising (1) ceramic particles comprising a mixture of higher-aspect ratio ceramic particles (HARCPs) and lower-aspect ratio ceramic particles (LARCPs), (2) a binder, and (3) a solvent; and (A2) dispensing the dispersion on a substrate to form a layer and drying the layer to form a separator coating on the substrate, wherein: a thickness of the separator coating is in a range of about 1.0 μm to about 10 μm; a mass fraction of the binder in the separator coating is about 20 wt. % or less; the ceramic particles comprise Al₂O₃, AlO(OH), and/or Al(OH)₃; the HARCPs are characterized by an HARCP aspect ratio of more than about 3; the LARCPs are characterized by an LARCP aspect ratio of about 1 to about 3; and the substrate comprises an electrode coating disposed on and/or in a current collector and comprising electrode active material.

Additional Clause 50: The method of Additional Clause 49, wherein: a Gurley air permeability of the separator coating is in a range of about 7 sec/100 ml to about 60 sec/100 ml.

Additional Clause 51: The method of any of Additional Clauses 49 to 50, wherein: the Gurley air permeability of the separator coating is in a range of about 7 sec/100 ml to about 40 sec/100 ml.

Additional Clause 52: The method of any of Additional Clauses 49 to 51, wherein: the thickness of the separator coating is in a range of about 1.0 μm to about 7.0 μm.

Additional Clause 53: The method of any of Additional Clauses 49 to 52, wherein: the thickness of the separator coating is in a range of about 1.0 μm to about 5.0 μm.

Additional Clause 54: The method of any of Additional Clauses 49 to 53, wherein: the thickness of the separator coating is in a range of about 1.0 μm to about 3.0 μm.

Additional Clause 55: The method of any of Additional Clauses 49 to 54, wherein: the thickness of the separator coating is in a range of about 1.2 μm to about 2.0 μm.

Additional Clause 56: The method of any of Additional Clauses 49 to 55, wherein: the mass fraction of the binder is in a range of about 5 wt. % to about 15 wt. %.

Additional Clause 57: The method of any of Additional Clauses 49 to 56, wherein: an average length of the HARCPs is in a range of about 1.0 μm to about 30.0 μm; and/or an average length of the LARCPs is in a range of about 0.1 μm to about 3.0 μm.

Additional Clause 58: The method of any of Additional Clauses 49 to 57, wherein: a Brunauer-Emmett-Teller specific surface area (BET-SSA) of the ceramic particles is in a range of about 30 to about 400 m²/g.

Additional Clause 59: The method of any of Additional Clauses 49 to 58, wherein: a particle size distribution of the ceramic particles, as measured by laser particle size distribution analysis (LPSA), exhibits at least a first peak and a second peak in a range of about 0.1 μm to about 8 μm.

Additional Clause 60: The method of any of Additional Clauses 49 to 59, wherein: the first peak is in a range of about 0.1 μm to about 1.0 μm and the second peak is in a range of about 1 μm to about 8 μm.

Additional Clause 61: The method of any of Additional Clauses 49 to 60, wherein: the dispensing of the dispersion is along a machine direction within a plane of the substrate; and the HARCPs are aligned more closely to the machine direction than to a direction perpendicular to the plane.

Additional Clause 62: The method of any of Additional Clauses 49 to 61, wherein: the binder is a separator binder; the electrode coating comprises an electrode binder; and the separator binder and the electrode binder share a common chemical structure.

Additional Clause 63: The method of any of Additional Clauses 49 to 62, wherein: the separator coating and the electrode coating meet at an intermixing region comprising the electrode active material and the ceramic particles; and a thickness the intermixing region is in a range of about 5 to about 50% of a thickness of the separator coating.

Additional Clause 64: The method of any of Additional Clauses 49 to 63, wherein: the substrate is in the form of a roll.

Additional Clause 65: An integrated electrode-separator component comprising: the separator coating on the substrate made according to the method of any of Additional Clauses 49 to 64.

Additional Clause 66: A lithium-ion battery, comprising: the integrated electrode-separator component of any of Additional Clauses 49 to 65, the electrode coating thereof being configured as a first electrode of the lithium-ion battery; a second electrode in contact with and facing toward the separator coating of the integrated electrode-separator component; and an electrolyte ionically coupling the first electrode and the second electrode.

Additional Clause 67: A lithium-ion battery, comprising: a first instantiation and a second instantiation of the integrated electrode-separator component of any of Additional Clauses 49 to 66, the electrode coating of the first instantiation being configured as an anode of the lithium-ion battery, the electrode coating of the second instantiation being configured as a cathode of the lithium-ion battery; the separator coating of the first instantiation and the separator coating of the second instantiation being in contact with each other and facing toward each other, constituting at least part of a separator; and an electrolyte ionically coupling the cathode and the anode.

Additional Clause 68: A method, comprising: (B1) preparing a slurry comprising (1) an electrode active material, (2) a first binder, and (3) a first solvent; (B2) preparing a dispersion comprising (1) ceramic particles comprising a mixture of higher-aspect ratio ceramic particles (HARCPs) and lower-aspect ratio ceramic particles (LARCPs) and (2) a second binder, and (3) a second solvent; (B3) dispensing the slurry on a current collector to form a first layer; (B4) dispensing the dispersion on the first layer to form a second layer, while the first layer is still wet; and (B5) drying the first and second layers concurrently to form an integrated electrode-separator component, the first layer becoming an electrode coating, the second layer becoming a separator coating, wherein: a first thickness of the electrode coating is in a range of about 10 μm to about 300 μm; a second thickness of the separator coating is in a range of about 1.0 μm to about 15 μm; a mass fraction of the binder in the separator coating is about 20 wt. % or less; the ceramic particles comprise Al₂O₃, AlO(OH), and/or Al(OH)₃; the HARCPs are characterized by an HARCP aspect ratio of more than about 3; and the LARCPs are characterized by an LARCP aspect ratio of about 1 to about 3.

Additional Clause 69: The method of Additional Clause 68, wherein: a Gurley air permeability of the separator coating is in a range of about 7 sec/100 ml to about 60 sec/100 ml.

Additional Clause 70: The method of any of Additional Clauses 68 to 69, wherein: the Gurley air permeability of the separator coating is in a range of about 7 sec/100 ml to about 40 sec/100 ml.

Additional Clause 71: The method of any of Additional Clauses 68 to 70, wherein: the second thickness of the separator coating is in a range of about 1.0 μm to about 10 μm.

Additional Clause 72: The method of any of Additional Clauses 68 to 71, wherein: the second thickness of the separator coating is in a range of about 1.0 μm to about 7.0 μm.

Additional Clause 73: The method of any of Additional Clauses 68 to 72, wherein: the second thickness of the separator coating is in a range of about 1.0 μm to about 5.0 μm.

Additional Clause 74: The method of any of Additional Clauses 68 to 73, wherein: the thickness of the separator coating is in a range of about 1.0 μm to about 3.0 μm.

Additional Clause 75: The method of any of Additional Clauses 68 to 74, wherein: the thickness of the separator coating is in a range of about 1.2 μm to about 2.0 μm.

Additional Clause 76: The method of any of Additional Clauses 68 to 75, wherein: the mass fraction of the binder is in a range of about 5 wt. % to about 15 wt. %.

Additional Clause 77: The method of any of Additional Clauses 68 to 76, wherein: an average length of the HARCPs is in a range of about 1.0 μm to about 30.0 μm; and/or an average length of the LARCPs is in a range of about 0.1 μm to about 3.0 μm.

Additional Clause 78: The method of any of Additional Clauses 68 to 77, wherein: a Brunauer-Emmett-Teller specific surface area (BET-SSA) of the ceramic particles is in a range of about 30 to about 400 m²/g.

Additional Clause 79: The method of any of Additional Clauses 68 to 78, wherein: a particle size distribution of the ceramic particles, as measured by laser particle size distribution analysis (LPSA), exhibits at least at least a first peak and a second peak in a range of about 0.1 μm to about 8 μm.

Additional Clause 80: The method of any of Additional Clauses 68 to 79, wherein: the peak is in a range of about 0.1 μm to about 1.0 μm and the second peak is in a range of about 1 μm to about 8 μm.

Additional Clause 81: The method of any of Additional Clauses 68 to 80, wherein: the dispensing of the dispersion is along a machine direction within a plane of the current collector; and the HARCPs are aligned more closely to the machine direction than to a direction perpendicular to the plane.

Additional Clause 82: The method of any of Additional Clauses 68 to 81, wherein: the binder is a separator binder; the electrode coating comprises an electrode binder; and the separator binder and the electrode binder share a common chemical structure.

Additional Clause 83: The method of any of Additional Clauses 68 to 82, wherein: the separator coating and the electrode coating meet at an intermixing region comprising the electrode active material and the ceramic particles; and a thickness the intermixing region is in a range of about 5 to about 50% of a thickness of the separator coating.

Additional Clause 84: The method of any of Additional Clauses 68 to 83, wherein: the current collector is in the form of a roll.

Additional Clause 85: An integrated electrode-separator component made according to the method of any of Additional Clauses 68 to 84.

Additional Clause 86: A lithium-ion battery, comprising: the integrated electrode-separator component of any of Additional Clauses 68 to 85, the electrode coating thereof being configured as a first electrode of the lithium-ion battery; a second electrode in contact with and facing toward the separator coating of the integrated electrode-separator component; and an electrolyte ionically coupling the first electrode and the second electrode.

Additional Clause 87: A lithium-ion battery, comprising: a first instantiation and a second instantiation of the integrated electrode-separator component of any of Additional Clauses 68 to 86, the electrode coating of the first instantiation being configured as an anode of the lithium-ion battery, the electrode coating of the second instantiation being configured as a cathode of the lithium-ion battery; the separator coating of the first instantiation and the separator coating of the second instantiation being in contact with each other and facing toward each other, constituting at least part of a separator; and an electrolyte ionically coupling the cathode and the anode.

This description is provided to enable any person skilled in the art to make or use embodiments of the present invention. It will be appreciated, however, that the present invention is not limited to the particular formulations, process steps, and materials disclosed herein, as various modifications to these embodiments will be readily apparent to those skilled in the art. That is, the generic principles defined herein may be applied to other embodiments without departing from the spirit or scope of the invention.

1. A separator, comprising:
a polymer membrane; and
a separator coating disposed on the polymer membrane comprising (1) ceramic particles comprising a mixture of higher-aspect ratio ceramic particles (HARCPs) and lower-aspect ratio ceramic particles (LARCPs) and (2) a binder, the separator coating having a thickness of about 0.5 μm to about 5.0 μm, a mass fraction of the binder in the separator coating being about 20 wt. % or less,
wherein:
the ceramic particles comprise Al₂O₃, AlO(OH), and/or Al(OH)₃;
the HARCPs are characterized by an HARCP aspect ratio of more than about 3; and
the LARCPs are characterized by an LARCP aspect ratio of about 1 to about 3.

2. The separator of claim 1, wherein:
a Gurley air permeability of the separator coating is in a range of about 7 sec/100 ml to about 60 sec/100 ml.

3. The separator of claim 2, wherein:
the Gurley air permeability of the separator coating is in a range of about 7 sec/100 ml to about 40 sec/100 ml.

4. The separator of claim 1, wherein:
the thickness of the separator coating is in a range of about 1.0 μm to about 4.0 μm.

5. The separator of claim 4, wherein:
the thickness of the separator coating is in a range of about 1.0 μm to about 3.5 μm.

6. The separator of claim 5, wherein:
the thickness of the separator coating is in a range of about 1.0 μm to about 3.0 μm.

7. The separator of claim 1, wherein:
the mass fraction of the binder is in a range of about 5 wt. % to about 15 wt. %.

8. The separator of claim 1, wherein:
an average length of the HARCPs is in a range of about 1.0 μm to about 30.0 μm; and/or
an average length of the LARCPs is in a range of about 0.1 μm to about 3.0 μm.

9. The separator of claim 1, wherein:
a Brunauer-Emmett-Teller specific surface area (BET-SSA) of the ceramic particles is in a range of about 30 to about 400 m²/g.

10. The separator of claim 1, wherein:
a particle size distribution of the ceramic particles, as measured by laser particle size distribution analysis (LPSA), exhibits at least a first peak and a second peak in a range of about 0.1 μm to about 8 μm.

11. The separator of claim 10, wherein:
the first peak is in a range of about 0.1 μm to about 1.0 μm and the second peak is in a range of about 1 μm to about 8 μm.

12. The separator of claim 1, wherein:
the HARCPs are aligned more closely to a longitudinal direction within a plane of the polymer membrane than to a direction perpendicular to the plane.

13. The separator of claim 1, wherein:
a puncture strength of the separator is in a range of about 15 to about 30 N; and/or
a thermal shrinkage of the separator, after storage at 120° C. for 60 minutes, is in a range of 0.5 to 5.0%; and/or
a thermal shrinkage of the separator, after storage at 150° C. for 15 minutes, is in a range of 10 to 25%.

14. The separator of claim 13, wherein:
the thermal shrinkage of the separator, after the storage at 120° C. for 60 minutes, is in a range of about 0.5 to about 3.0%.

15. A lithium-ion battery, comprising:
an anode;
a cathode;
an electrolyte ionically coupling the anode and the cathode; and
the separator of claim 1 disposed in a space between the anode and the cathode.

16. A method comprising:
(A1) preparing a dispersion comprising (1) ceramic particles comprising a mixture of higher-aspect ratio ceramic particles (HARCPs) and lower-aspect ratio ceramic particles (LARCPs), (2) a binder, and (3) a solvent; and
(A2) dispensing the dispersion on a substrate to form a layer and drying the layer to form a separator coating on the substrate,
wherein:
a thickness of the separator coating is in a range of about 0.5 μm to about 5.0 μm;
a mass fraction of the binder in the separator coating is about 20 wt. % or less;
the ceramic particles comprise Al₂O₃, AlO(OH), and/or Al(OH)₃;
the HARCPs are characterized by an HARCP aspect ratio of more than about 3; and
the LARCPs are characterized by an LARCP aspect ratio of about 1 to about 3; and
the substrate comprises a polymer membrane.

17. The method of claim 16, wherein:
a Gurley air permeability of the separator coating is in a range of about 7 sec/100 ml to about 60 sec/100 ml.

18. The method of claim 17, wherein:
the Gurley air permeability of the separator coating is in a range of about 7 sec/100 ml to about 40 sec/100 ml.

19. The method of claim 16, wherein:
the thickness of the separator coating is in a range of about 1.0 μm to about 4.0 μm.

20. The method of claim 19, wherein:
the thickness of the separator coating is in a range of about 1.0 μm to about 3.5 μm.

21. The method of claim 20, wherein:
the thickness of the separator coating is in a range of about 1.0 μm to about 3.0 μm.

22. The method of claim 16, wherein:
the mass fraction of the binder is in a range of about 5 wt. % to about 15 wt. %.

23. The method of claim 16, wherein:
an average length of the HARCPs is in a range of about 1.0 μm to about 30.0 μm; and/or
an average length of the LARCPs is in a range of about 0.1 μm to about 3.0 μm.

24. The method of claim 16, wherein:
a Brunauer-Emmett-Teller specific surface area (BET-SSA) of the ceramic particles is in a range of about 30 to about 400 m²/g.

25. The method of claim 16, wherein:
a particle size distribution of the ceramic particles, as measured by laser particle size distribution analysis (LPSA), exhibits at least at least a first peak and a second peak in a range of about 0.1 μm to about 8 μm.

26. The method of claim 25, wherein:
the first peak is in a range of about 0.1 μm to about 1.0 μm and the second peak is in a range of about 1 μm to about 8 μm.

27. The method of claim 16, wherein:
the dispensing of the dispersion is along a machine direction within a plane of the substrate; and
the HARCPs are aligned more closely to the machine direction than to a direction perpendicular to the plane.

28. The method of claim 16, wherein:
the substrate is in the form of a roll.

29. A separator comprising the separator coating made according to the method of claim 16.

30. A lithium-ion battery, comprising:
an anode;
a cathode;
an electrolyte ionically coupling the anode and the cathode; and
the separator of claim 29 disposed in a space between the anode and the cathode.
